(19) United States
(12) Patent Application Publication
(10) Pub. No.: US 2017/0330039 A1
(43) Pub. Date: Nov. 16, 2017

(54) FRAME EXTRACTING METHOD, NON-TRANSITORY COMPUTER-READABLE STORAGE MEDIUM, AND FRAME EXTRACTING APPARATUS

(71) Applicant: FUJITSU LIMITED, Kawasaki-shi (JP)

(72) Inventors: Hiroyuki MATSUSHITA, Asaka (JP); Yuta SHIOIRI, Kawasaki (JP)

(73) Assignee: FUJITSU LIMITED, Kawasaki-shi (JP)

(21) Appl. No.: 15/586,442

(22) Filed: May 4, 2017

(30) Foreign Application Priority Data
May 11, 2016 (JP) 2016-095666

(51) Int. Cl. G06K 9/00; G06T 7/00

(52) U.S. Cl. CPC G06K 9/00744; G06K 9/00718; G06T 7/0002

(57) ABSTRACT

A frame extracting method including specifying, for each of a plurality of first groups acquired by dividing a plurality of frames included in a moving image with a predetermined time interval, one frame for which an index related to clearness of a frame indicates highest clearness among frames included in each of the plurality of first groups, grouping the plurality of specified frames into a plurality of second groups, an amount of change between temporally adjacent frames in each of the plurality of second groups being less than or equal to a predetermined reference, and extracting, for each of the plurality of second groups, a representative frame from the plurality of specified frames included in each of the plurality of second groups, the index of the representative frame indicating the highest clearness among the plurality of specified frames included in each of the plurality of second groups.

### CROSS-REFERENCE TO RELATED APPLICATION

This application is based upon and claims the benefit of priority of the prior Japanese Patent Application No. 2016-095666, filed on May 11, 2016, the entire contents of which are incorporated herein by reference.

### FIELD

The embodiments discussed herein are related to a frame extracting method, a non-transitory computer-readable storage medium, and a frame extracting apparatus.

### BACKGROUND

In the case of, for example, performing work analysis based on a video captured with a camera mounted on a head portion of a worker, searching for each scene is facilitated if a series of works may be recognized as one scene.

In Japanese Laid-open Patent Publication No. 2000-350156, disclosed is a technology that allows prompt searching for a desired scene with a frame image, as a representative image, that is related to a period divided by a change in scene and has the maximum amount of features. In Japanese Laid-open Patent Publication No. 2000-350156, disclosed is dividing scenes by acquiring a correlation between frame images from a difference in color histogram.

### SUMMARY

According to an aspect of the invention, a frame extracting method executed by a computer, the frame extracting method including specifying, for each of a plurality of first groups acquired by dividing a plurality of frames included in a moving image with a predetermined time interval, one frame for which an index related to clearness of a frame indicates highest clearness among frames included in each of the plurality of first groups, grouping the plurality of specified frames into a plurality of second groups, an amount of change between temporally adjacent frames in each of the plurality of second groups being less than or equal to a predetermined reference, each of the plurality of second groups including temporally adjacent frames when each of the plurality of second groups includes more than two frames, and extracting, for each of the plurality of second groups, a representative frame from the plurality of specified frames included in each of the plurality of second groups, the index related to the clearness of the representative frame indicating the highest clearness among the plurality of specified frames included in each of the plurality of second groups.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating examples of a unit period and a first representative image;

FIG. 2 is a diagram illustrating examples of a stable period and a second representative image;

FIG. 3 is a diagram illustrating a display operating screen of a first viewer;

FIG. 4 is a diagram illustrating a modular configuration of a first moving image processing apparatus;

FIG. 5 is a diagram illustrating the flow of a first main process;

FIG. 6 is a diagram illustrating a modular configuration of a first analyzing unit;

FIG. 7 is a diagram illustrating the flow of a first analysis phase process;

FIG. 8 is a diagram illustrating an example of a frame table;

FIG. 9 is a diagram illustrating the flow of a unit period process;

FIG. 10 is a diagram illustrating the flow of a first selection process (A);

FIG. 11A is a diagram illustrating an example of a period table;

FIG. 11B is a diagram illustrating an example of a period table;

FIG. 12 is a diagram illustrating the flow of a stable period process;

FIG. 13 is a diagram illustrating the flow of a stable period specification process;

FIG. 14 is a diagram illustrating the flow of a second representative image selection process;

FIG. 15 is a diagram illustrating a modular configuration of the first viewer;

FIG. 16 is a diagram illustrating the flow of a first browse phase process;

FIG. 17 is a diagram illustrating the flow of a first thumbnail display process;

FIG. 18 is a diagram illustrating the flow of a first mark array display process;

FIG. 19 is a diagram illustrating the flow of the first browse phase process;

FIG. 20 is a diagram illustrating the flow of the first browse phase process;

FIG. 21 is a diagram illustrating the flow of a first moving image reproduction process;

FIG. 22 is a diagram illustrating the flow of the first browse phase process;

FIG. 23 is a diagram illustrating the flow of the first browse phase process;

FIG. 24 is a diagram illustrating the flow of a second moving image reproduction process;

FIG. 25 is a diagram illustrating a comparative example of the second representative image;

FIG. 26 is a diagram illustrating a comparative example of the second representative image;

FIG. 27 is a diagram illustrating examples of a scene period and a third representative image;

FIG. 28 is a diagram illustrating an array of the first representative images, the second representative images, and the third representative images;

FIG. 29 is a diagram illustrating a display operating screen of a second viewer;

FIG. 30 is a diagram illustrating a modular configuration of a second moving image processing apparatus;

FIG. 31 is a diagram illustrating the flow of a second main process;

FIG. 32 is a diagram illustrating a modular configuration of a second analyzing unit;

FIG. 33 is a diagram illustrating the flow of a second analysis phase process;

FIG. 34A is a diagram illustrating an example of a period table;

FIG. 34B is a diagram illustrating an example of a period table;

FIG. 34C is a diagram illustrating an example of a period table;

FIG. 34D is a diagram illustrating an example of a period table;

FIG. 35 is a diagram illustrating the flow of a scene period process;

FIG. 36 is a diagram illustrating the flow of a scene period specification process;

FIG. 37 is a diagram illustrating the flow of a similarity determination process related to tone;

FIG. 38 is a diagram illustrating the flow of a feature vector calculation process;

FIG. 39 is a diagram illustrating the flow of a third representative image selection process;

FIG. 40 is a diagram illustrating a modular configuration of the second viewer;

FIG. 41 is a diagram illustrating the flow of a second browse phase process (A);

FIG. 42 is a diagram illustrating the flow of the second browse phase process (A);

FIG. 43 is a diagram illustrating the flow of a third moving image reproduction process;

FIG. 44 is a diagram illustrating the flow of a first selection process (B),

FIG. 45 is a diagram illustrating a display operating screen of the second viewer according to a fourth embodiment;

FIG. 46 is a diagram illustrating the flow of a second browse phase process (B);

FIG. 47 is a diagram illustrating the flow of an automatic scrolling process;

FIG. 48 is a diagram illustrating the flow of the automatic scrolling process;

FIG. 49 is a diagram illustrating the flow of the automatic scrolling process;

FIG. 50 is a diagram illustrating a display operating screen of the second viewer according to a fifth embodiment;

FIG. 51 is a diagram illustrating the flow of a second browse phase process (C);

FIG. 52 is a diagram illustrating the flow of a second thumbnail display process;

FIG. 53 is a diagram illustrating a display operating screen of the second viewer according to a sixth embodiment;

FIG. 54 is a diagram illustrating the flow of a second browse phase process (D);

FIG. 55 is a diagram illustrating the flow of a second mark array display process (A);

FIG. 56 is a diagram illustrating a display operating screen of the second viewer according to a seventh embodiment;

FIG. 57 is a diagram illustrating the flow of a second mark array display process (B);

FIG. 58 is a diagram illustrating a display operating screen of the second viewer according to an eighth embodiment; and

FIG. 59 is a functional block diagram of a computer.

### DESCRIPTION OF EMBODIMENTS

An object of one aspect of the embodiments is to extract a more accurate representative frame.

### First Embodiment

Moving image data that is captured with a video camera is used in various forms. For example, a work may be analyzed based on moving image data captured with a head-mounted video camera. For example, a work procedure is created according to the content of a captured scene. Appropriateness of the content of a work may also be verified. In this case, generally, all moving images are reproduced to view the reproduced video.

In the present embodiment, effort at the time of analyzing a moving image is reduced by enabling simple recognition of a state of visual fixation at a reproduction timing. Specifically, the entire flow of the moving image may be recognized by extracting the state of visual fixation that is expected to be meaningful, and scrolling a representative image of the state of visual fixation.

The present embodiment may be applied to another moving image data. For example, the present embodiment may be applied to a home video, a music video, a movie, or the like.

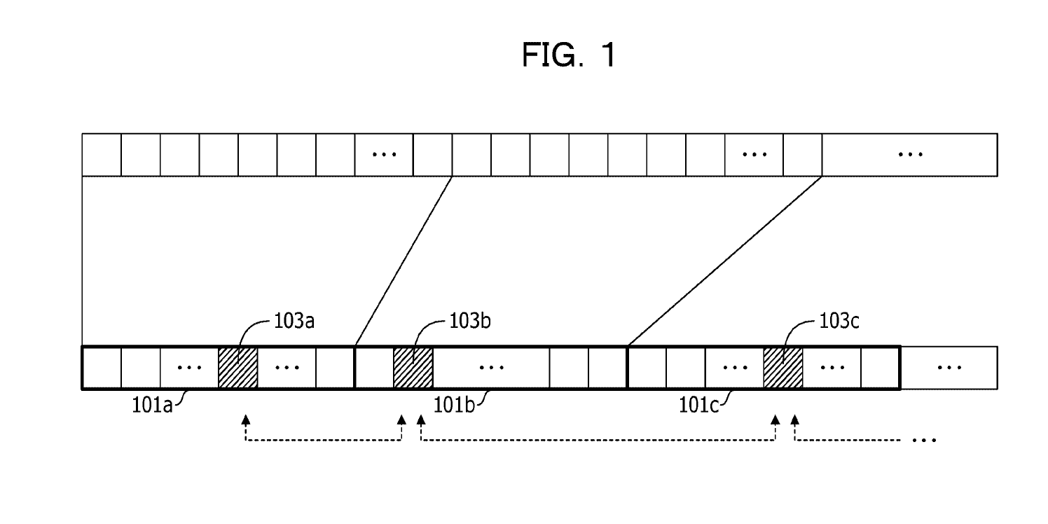

Analysis of moving image data in the present embodiment will be described. A configuration of moving image data is illustrated in the upper part of FIG. 1. A sequence of frame images is illustrated from left to right in accordance with a time series of reproduction timings. The entirety of reproduction time is split into unit periods 101, each of which corresponds to a predetermined length of time. A boldfaced box in the lower part of FIG. 1 surrounds a frame image included in the unit period 101.

In the present embodiment, a first representative image 103 that represents each unit period 101 is selected. In this example, a frame image having the sharpest edge is selected.

The first representative images 103 that are in direct adjacency in a linear arrangement of the first representative images 103 are compared. For example, a first representative image 103a and a first representative image 103b are compared. A first representative image 103b and a first representative image 103c are compared. In the case of a small change in the position of a subject between both of the first representative images 103, both of the first representative images 103 are determined to correspond to the same stable period. That is, images having similar compositions are lined up in a stable period. The stable period corresponds to a period in which the state of visual fixation is continued.

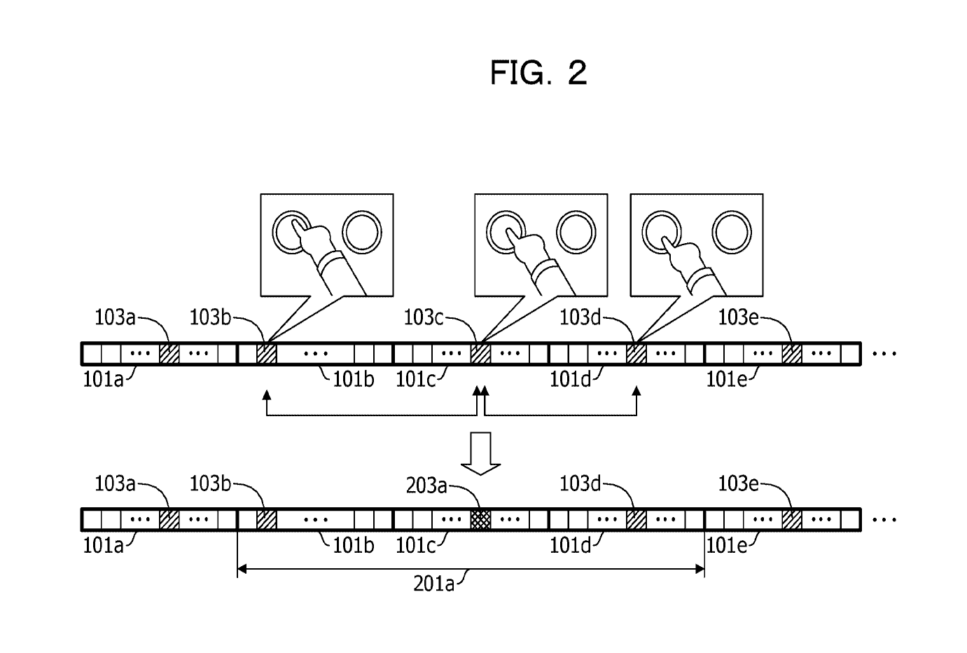

FIG. 2 will be described. In this example, there is a small change in the position of the subject between the first representative image 103b and the first representative image 103c and a small change in the position of the subject between the first representative image 103c and a first representative image 103d. In this example, a state where a left button switch of two button switches is operated is captured. A sequence of the first representative images 103 having a small change in the position of the subject in images is a stable period 201. In this example, a unit period 101b to a unit period 101d correspond to a stable period 201a.

A second representative image 203 is selected in each stable period 201. In this example, the first representative image 103c that has the sharpest edge of the first representative image 103b to the first representative image 103d included in the stable period 201a is selected as a second representative image 203a.

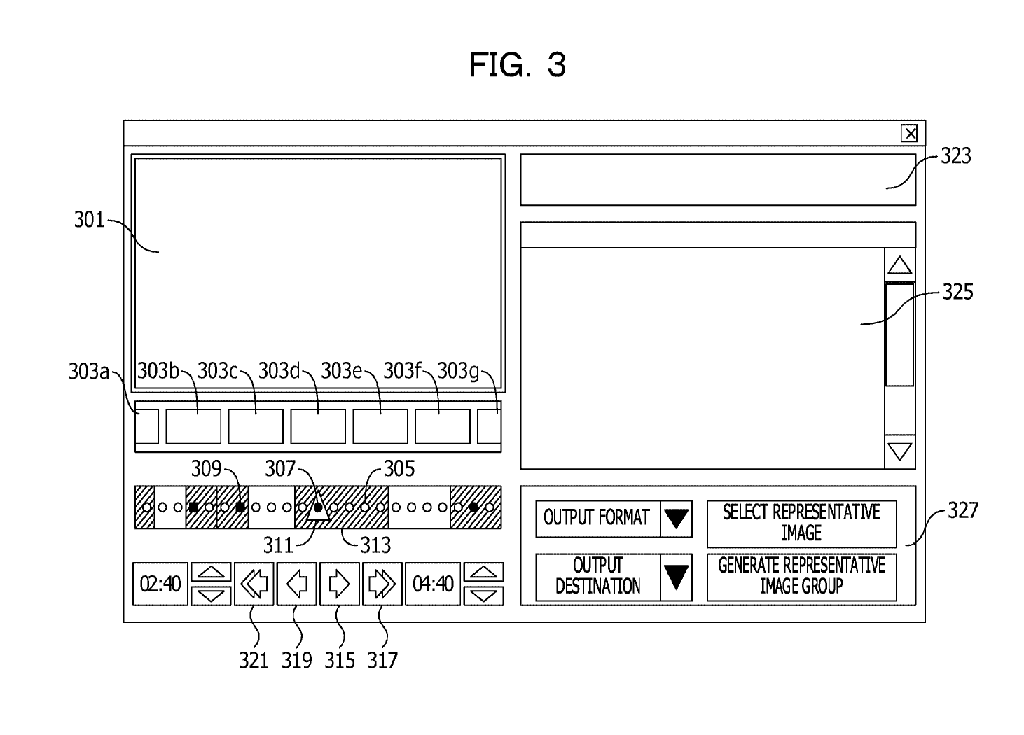

Next, display of an image based on this analysis will be described. FIG. 3 illustrates a display operating screen of a first viewer. A viewer in the present embodiment is referred to as the first viewer. An image area 301 displays a frame image (for example, the first representative image 103 or the second representative image 203). The image area 301 may display a moving image.

A thumbnail 303d at the center is a reduced image of the second representative image 203 that is nearest to the frame image displayed in the image area 301. A thumbnail 303c to a thumbnail 303a that are in order backward in time are reduced images of the previous second representative images 203. A thumbnail 303e to a thumbnail 303g that are in order are reduced images of the subsequent second representative images 203.

When any of the thumbnails 303a to 303g is touched, the second representative image 203 corresponding to the thumbnail 303 is displayed in the image area 301. Then, the thumbnails 303a to 303g are rearranged in such a manner that the touched thumbnail 303 is at the center. If an operation of sliding the display area of the thumbnail 303 is performed, the thumbnails 303a to 303g are moved in accordance with the amount of sliding and are replaced.

A first mark 305 that is illustrated by a circle with only an edge corresponds to the first representative image 103 that does not correspond to the second representative image 203. A second mark 307 that is illustrated by a filled circle corresponds to the second representative image 203 for which additional data is not registered. A third mark 309 that is illustrated by a filled square corresponds to the second representative image 203 for which additional data is registered. The additional data is data that is registered in association with a representative image, and is, for example, the title of an image or a text describing an image.

A triangular mark 311 represents the representative image displayed in the image area 301. A mark on the left side of the triangular mark 311 corresponds to a representative image that is earlier in order than the frame image displayed in the image area 301. A mark on the right side of the triangular mark 311 corresponds to a representative image that is later in order than the frame image displayed in the image area 301. A box 313 illustrates the range of the stable period 201. A predetermined background color is set inside of the box 313.

When any mark is touched (tapped), a representative image corresponding to the mark is displayed in the image area 301. Then, the marks are rearranged in such a manner that the touched mark is at the center. If an operation of sliding the display area of the marks is performed, the marks are moved in accordance with the amount of sliding and are replaced. In the case of touching a mark, a moving image may be reproduced from a reproduction timing of a representative image corresponding to the mark.

If a first subsequent button 315 is touched, an instruction to display the subsequent first representative image 103 in the image area 301 is provided. If a second subsequent button 317 is touched, an instruction to display the subsequent second representative image 203 in the image area 301 is provided. If a first previous button 319 is touched, an instruction to display the previous first representative image 103 in the image area 301 is provided. If a second previous button 321 is touched, an instruction to display the previous second representative image 203 in the image area 301 is provided.

While a touch operation or a slide operation performed on a touch panel included in a moving image processing apparatus is received in this example, another operation (for example, a click operation or a drag operation with a mouse included in the moving image processing apparatus) may be received.

A system menu area 323 is used for providing instructions for functions related to the use of a system. An additional data input area 325 is used for receiving input of data that is added to a representative image. An output menu area 327 is used for providing an instruction to output a representative image group. Besides, the length of the stable period 201 may be displayed.

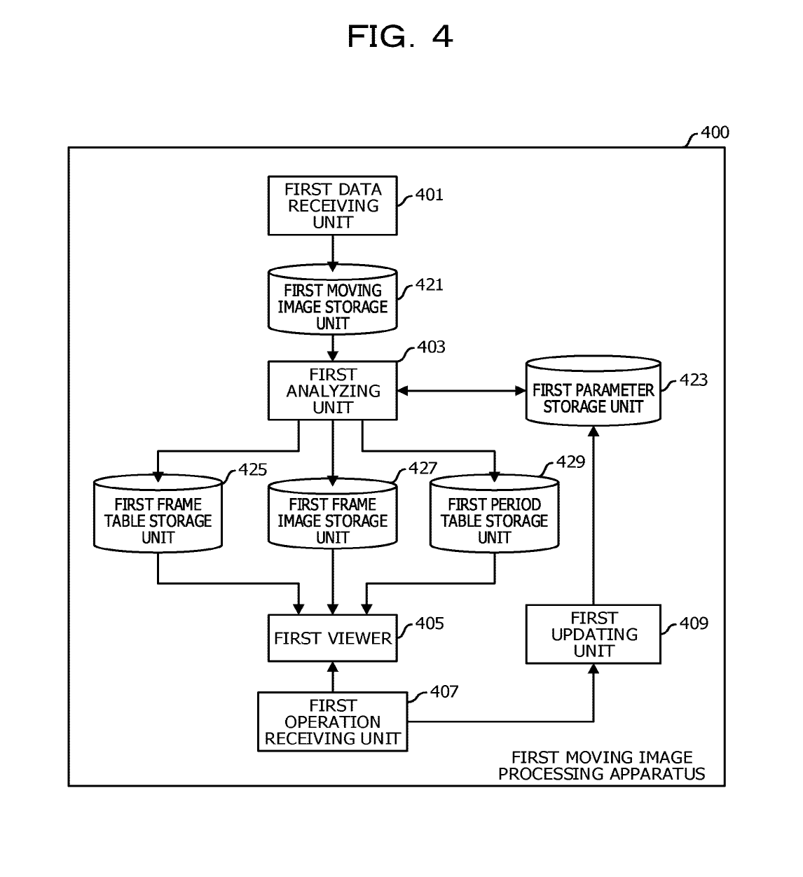

Hereinafter, a moving image processing apparatus according to the present embodiment will be referred to as a first moving image processing apparatus. FIG. 4 illustrates a modular configuration of the first moving image processing apparatus. A first moving image processing apparatus 400 includes a first data receiving unit 401, a first analyzing unit 403, a first viewer 405, a first operation receiving unit 407, a first updating unit 409, a first moving image storage unit 421, a first parameter storage unit 423, a first frame table storage unit 425, a first frame image storage unit 427, and a first period table storage unit 429.

The first data receiving unit 401 receives moving image data. The first analyzing unit 403 analyzes moving image data. The first viewer 405 displays a frame image and a moving image. Registration of additional data and generation of a representative image group are performed in the first viewer 405. The first operation receiving unit 407 receives an operation performed by a user. The first updating unit 409 updates a parameter that is used in analysis of moving image data.

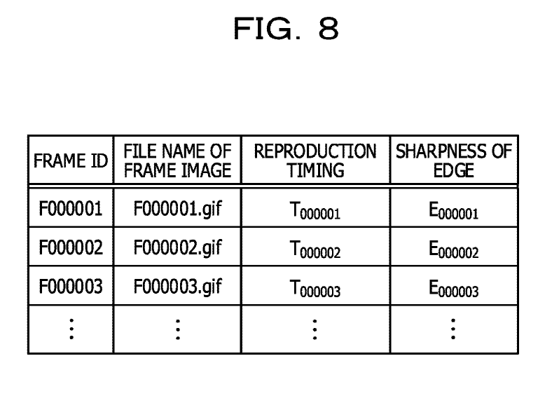

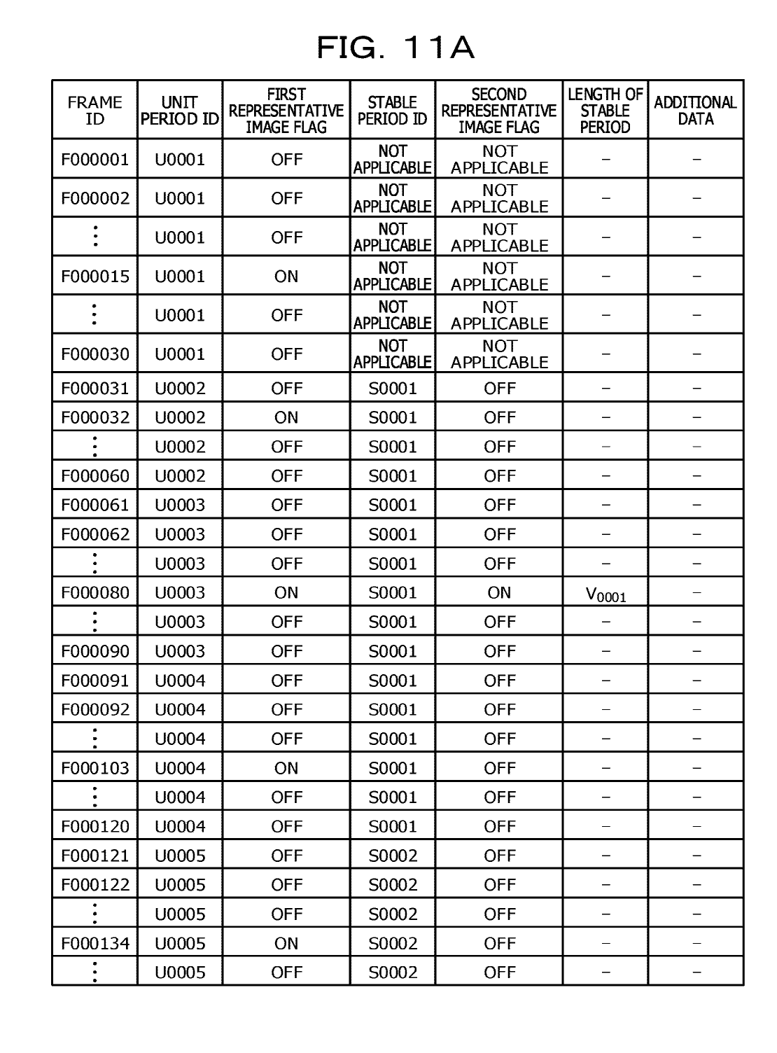

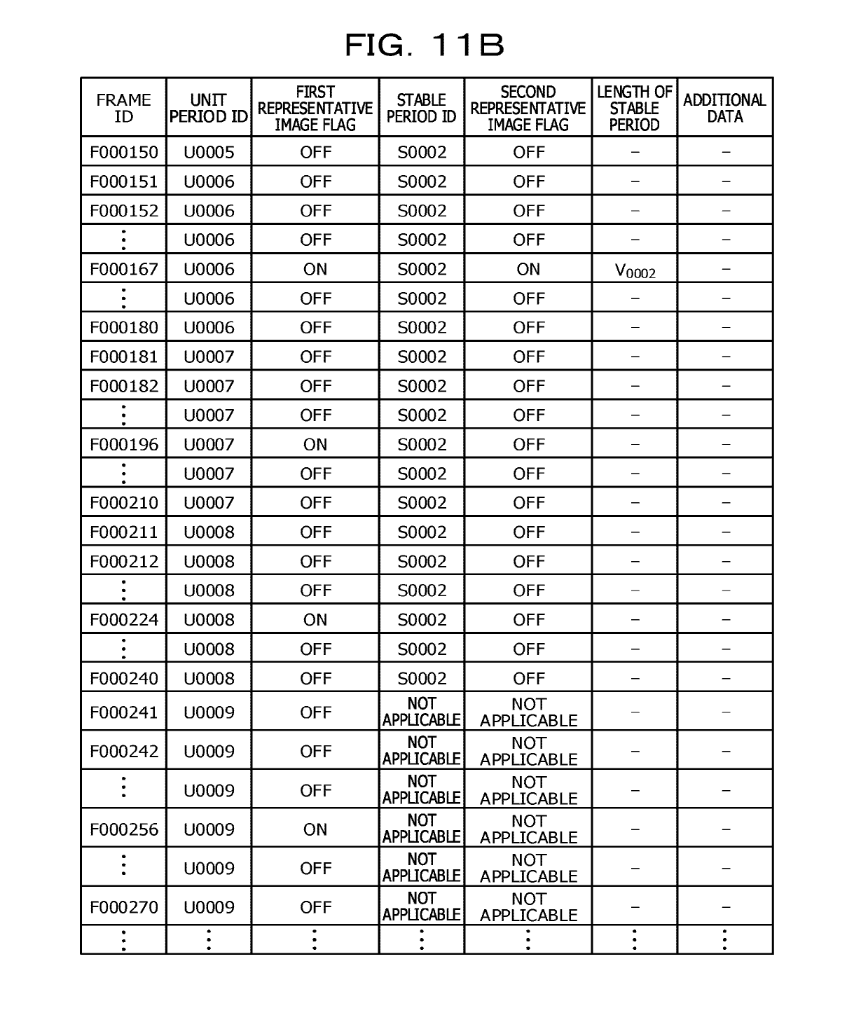

The first moving image storage unit 421 stores moving image data. The first parameter storage unit 423 stores a parameter that is used in analysis of moving image data. The first frame table storage unit 425 stores a frame table. The frame table will be described later by using FIG. 8. The first frame image storage unit 427 stores a file of a frame image. The first period table storage unit 429 stores a period table. The period table will be described later by using FIG. 11A and FIG. 11B.

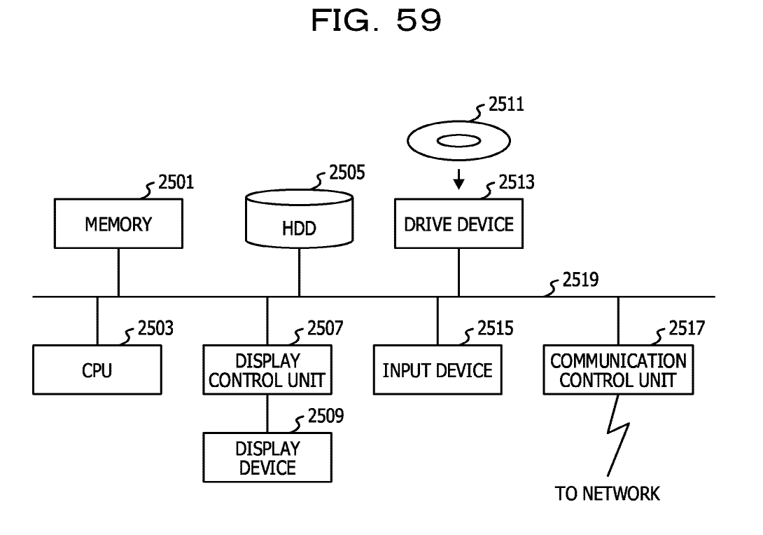

The first data receiving unit 401, the first analyzing unit 403, the first viewer 405, the first operation receiving unit 407, and the first updating unit 409 are realized by using hardware resources (for example, FIG. 59) and a program that causes a processor to perform processes described below.

The first moving image storage unit 421, the first parameter storage unit 423, the first frame table storage unit 425, the first frame image storage unit 427, and the first period table storage unit 429 are realized by using hardware resources (for example, FIG. 59).

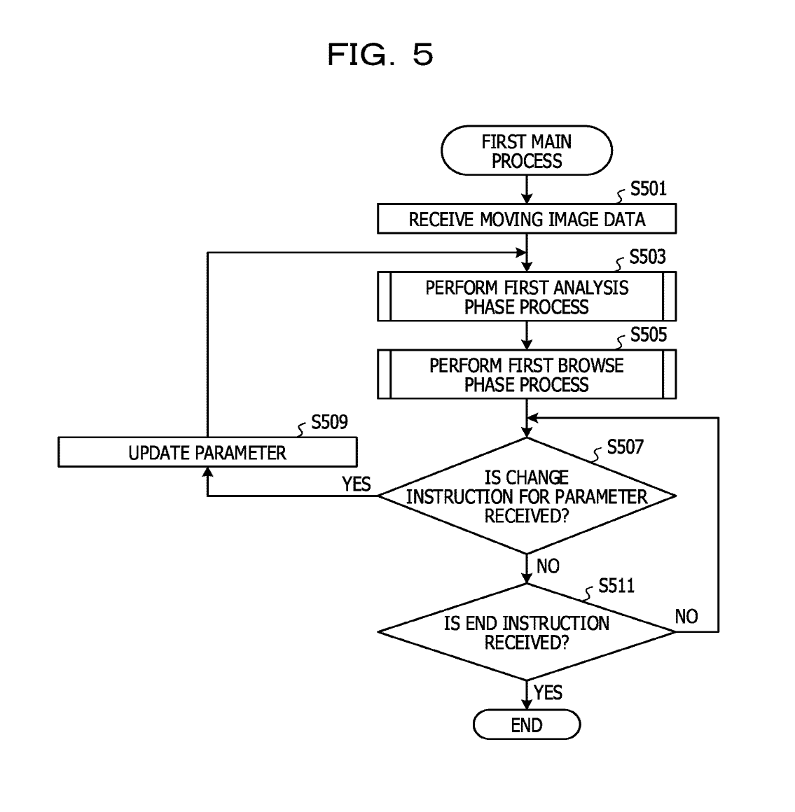

Next, a first main process in the first moving image processing apparatus 400 will be described. FIG. 5 illustrates the flow of the first main process. The first data receiving unit 401 receives moving image data (S501). The received moving image data is stored in the first moving image storage unit 421.

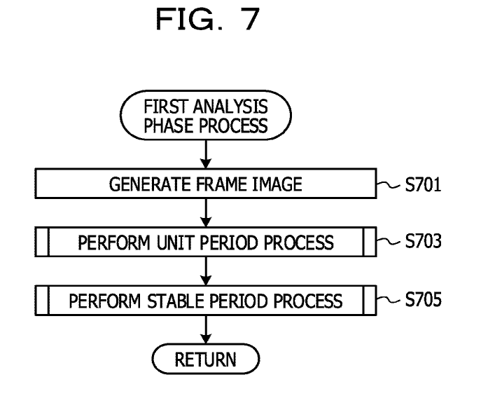

The first analyzing unit 403 performs a first analysis phase process (S503). In the first analysis phase process, the moving image data is analyzed. The first analysis phase process will be described later by using FIG. 7 and the like.

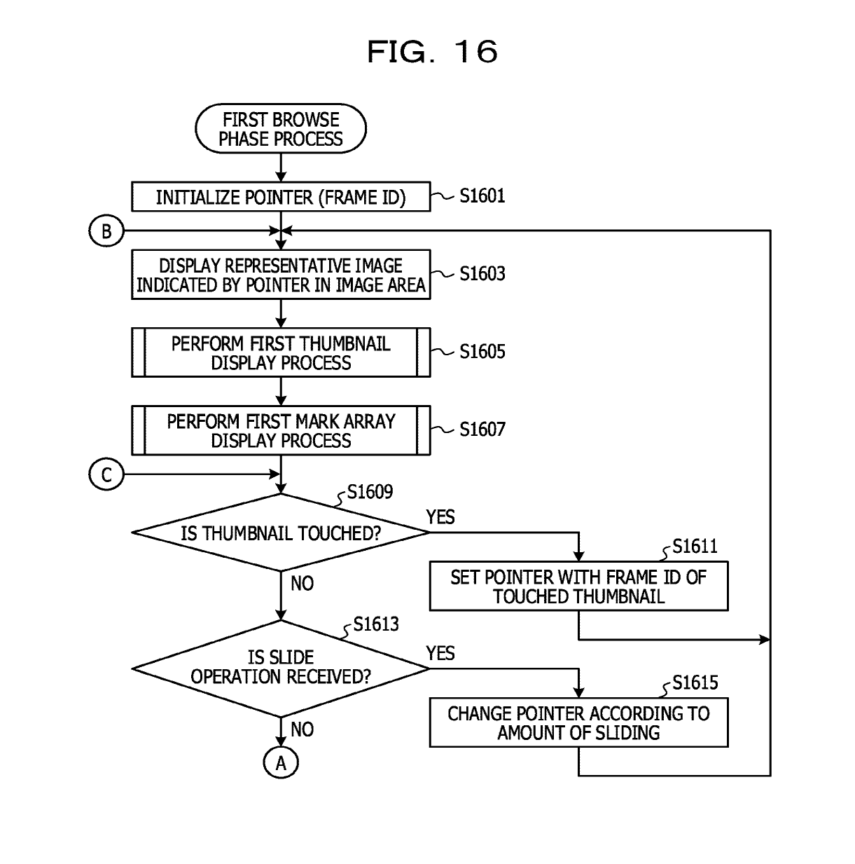

The first viewer 405 performs a first browse phase process (S505). In the first browse phase process, processes for browsing a frame image and a reproduced moving image, registering additional data, and generating a representative image group are performed. The first browse phase process will be described later by using FIG. 16 and the like.

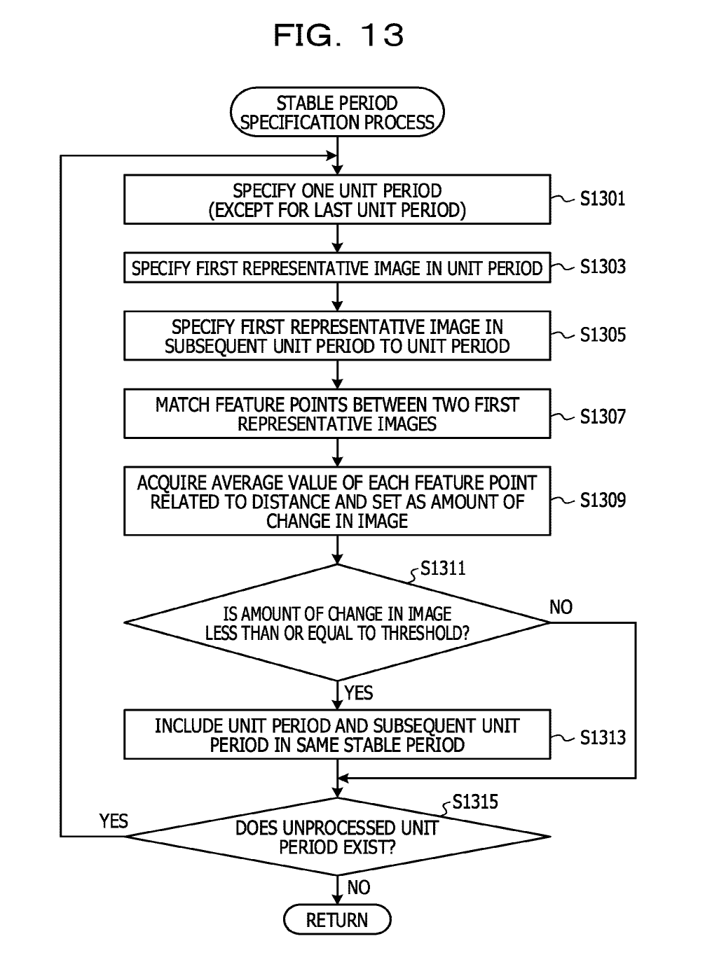

The first operation receiving unit 407 determines whether or not a change instruction for a parameter is received (S507). A parameter of a target of change is stored in the first parameter storage unit 423. The parameter of a target of change is, for example, the length of the unit period 101 or a threshold that is used in S1311 of FIG. 13 described later.

In the case of determining a change instruction for a parameter to be received, the first updating unit 409 updates the parameter in accordance with the change instruction (S509). Then, a return is made to the process illustrated in S503, and the above processes are repeated.

Meanwhile, in the case of determining a change instruction for a parameter not to be received, the first operation receiving unit 407 determines whether or not an end instruction is received (S511). In the case of determining an end instruction to be received, the first main process is ended.

Meanwhile, in the case of determining an end instruction not to be received, a return is made to the process illustrated in S507, and the above processes are repeated.

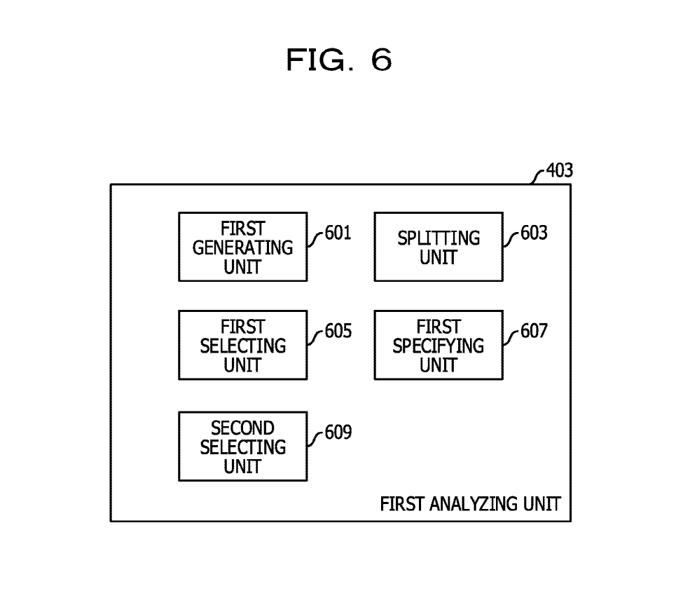

Next, the first analyzing unit 403 that performs the first analysis phase process will be described. FIG. 6 illustrates a modular configuration of the first analyzing unit 403. The first analyzing unit 403 includes a first generating unit 601, a splitting unit 603, a first selecting unit 605, a first specifying unit 607, and a second selecting unit 609.

The first generating unit 601 generates a frame image based on moving image data. The splitting unit 603 splits the entirety of time related to reproduction of moving image data (hereinafter, referred to as moving image reproduction time) into the unit periods 101. The first selecting unit 605 selects the first representative image 103 that represents the unit period 101. The first specifying unit 607 specifies the stable period 201. The second selecting unit 609 selects the second representative image 203 that represents the stable period 201.

The first generating unit 601, the splitting unit 603, the first selecting unit 605, the first specifying unit 607, and the second selecting unit 609 are realized by using hardware resources (for example, FIG. 59) and the program that causes the processor to perform processes described below.

FIG. 7 illustrates the flow of the first analysis phase process. The first generating unit 601 generates a frame image based on moving image data (S701). In this example, 30 frame images are included in one second. If the moving image reproduction time is 20 minutes, 36,000 frame images are generated. The generated frame image is stored in the first frame image storage unit 427. At this point, a frame ID and a file name and a reproduction timing of a frame image are set in the frame table. A frame image that does not correspond to a representative image may be deleted in the stage after analysis is ended.

FIG. 8 illustrates an example of the frame table. The frame table in this example includes a record corresponding to a frame. The record of the frame table includes a field storing a frame ID, a field storing a file name of a frame image, a field storing a reproduction timing, and a field storing the sharpness of an edge.

The frame ID specifies a frame. The file name of a frame image is the name of a file stored in the first frame image storage unit 427. The reproduction timing indicates time at which a corresponding frame is reproduced in the moving image reproduction time. The sharpness of an edge corresponds to the clarity of an edge. In this example, the sharpness of an edge is used as an index that indicates the clearness of a frame. The index that indicates the clearness of a frame may indicate the degree of focus. The index that indicates the clearness of a frame may be the amount of edges detected in a frame image. The sharpness of an edge is acquired in a first selection process (A) described later. In the case of, for example, specifying the file name based on the frame ID, the file name may be omitted. If a process of calculating the reproduction timing is included, the reproduction timing may not be retained.

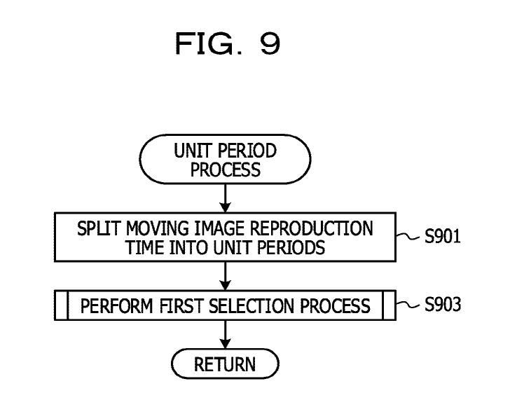

FIG. 7 will be described again. The first analyzing unit 403 performs a unit period process (S703). In the unit period process, a representative image in the unit period 101 (that is, the first representative image 103) is selected. The unit period process will be described later by using FIG. 9.

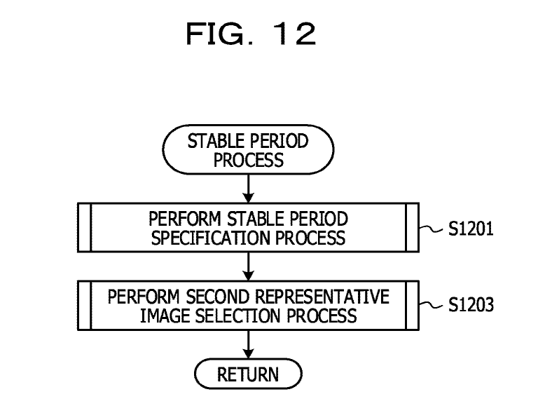

The first analyzing unit 403 performs a stable period process (S705). In the stable period process, the stable period 201 is specified, and a representative image in the stable period 201 (that is, the second representative image 203) is selected. The stable period process will be described later by using FIG. 12. When the first analysis phase process is ended, a return is made to a caller of the first main process.

FIG. 9 illustrates the flow of the unit period process. First, the splitting unit 603 splits the moving image reproduction time into the unit periods 101 (S901). The unit period 101 has a predetermined length of time. In this example, the length of the unit period 101 is one second. That is, the first unit period 101 (unit period ID: 00001) corresponds to reproduction timings of zero seconds to one second. Similarly, the second unit period 101 (unit period ID: U0002) corresponds to reproduction timings of one second to two seconds. Similarly, the third unit period 101 (unit period ID: 00003) corresponds to reproduction timings of two seconds to three seconds. Subsequently, the N-th unit period 101 corresponds to reproduction timings of N−1 seconds to N seconds. Data of the set unit period 101 is stored in the first parameter storage unit 423.

The first selecting unit 605 performs a first selection process (S903). In the first selection process, the first representative image 103 is selected from frame images included in the unit period 101.

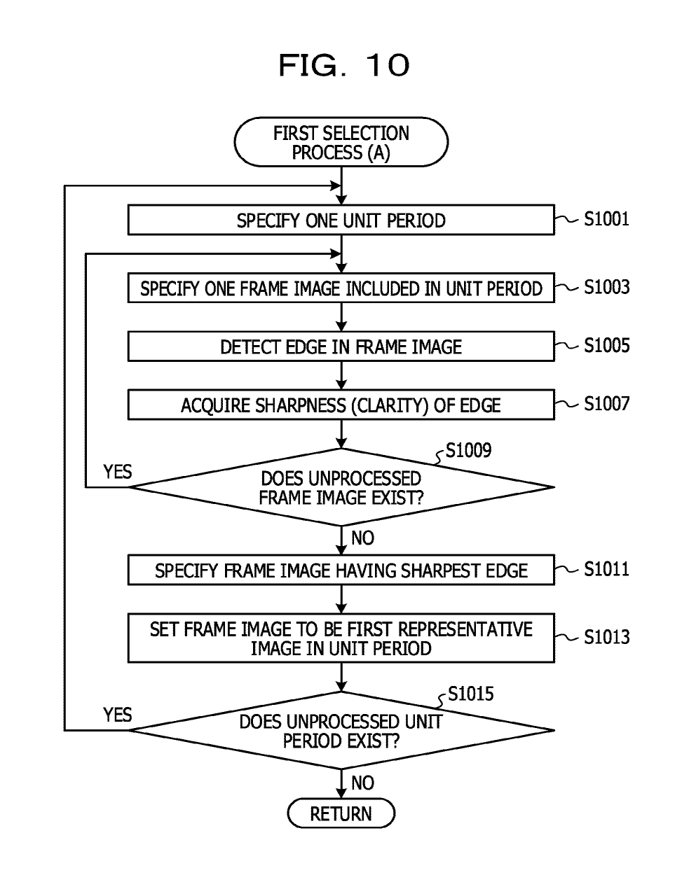

The first selection process (A) is performed in the present embodiment. FIG. 10 illustrates the flow of the first selection process (A). The first selecting unit 605 specifies one unit period 101 (S1001). For example, the first selecting unit 605 specifies the unit period 101 in reproduction order.

The first selecting unit 605 specifies one frame image included in the unit period 101 (S1003). For example, the first selecting unit 605 specifies a frame image in reproduction order. At this point, a frame ID and a unit period ID are set in a record in the period table.

FIG. 11A and FIG. 11B illustrate an example of the period table. FIG. 11B illustrates a part continued from FIG. 11A. The period table in this example includes a record corresponding to a frame. The record of the period table includes a field storing a frame ID, a field storing a unit period ID, a field of a first representative image flag, a field storing a stable period ID, a field of a second representative image flag, a field storing the length of the stable period 201, and a field storing additional data.

The frame ID specifies a frame. The unit period ID specifies the unit period 101 to which the frame belongs. The first representative image flag is ON in the case of the image of the frame corresponding to the first representative image 103. If the first representative image flag is OFF, the frame does not correspond to the first representative image 103. The stable period ID specifies the stable period 201 to which the frame belongs. In the case of the frame not being included in the stable period 201, the text “not applicable” is set. The second representative image flag is ON in the case of the frame corresponding to the second representative image 203. If the second representative image flag is OFF, the frame does not correspond to the second representative image 203. The length of the stable period 201 is set in the record corresponding to the second representative image 203. Additional data may be set in the record corresponding to the first representative image 103 or the second representative image 203.

FIG. 10 will be described again. The first selecting unit 605 detects an edge in the frame image specified in S1003 (S1005). The first selecting unit 605 acquires the sharpness (clarity) of the detected edge (S1007). The sharpness of the edge is stored in the frame table. At this point, another index that indicates the clearness of the frame may be acquired. Specifically, the first selecting unit 605 may calculate the amount of edges detected in the frame image.

The first selecting unit 605 determines whether or not an unprocessed frame image exists (S1009). In the case of determining an unprocessed frame image to exist, a return is made to the process illustrated in S1003, and the above processes are repeated.

Meanwhile, in the case of determining an unprocessed frame image not to exist, the first selecting unit 605 specifies a frame image having the sharpest edge (that is, a frame image that is the clearest) of frame images included in the unit period 101 specified in S1001 (S1011). Then, the first selecting unit 605 sets the frame image to be the first representative image 103 in the unit period 101 (S1013). Specifically, the first representative image flag in the record corresponding to the frame image is set to ON. The first representative image flag in the record corresponding to a frame image other than the first representative image 103 is set to OFF.

The first selecting unit 605 determines whether or not an unprocessed unit period 101 exists (S1015). In the case of determining an unprocessed unit period 101 to exist, a return is made to the process illustrated in S1001, and the above processes are repeated.

Meanwhile, in the case of determining an unprocessed unit period 101 not to exist, the first selection process (A) is ended. When the first selection process (A) is ended, a return is made to a caller of the unit period process. Then, the unit period process illustrated in FIG. 9 is ended, and a return is made to a caller of the first analysis phase process.

FIG. 12 illustrates the flow of the stable period process. The first specifying unit 607 performs a specification process of the stable period 201 (S1201).

FIG. 13 illustrates the flow of the specification process of the stable period 201. The first specifying unit 607 specifies one unit period 101 (S1301). For example, the first specifying unit 607 specifies the unit period 101 in reproduction order. The last unit period 101 is not specified.

The first specifying unit 607 specifies the first representative image 103 in the unit period 101 (S1303). The first specifying unit 607 specifies the first representative image 103 in the subsequent unit period 101 to the unit period 101 (S1305).

Then, the first specifying unit 607 matches feature points between the two first representative images 103 (S1307). A feature point is, for example, a point included in an edge. An angle in the contour of the subject may be a feature point. In the matching, feature points that are expected to indicate the same location in the subject are associated with each other, and a positional relationship between these feature points is specified. In this example, the first specifying unit 607 acquires the average value of feature points related to distance as the amount of change in image (S1309). The acquired amount of change in image corresponds to the amount of change in the position of the subject in the first representative image 103. The amount of change in image may be a value based on a combination of the amount of change in the position of the subject and the amount of change in tone (for example, a difference between feature vectors) in the first representative image 103.

The first specifying unit 607 determines whether or not the amount of change in image is less than or equal to the threshold (S1311). In the case of determining the amount of change in image to be less than or equal to the threshold, the first specifying unit 607 includes the unit period 101 and the subsequent unit period 101 in the same stable period 201 (S1313). Specifically, the same value as the stable period ID in the record of each frame included in the unit period 101 is set in the stable period ID in the record of each frame included in the subsequent unit period 101. In the case of a stable period ID not being set in the record of each frame included in the unit period 101, a new stable period ID is set in the record of each frame included in both of the unit periods 101.

Meanwhile, in the case of determining the amount of change in image not to be less than or equal to the threshold, a transition is made to a process of S1315.

The first specifying unit 607 determines whether or not an unprocessed unit period 101 exists (S1315). In the case of determining an unprocessed unit period 101 to exist, a return is made to the process illustrated in S1301, and the above processes are repeated.

Meanwhile, in the case of determining an unprocessed unit period 101 not to exist, the specification process of the stable period 201 is ended. When the specification process of the stable period 201 is ended, a return is made to a caller of the stable period process.

FIG. 12 will be described again. The second selecting unit 609 performs a selection process of the second representative image 203 (S1203).

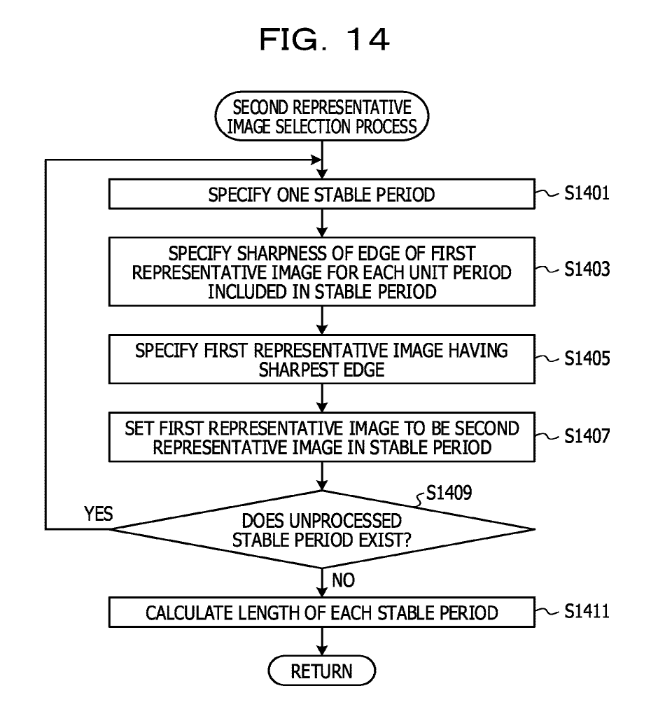

FIG. 14 illustrates the flow of the selection process of the second representative image 203. The second selecting unit 609 specifies one stable period 201 (S1401). For example, the second selecting unit 609 specifies a stable period ID in reproduction order in the period table.

The second selecting unit 609 specifies the sharpness of an edge in the first representative image 103 of the unit period 101 for each unit period 101 included in the specified stable period 201 (S1403). Specifically, the second selecting unit 609 reads the sharpness of an edge in the first representative image 103 from the frame table. The same applies in the case of using another index that indicates the clearness of a frame.

The second selecting unit 609 specifies the first representative image 103 having the sharpest edge (that is, the clearest first representative image 103) of the first representative images 103 of the unit period 101 included in the stable period 201 (S1405). The second selecting unit 609 sets the first representative image 103 to be the second representative image 203 in the stable period 201 (S1407). Specifically, the second representative image flag in the record corresponding to the first representative image 103 is set to ON. The second representative image flag in the record corresponding to a frame image other than the second representative image 203 is set to OFF.

The second selecting unit 609 determines whether or not an unprocessed stable period 201 exists (S1409). In the case of determining an unprocessed stable period 201 to exist, a return is made to the process illustrated in S1401, and the above processes are repeated.

Meanwhile, in the case of determining an unprocessed stable period 201 not to exist, the second selecting unit 609 calculates the length of each stable period 201 (S1411). The calculated length of the stable period 201 is set in the record of the second representative image 203 in the period table. Specifically, the reproduction timing of the frame in the initial record of records having the same stable period ID set is subtracted from the reproduction timing of the frame in the last record in the period table, and thus the length of the stable period 201 specified by the stable period ID is acquired. When the selection process of the second representative image 203 is ended, a return is made to a caller of the stable period process.

FIG. 12 will be described again. When the stable period process is ended, a return is made to a caller of the first analysis phase process. The first analysis phase process is described heretofore.

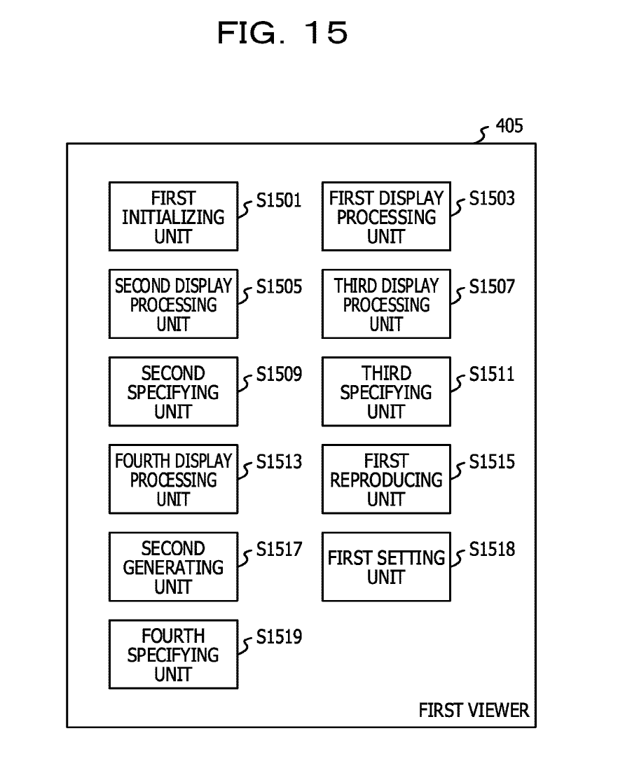

Next, the first browse phase process will be described. FIG. 15 illustrates a modular configuration of the first viewer 405. The first viewer 405 includes a first initializing unit 1501, a first display processing unit 1503, a second display processing unit 1505, a third display processing unit 1507, a second specifying unit 1509, a third specifying unit 1511, a fourth display processing unit 1513, a first reproducing unit 1515, a second generating unit 1517, a first setting unit 1518, and a fourth specifying unit 1519.

The first initializing unit 1501 initializes a pointer for specifying a display target. The first display processing unit 1503 displays a representative image indicated by the pointer in the image area 301. The second display processing unit 1505 performs a first thumbnail display process. The third display processing unit 1507 performs a first mark array display process. The second specifying unit 1509 specifies a display target in response to the user operating the thumbnail 303. The third specifying unit 1511 specifies a display target in response to the user operating a subsequent button or a previous button. The fourth display processing unit 1513 performs a first moving image reproduction process. The first reproducing unit 1515 reproduces a moving image. The second generating unit 1517 generates a representative image group. The first setting unit 1518 sets the pointer with the ID of the frame that is lastly reproduced as a moving image (or the frame ID of the first representative image 103 that is lastly reproduced). The fourth specifying unit 1519 specifies a display target in response to the user operating a mark.

The first initializing unit 1501, the first display processing unit 1503, the second display processing unit 1505, the third display processing unit 1507, the second specifying unit 1509, the third specifying unit 1511, the fourth display processing unit 1513, the first reproducing unit 1515, the second generating unit 1517, the first setting unit 1518, and the fourth specifying unit 1519 are realized by using hardware resources (for example, FIG. 59) and the program that causes the processor to perform processes described below.

FIG. 16 illustrates the flow of the first browse phase process. The first initializing unit 1501 initializes the pointer (S1601). The pointer is an internal parameter that indicates the frame ID of a representative image displayed in the image area 301. The first initializing unit 1501 sets the pointer with, for example, the frame ID of the leading first representative image 103. The pointer may be set with the frame ID of the leading second representative image 203. The pointer may be initialized in any manner.

The first display processing unit 1503 displays a representative image indicated by the pointer in the image area 301 (S1603). Specifically, the file name of the frame image corresponding to the frame ID indicated by the pointer is specified, and the frame image of the file is loaded and displayed in the image area 301.

The second display processing unit 1505 performs the first thumbnail display process (S1605). In the thumbnail display process, the thumbnails 303a to 303g of the second representative image 203 are displayed.

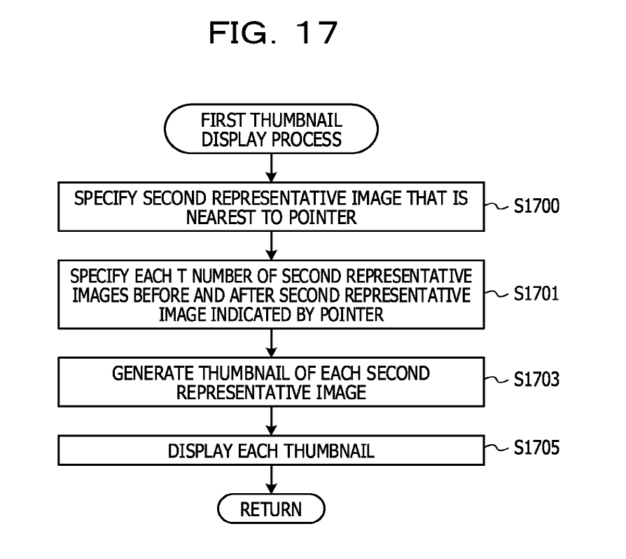

FIG. 17 illustrates the flow of the first thumbnail display process. The second display processing unit 1505 specifies the second representative image 203 that is nearest to the pointer (S1700). Specifically, the second display processing unit 1505 specifies the record, of records having the second representative image flag set to ON in the period table, that is nearest to the record of the frame ID indicated by the pointer.

The second display processing unit 1505 specifies each T number (in this example, three) of second representative images 203 before and after the second representative image 203 indicated by the pointer (S1701). Specifically, the second display processing unit 1505 searches in the period table for immediately nearby T number of records having the second representative image flag set to ON from the records before the record of the frame ID indicated by the pointer. The second display processing unit 1505 searches for immediately nearby T number of records having the second representative image flag set to ON from the records after the record of the frame ID indicated by the pointer.

The second display processing unit 1505 generates the thumbnail 303 of each specified second representative image 203 (S1703). Specifically, the file name of the frame image corresponding to each frame ID is specified, and the frame image of the file is converted into the image of the thumbnail 303.

The second display processing unit 1505 displays each of the generated thumbnails 303a to 303g (S1705). Specifically, the second display processing unit 1505 arranges the thumbnails 303a to 303g in reproduction order. Then, the thumbnail display process is ended, and a return is made to a caller of the first browse phase process.

FIG. 16 will be described again. The third display processing unit 1507 performs the first mark array display process (S1607). In the first mark array display process, marks represent a linear arrangement of the first representative images 103 and the second representative images 203.

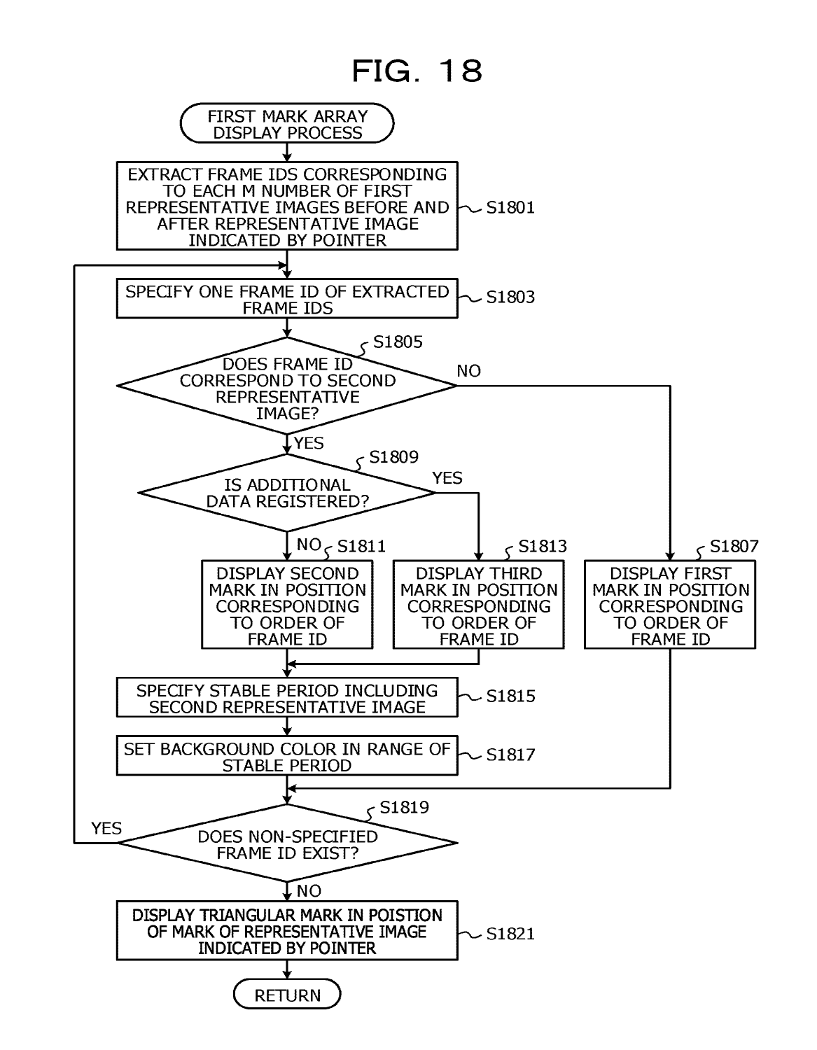

FIG. 18 illustrates the flow of the first mark array display process. The third display processing unit 1507 extracts the frame IDs corresponding to each M number (in this example, 11) of first representative images 103 before and after the representative image indicated by the pointer (S1801). Specifically, the third display processing unit 1507 searches in the period table for immediately nearby M number of records having the first representative image flag set to ON from the records before the record of the frame ID indicated by the pointer. The third display processing unit 1507 searches for immediately nearby M number of records having the first representative image flag set to ON from the records after the record of the frame ID indicated by the pointer.

The third display processing unit 1507 specifies one frame ID of the extracted frame IDs (S1803). For example, the third display processing unit 1507 specifies a frame ID in reproduction order.

The third display processing unit 1507 determines whether or not the frame ID also corresponds to the second representative image 203 (S1805). In the case of determining the frame ID not to correspond to the second representative image 203, the third display processing unit 1507 displays the first mark 305 in a position corresponding to the order of the frame ID (S1807). The order is set in reproduction order from left to right of the display operating screen. Then, a transition is made to a process of S1819.

Meanwhile, in the case of determining the frame ID to correspond to the second representative image 203, the third display processing unit 1507 determines whether or not additional data is registered in the second representative image 203 (S1809). Specifically, the third display processing unit 1507 determines whether or not additional data is set in the record corresponding to the second representative image 203 in the period table. In the case of determining additional data not to be registered in the second representative image 203, the third display processing unit 1507 displays the second mark 307 in the position corresponding to the order of the frame ID (S1811). Then, a transition is made to a process of S1815.

Meanwhile, in the case of determining additional data to be registered in the second representative image 203, the third display processing unit 1507 displays the third mark 309 in the position corresponding to the order of the frame ID (S1813). Then, a transition is made to a process of S1815.

The third display processing unit 1507 specifies the stable period 201 that includes the second representative image 203 (S1815). Specifically, the third display processing unit 1507 specifies, as the stable period 201, the leading record to the last record of records having the same ID set as the stable period ID set in the record corresponding to the second representative image 203 in the period table. Then, the third display processing unit 1507 specifies the position of a mark array corresponding to representative images included in the stable period 201.

The third display processing unit 1507 sets a background color for the range of the stable period 201 (S1817). Specifically, the third display processing unit 1507 displays the box 313 illustrating the range of the stable period 201 and displays a predetermined color in the background of representative images inside of the box 313. In the case of adjacent stable periods 201, a gap may be placed therebetween to render the background color not continuous.

The third display processing unit 1507 determines whether or not a non-specified frame ID exists (S1819). In the case of determining a non-specified frame ID to exist, a return is made to the process illustrated in S1803, and the above processes are repeated.

Meanwhile, in the case of determining a non-specified frame ID not to exist, the third display processing unit 1507 displays the triangular mark 311 in the position of the mark of the representative image indicated by the pointer (S1821). Then, the first mark array display process is ended, and a return is made to a caller of the first browse phase process.

FIG. 16 will be described again. When the first mark array display process is ended, the first operation receiving unit 407 determines whether or not the thumbnail 303 is touched (S1609). In the case of determining the thumbnail 303 to be touched, the second specifying unit 1509 sets the pointer with the frame ID corresponding to the touched thumbnail 303 (S1611). Then, a return is made to the process illustrated in S1603, and the above processes are repeated.

In the case of determining the thumbnail 303 not to be touched in S1609, the first operation receiving unit 407 determines whether or not a slide operation in the display area of the thumbnail 303 is received (S1613). In the case of determining a slide operation in the display area of the thumbnail 303 to be received, the second specifying unit 1509 changes the pointer according to the amount of sliding (S1615). At this point, the second specifying unit 1509 acquires the number of representative images corresponding to the movement by multiplying the amount of sliding by a predetermined percentage. When the pointer is changed, a return is made to the process illustrated in S1603, and the above processes are repeated.

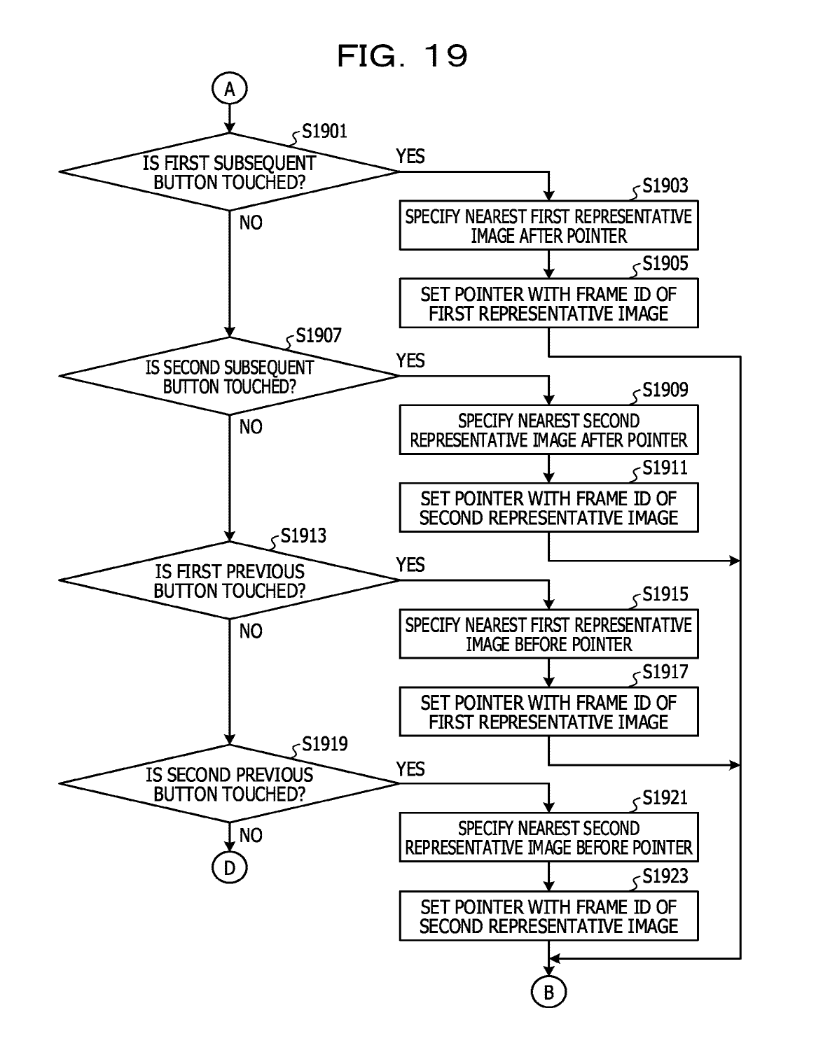

Meanwhile, in the case of determining a slide operation in the display area of the thumbnail 303 not to be received, a transition is made to a process of S1901 illustrated in FIG. 19 through a terminal A.

FIG. 19 will be described. The first operation receiving unit 407 determines whether or not the first subsequent button 315 is touched (S1901). In the case of determining the first subsequent button 315 to be touched, the third specifying unit 1511 specifies the nearest first representative image 103 after the pointer (S1903). Specifically, the third specifying unit 1511 searches in the period table for the immediately nearby record having the first representative image flag set to ON from the records after the record of the frame ID indicated by the pointer. Then, the third specifying unit 1511 sets the pointer with the frame ID of the first representative image 103 (S1905). Then, a return is made to the process illustrated in S1603 of FIG. 16 through a terminal B, and the above processes are repeated.

Meanwhile, in the case of determining the first subsequent button 315 not to be touched, the first operation receiving unit 407 determines whether or not the second subsequent button 317 is touched (S1907). In the case of determining the second subsequent button 317 to be touched, the third specifying unit 1511 specifies the nearest second representative image 203 after the pointer (S1909). Specifically, the third specifying unit 1511 searches in the period table for the immediately nearby record having the second representative image flag set to ON from the records after the record of the frame ID indicated by the pointer. Then, the third specifying unit 1511 sets the pointer with the frame ID of the second representative image 203 (S1911). Then, a return is made to the process illustrated in S1603 of FIG. 16 through the terminal B, and the above processes are repeated.

Meanwhile, in the case of determining the second subsequent button 317 not to be touched, the first operation receiving unit 407 determines whether or not the first previous button 319 is touched (S1913). In the case of determining the first previous button 319 to be touched, the third specifying unit 1511 specifies the nearest first representative image 103 before the pointer (S1915). Specifically, the third specifying unit 1511 searches in the period table for the immediately nearby record having the first representative image flag set to ON from the records before the record of the frame ID indicated by the pointer. Then, the third specifying unit 1511 sets the pointer with the frame ID of the first representative image 103 (S1917). Then, a return is made to the process illustrated in S1603 of FIG. 16 through the terminal B, and the above processes are repeated.

Meanwhile, in the case of determining the first previous button 319 not to be touched, the first operation receiving unit 407 determines whether or not the second previous button 321 is touched (S1919). In the case of determining the second previous button 321 to be touched, the third specifying unit 1511 specifies the nearest second representative image 203 before the pointer (S1921). Specifically, the third specifying unit 1511 searches in the period table for the immediately nearby record having the second representative image flag set to ON from the records before the record of the frame ID indicated by the pointer. Then, the third specifying unit 1511 sets the pointer with the frame ID of the second representative image 203 (S1923). Then, a return is made to the process illustrated in S1603 of FIG. 16 through the terminal B, and the above processes are repeated.

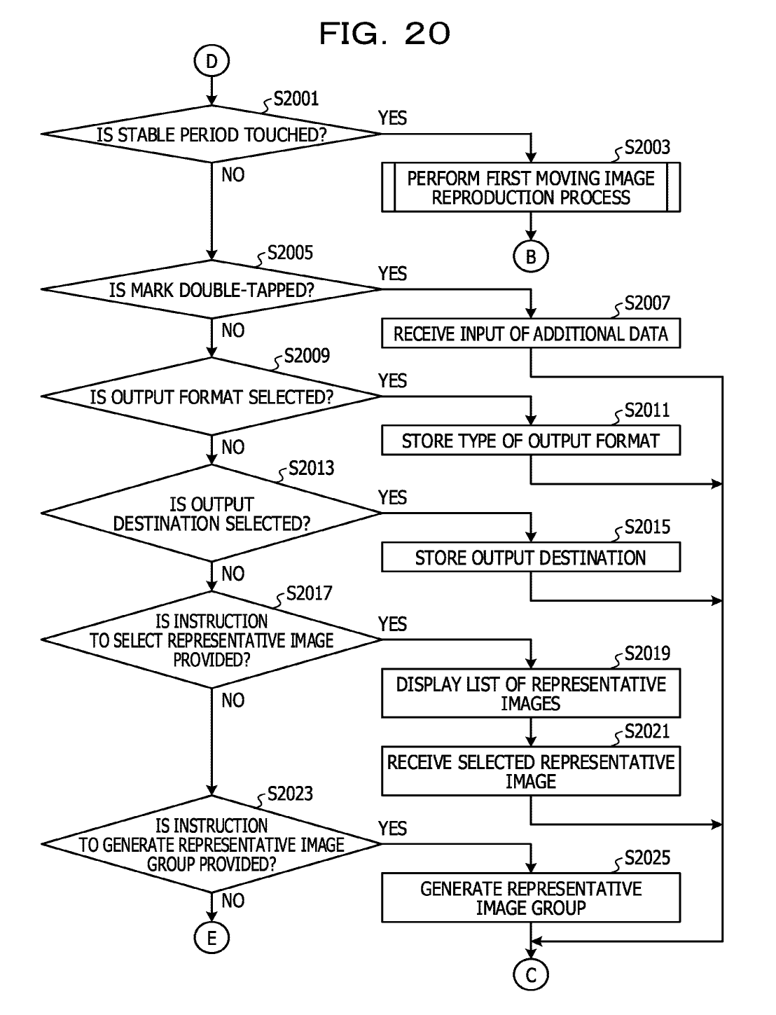

Meanwhile, in the case of determining the second previous button 321 not to be touched, a transition is made to a process of S2001 illustrated in FIG. 20 through a terminal D.

FIG. 20 will be described. The first operation receiving unit 407 determines whether or not the stable period 201 in the mark display area is touched (S2001). The first operation receiving unit 407 determines whether or not, for example, the box 313 or the background part is touched. In the case of determining the stable period 201 to be touched, the fourth display processing unit 1513 performs the first moving image reproduction process (S2003). In the first moving image reproduction process, a moving image is reproduced from the start of the stable period 201.

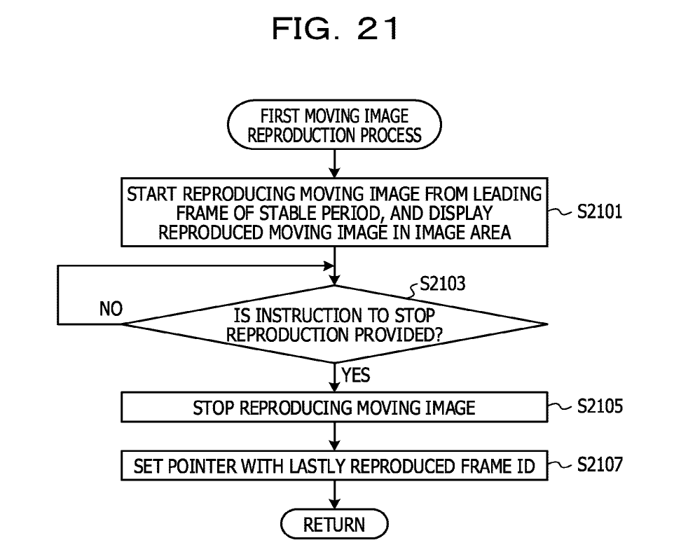

FIG. 21 illustrates the flow of the first moving image reproduction process. The first reproducing unit 1515 starts reproducing a moving image from the reproduction timing of the leading frame of the stable period 201, and the fourth display processing unit 1513 displays the reproduced moving image in the image area 301 (S2101).

The first operation receiving unit 407 determines whether or not an instruction to stop reproduction is provided (S2103). In the case of determining an instruction to stop reproduction not to be provided, the process of S2103 is repeated.

Meanwhile, in the case of determining an instruction to stop reproduction to be provided, the first reproducing unit 1515 stops reproducing the moving image (S2105). Then, the first setting unit 1518 sets the pointer with the lastly reproduced frame ID (or the frame ID of the lastly reproduced first representative image 103) (S2107). When the moving image reproduction process is ended, a return is made to a caller of the first browse phase process.

FIG. 20 will be described again. When the first moving image reproduction process is ended, a return is made to the process illustrated in S1603 of FIG. 16 through the terminal B, and the above processes are repeated.

In the case of determining the stable period 201 not to be touched in S2001, the first operation receiving unit 407 determines whether or not the first mark 305, the second mark 307, or the third mark 309 is double-tapped (S2005). In the present embodiment, a mark is double-tapped, and a transition is made to a process of receiving additional data. In the case of operating a mouse, a transition may be made to the process of receiving additional data by a double-click. A transition may be made to the process of receiving additional data by another operation.

In the case of determining the first mark 305, the second mark 307, or the third mark 309 to be double-tapped, the second generating unit 1517 receives input of additional data in the additional data input area 325 (S2007). The user inputs, for example, a title or a comment related to an image. The additional data is stored in the period table. Specifically, the additional data is set in the record of the representative image corresponding to the first mark 305, the second mark 307, or the third mark 309. When input of additional data is ended, a return is made to the process illustrated in S1609 of FIG. 16 through a terminal C, and the above processes are repeated.

Meanwhile, in the case of determining any of the first mark 305, the second mark 307, and the third mark 309 not to be double-tapped, the first operation receiving unit 407 determines whether or not an output format is selected in the output menu area 327 (S2009). In the case of determining an output format to be selected in the output menu area 327, the second generating unit 1517 stores the type of the selected output format in the first parameter storage unit 423 (S2011). Then, a return is made to the process illustrated in S1609 of FIG. 16 through the terminal C, and the above processes are repeated.

Meanwhile, in the case of determining an output format not to be selected in S2009, the first operation receiving unit 407 determines whether or not an output destination is selected in the output menu area 327 (S2013). The output destination is specified with, for example, a drive and a folder. In the case of determining an output destination to be selected in the output menu area 327, the second generating unit 1517 stores the output destination in the first parameter storage unit 423 (S2015). Then, a return is made to the process illustrated in S1609 of FIG. 16 through the terminal C, and the above processes are repeated.

Meanwhile, in the case of determining an output destination not to be selected in S2013, the first operation receiving unit 407 determines whether or not an instruction to select a representative image is provided in the output menu area 327 (S2017). In the case of determining an instruction to select a representative image to be provided, the second generating unit 1517 displays a list of representative images (S2019). A window that displays the list includes an interface for selecting a representative image and canceling the selection. The second generating unit 1517 receives an instruction to select a representative image included in the representative image group (S2021). As a default, all representative images may be selected. When selection of a representative image is ended, a return is made to the process illustrated in S1609 of FIG. 16 through the terminal C, and the above processes are repeated.

Meanwhile, in the case of determining an instruction to select a representative image not to be provided in S2017, the first operation receiving unit 407 determines whether or not an instruction to generate a representative image group is provided in the output menu area 327 (S2023). In the case of determining an instruction to generate a representative image group to be provided, the second generating unit 1517 generates a representative image group (S2025). Specifically, the second generating unit 1517 reads additional data set in the period table for each selected representative image and sets the frame image of the representative image and the additional data as a pair in representative image group data that complies with the output format. The generated representative image group data is stored in the output destination. Then, a return is made to the process illustrated in S1609 of FIG. 16 through the terminal C, and the above processes are repeated.

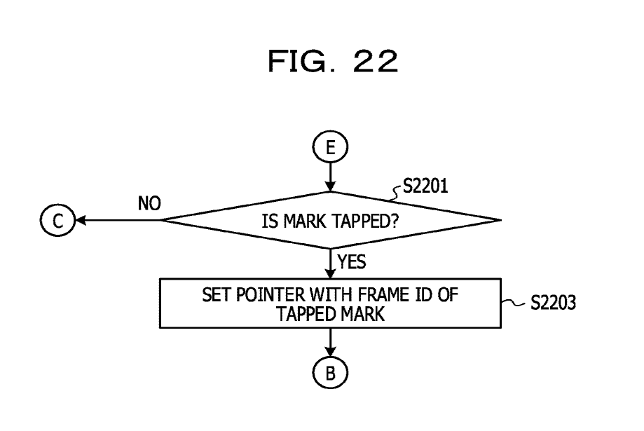

Meanwhile, in the case of determining an instruction to generate a representative image group not to be provided in S2023, a transition is made to a process illustrated in S2201 of FIG. 22 through a terminal E.

FIG. 22 will be described. The first operation receiving unit 407 determines whether or not the first mark 305, the second mark 307, or the third mark 309 is tapped (S2201). In this example, when the first mark 305, the second mark 307, or the third mark 309 is tapped, the representative image corresponding to the mark is displayed in the image area 301. Therefore, in the case of determining the first mark 305, the second mark 307, or the third mark 309 to be tapped, the fourth specifying unit 1519 sets the pointer with the frame ID corresponding to the tapped mark (S2203). Then, a return is made to the process illustrated in S1603 of FIG. 16 through the terminal B, and the above processes are repeated.

Meanwhile, in the case of determining any of the first mark 305, the second mark 307, or the third mark 309 not to be tapped, a return is made to the process illustrated in S1609 of FIG. 16 through the terminal C, and the above processes are repeated.

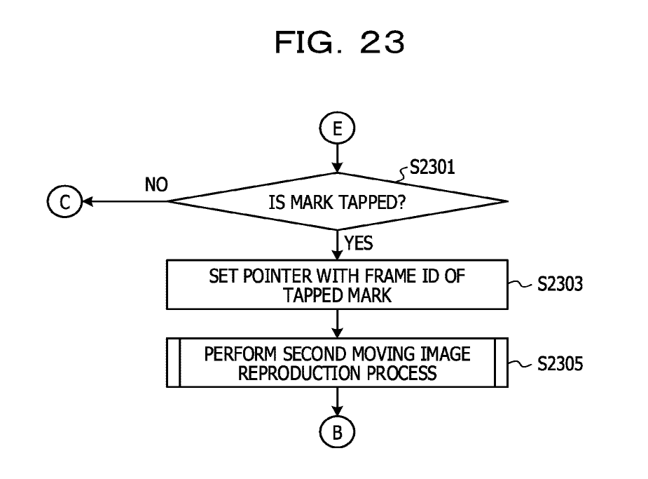

Regardless of the example of FIG. 22, when the first mark 305, the second mark 307, or the third mark 309 is tapped, a moving image may be reproduced from the representative image corresponding to the mark. The flow of a process in this case is illustrated in FIG. 23. A transition is made from a route NO in S2023 of FIG. 20 to a process of S2301 through the terminal E.

The first operation receiving unit 407 determines whether or not the first mark 305, the second mark 307, or the third mark 309 is tapped (S2301). In the case of determining the first mark 305, the second mark 307, or the third mark 309 to be tapped, the fourth specifying unit 1519 sets the pointer with the frame ID corresponding to the tapped mark (S2303). Then, the fourth display processing unit 1513 performs a second moving image reproduction process (S2305). In the second moving image reproduction process, a moving image is reproduced from the frame indicated by the pointer.

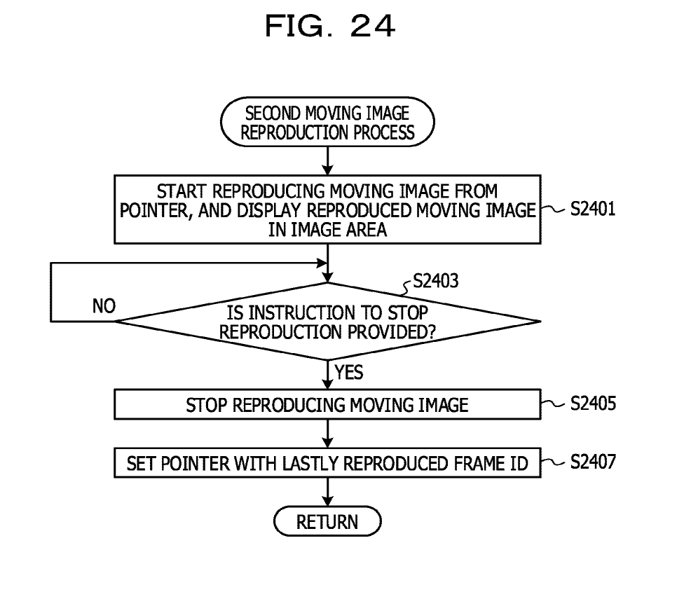

FIG. 24 illustrates the flow of the second moving image reproduction process. The first reproducing unit 1515 starts reproducing a moving image from the reproduction timing of the frame indicated by the pointer, and the fourth display processing unit 1513 displays the reproduced moving image in the image area 301 (S2401).

The first operation receiving unit 407 determines whether or not an instruction to stop reproduction is provided (S2403). In the case of determining an instruction to stop reproduction not to be provided, the process of S2403 is repeated.

Meanwhile, in the case of determining an instruction to stop reproduction to be provided, the first reproducing unit 1515 stops reproducing the moving image (S2405). Then, the first setting unit 1518 sets the pointer with the lastly reproduced frame ID (or the frame ID of the lastly reproduced first representative image 103) (S2407). When the second moving image reproduction process is ended, a return is made to a caller of the first browse phase process.

FIG. 23 will be described again. When the second moving image reproduction process is ended, a return is made to the process illustrated in S1603 of FIG. 16 through the terminal B, and the above processes are repeated. In the case of determining any of the first mark 305, the second mark 307, or the third mark 309 not to be tapped in S2301, a return is made to the process illustrated in S1609 of FIG. 16 through the terminal C, and the above processes are repeated. The first browse phase process is described heretofore.

According to the present embodiment, a more accurate representative frame may be extracted. A clear representative frame is acquired.

The amount of time of reproducing a meaningless video is easily reduced. For example, while a capturer moves in a workplace, a video is out of focus, and unstable images are repeated. Even in a video that is captured when the capturer does not pay attention, the direction of a sight line is not set, and unstable images are repeated. Easy operability is provided for reproduction with such videos avoided.

### Second Embodiment

In the present embodiment, effort at the time of analyzing a moving image is reduced by enabling simple recognition of a scene at a reproduction timing. Specifically, the entire flow of the moving image may be recognized by extracting a scene that is expected to be meaningful, and scrolling the representative image of the scene.

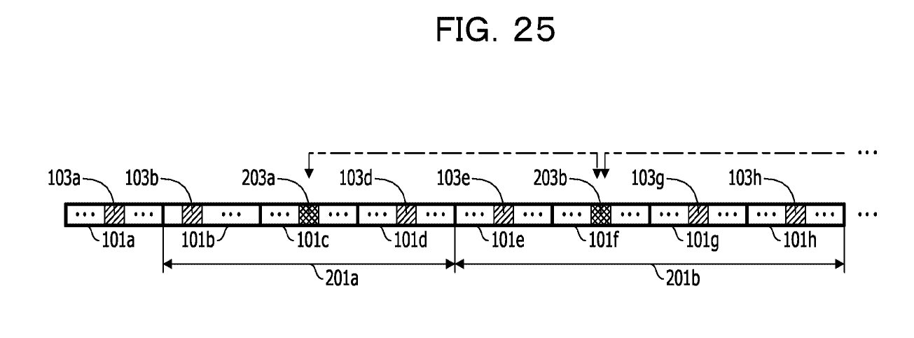

In the present embodiment, the second representative images 203 illustrated in FIG. 25 are compared after the comparison of the first representative images 103 illustrated in FIG. 1 and FIG. 2. FIG. 25 will be described. A stable period 201b is specified in addition to the stable period 201a, and a first representative image 103f in a unit period 101f is selected as a second representative image 203b.

In this stage, the second representative images 203 that are in direct adjacency in a linear arrangement of the second representative images 203 are compared. For example, the second representative image 203a and the second representative image 203b are compared. In the case of both of the second representative images 203 having similar tone, both of the second representative images 203 are determined to correspond to the same scene period. A scene period corresponds to one scene.

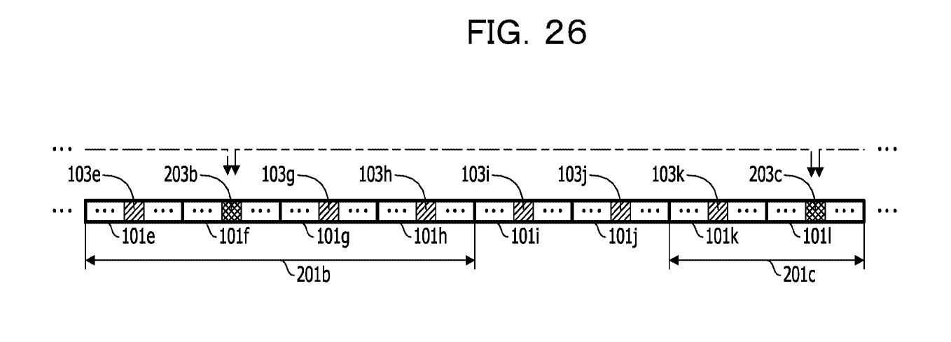

In FIG. 26, the second representative image 203b and a second representative image 203c are compared. The stable periods 201 including the second representative images 203 of comparison targets are not continuous at all times. Comparison may be performed with the unit period 101 not corresponding to the stable period 201 interposed between the stable periods 201, like a unit period 101i and a unit period 101j.

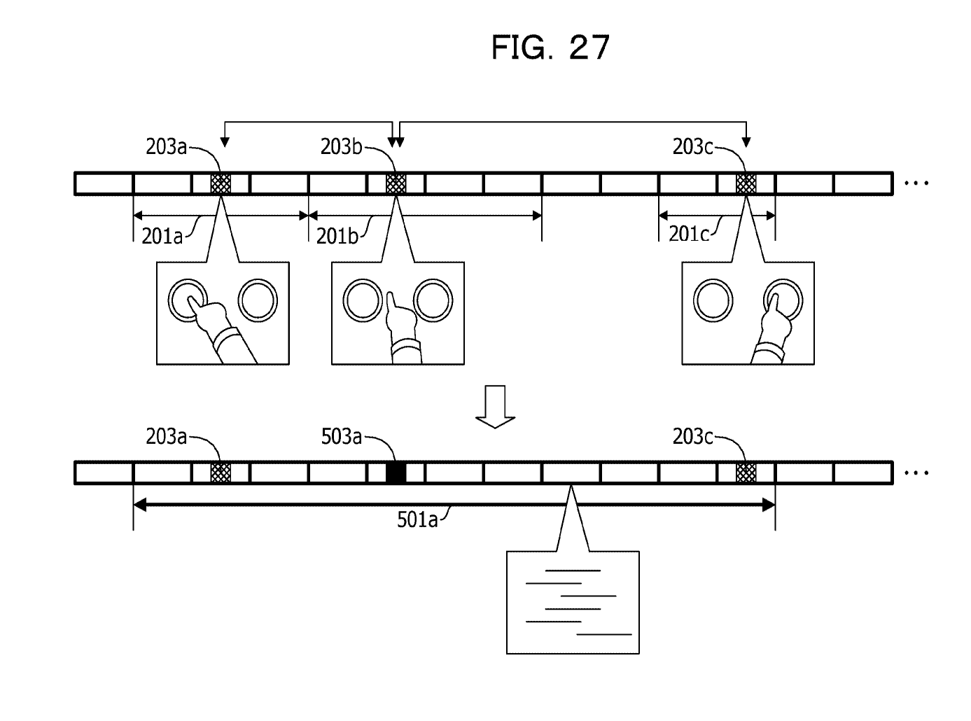

FIG. 27 will be described. In this example, the second representative image 203a and the second representative image 203b have similar tone, and the second representative image 203b and the second representative image 203c have similar tone. In this example, a hand of a worker is captured on an operating surface that includes two button switches. While there is a large change in the position of the subject in images since the position of the hand is different, the projected subject is the same, and thus tone is similar. A sequence of the second representative images 203 having similar tone is a scene period 501. In this example, the second representative image 203a to the second representative image 203c correspond to a scene period 501a.

A third representative image 503 is selected in each scene period 501. In this example, the second representative image 203b that has the sharpest edge of the second representative image 203a to the second representative image 203c included in the scene period 501a is selected as a third representative image 503a.

In the unit period 101i and the unit period 101j that do not correspond to the stable period 201, the worker looks aside for a moment, and the video is blurred. The tone of the frame image in this period is not similar to the tone of the second representative image 203a to the second representative image 203c. However, in the present embodiment, one scene period 501 may be specified by including this period.

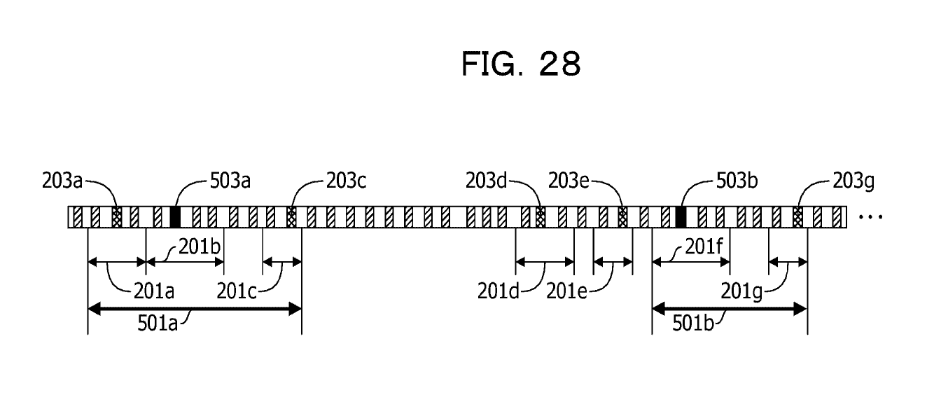

FIG. 28 illustrates an array of the first representative images 103, the second representative images 203, and the third representative images 503. A rectangle that is hatched in FIG. 28 illustrates the first representative image 103 that does not correspond to any of the second representative image 203 and the third representative image 503. As a result of analysis in the present embodiment, the first representative image 103 that does not correspond to any of the second representative image 203 and the third representative image 503, the second representative image 203 that does not correspond to the third representative image 503, and the third representative image 503 are linearly arranged. In the present embodiment, a process of selectively displaying these representative images is also performed.

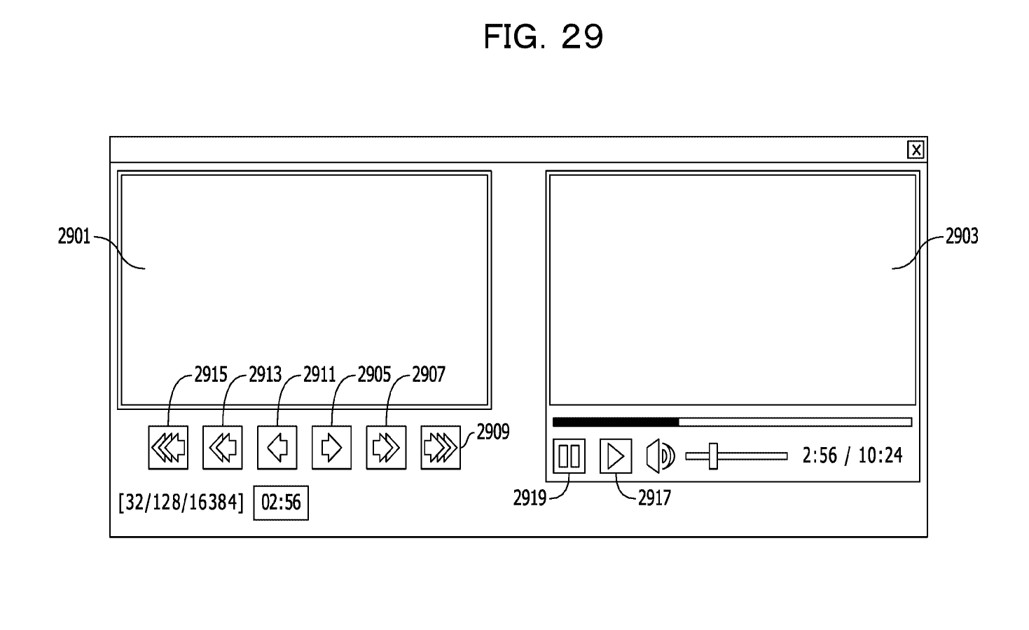

FIG. 29 illustrates a display operating screen of a second viewer. A first image area 2901 displays a frame image (for example, the first representative image 103 to the third representative image 503). A second image area 2903 displays a moving image.

If a first subsequent button 2905 is touched, an instruction to display the subsequent first representative image 103 in the first image area 2901 is provided. If a second subsequent button 2907 is touched, an instruction to display the subsequent second representative image 203 in the first image area 2901 is provided. If a third subsequent button 2909 is touched, an instruction to display the subsequent third representative image 503 in the first image area 2901 is provided. If a first previous button 2911 is touched, an instruction to display the previous first representative image 103 in the first image area 2901 is provided. If a second previous button 2913 is touched, an instruction to display the previous second representative image 203 in the first image area 2901 is provided. If a third previous button 2915 is touched, an instruction to display the previous third representative image 503 in the first image area 2901 is provided.

If a moving image reproduction button 2917 is touched, a moving image that is reproduced from the frame image displayed in the first image area 2901 is displayed in the second image area 2903. If a reproduction stop button 2919 is touched, reproduction of the moving image is stopped, and a lastly reproduced frame (or a lastly reproduced first representative image) is displayed in the first image area 2901. While a touch operation or a slide operation performed on a touch panel included in a second moving image processing apparatus is received in this example, another operation (for example, a click operation or a drag operation with a mouse included in the second moving image processing apparatus) may be received. A moving image processing apparatus according to embodiments below will be referred to as a second moving image processing apparatus.

Besides, the number of first representative images 103 (in this example, 16,384), the number of second representative images 203 (in this example, 128), and the number of third representative images 503 (in this example, 32) are displayed. The amount of time of reproducing a moving image (in this example, 10 minutes 24 seconds) and the current reproduction timing (in this example, 2 minutes 56 seconds) are also displayed. The length of the stable period 201 and/or the length of the scene period 501 may be displayed.

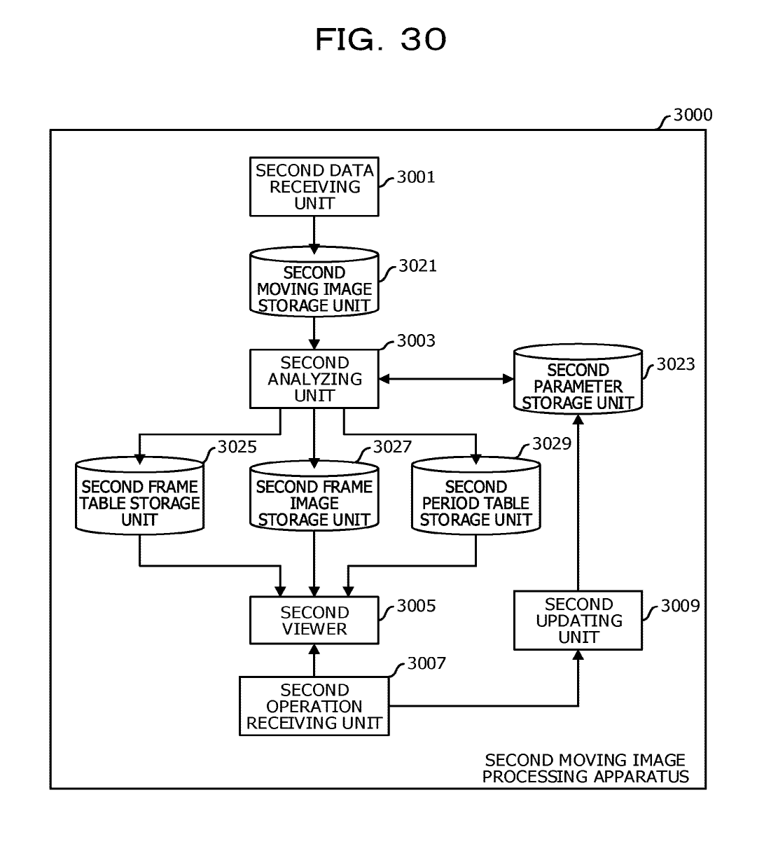

FIG. 30 illustrates a modular configuration of the second moving image processing apparatus. A second moving image processing apparatus 3000 includes a second data receiving unit 3001, a second analyzing unit 3003, a second viewer 3005, a second operation receiving unit 3007, a second updating unit 3009, a second moving image storage unit 3021, a second parameter storage unit 3023, a second frame table storage unit 3025, a second frame image storage unit 3027, and a second period table storage unit 3029.

The second data receiving unit 3001 receives moving image data. The second analyzing unit 3003 analyzes moving image data. The second viewer 3005 displays a frame image and a moving image. The second operation receiving unit 3007 receives an operation performed by a user. The second updating unit 3009 updates a parameter that is used in analysis of moving image data. The second viewer 3005 may perform processes for registering additional data or generating a representative image group.

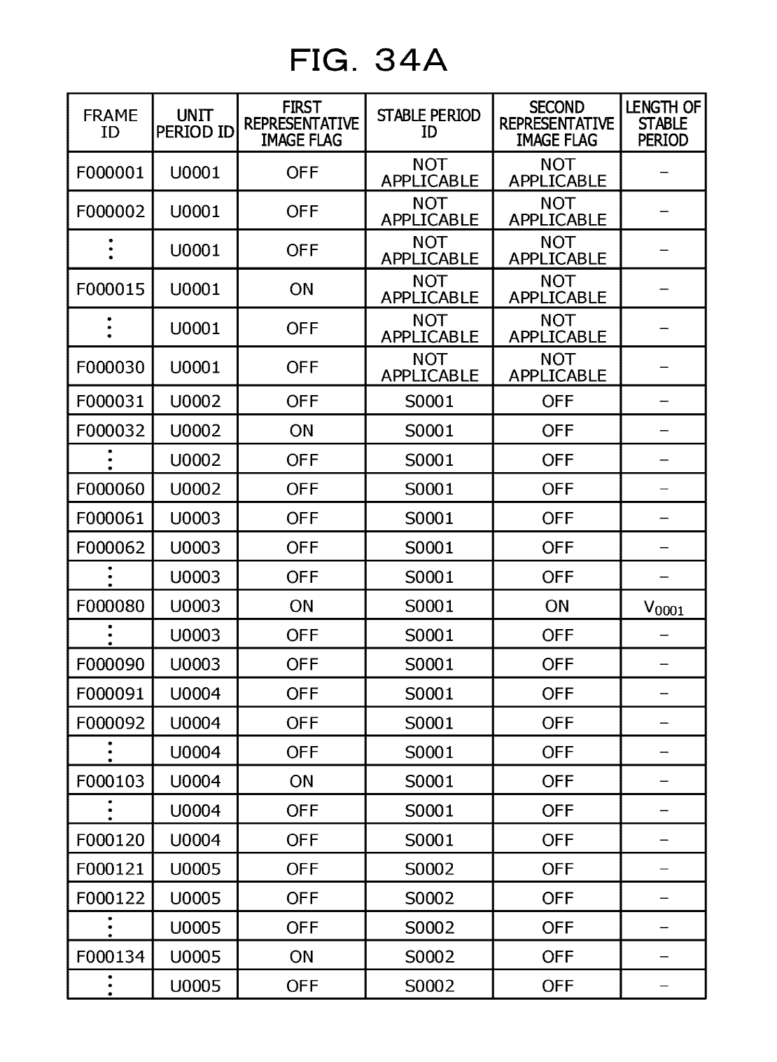

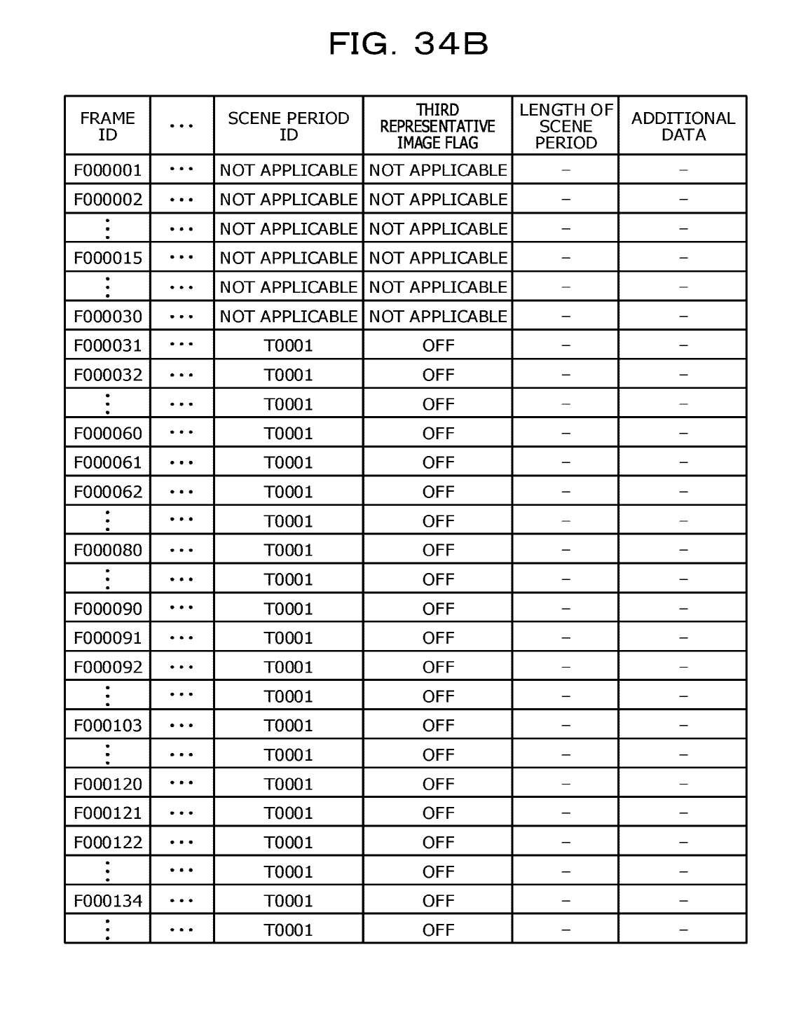

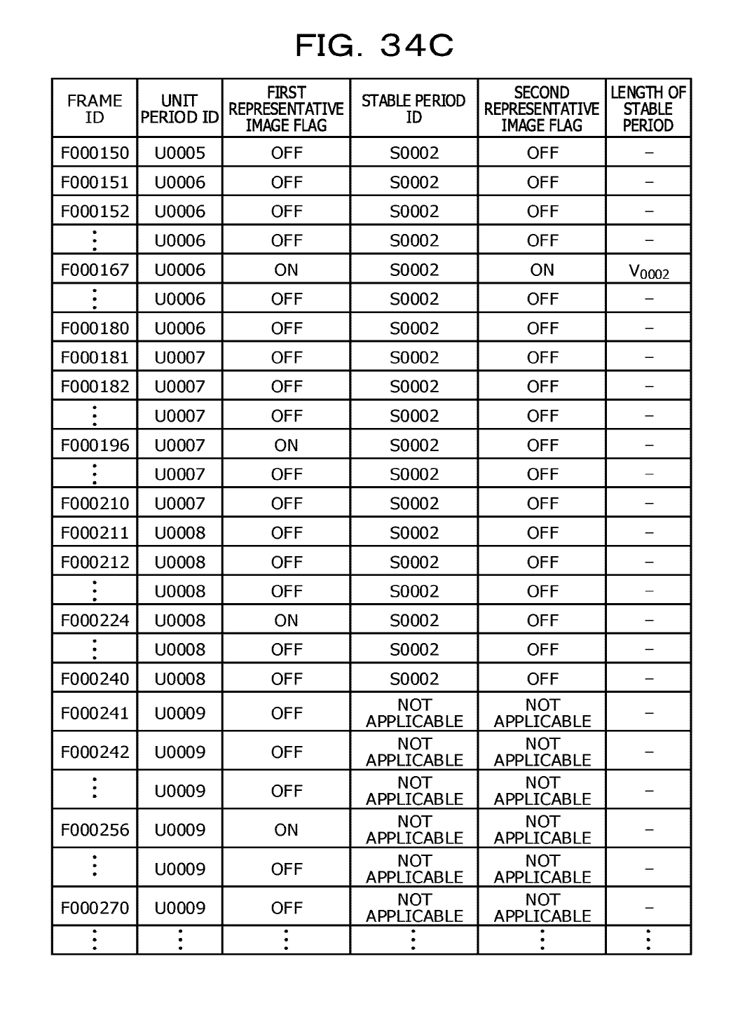

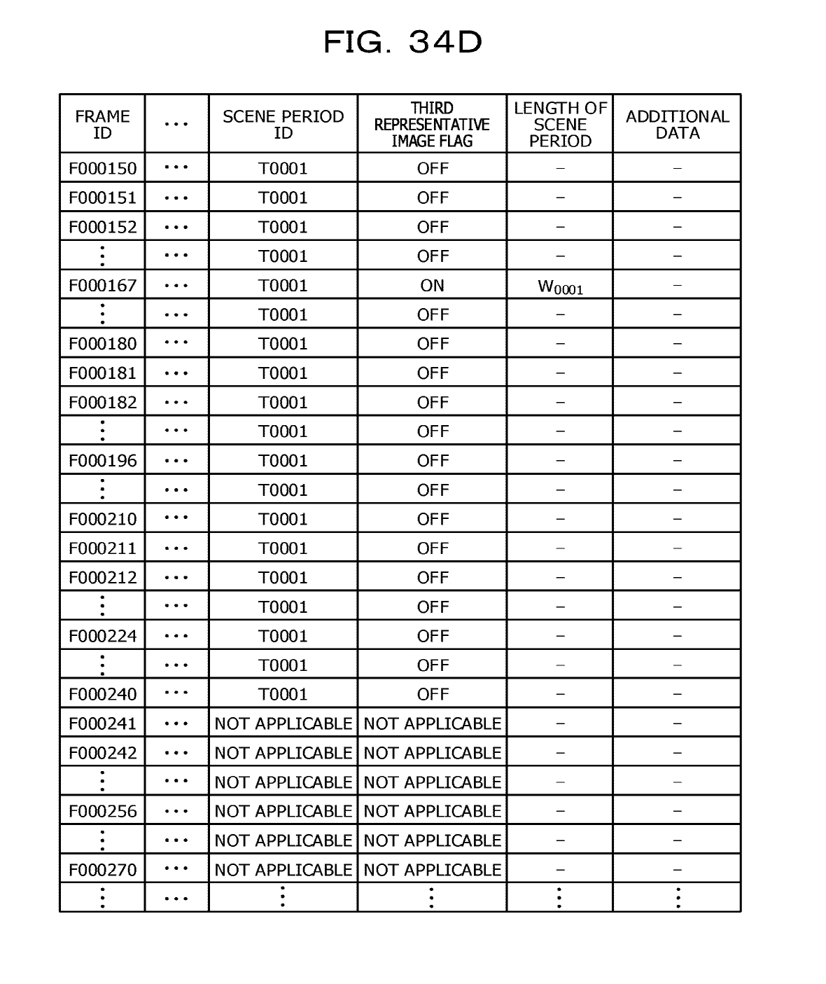

The second moving image storage unit 3021 stores moving image data. The second parameter storage unit 3023 stores a parameter that is used in analysis of moving image data. The second frame table storage unit 3025 stores a frame table. The frame table is the same as that in the case of the first embodiment. The second frame image storage unit 3027 stores a file of a frame image. The second period table storage unit 3029 stores a period table. The period table according to the present embodiment will be described later by using FIG. 34A to FIG. 34D.

The second data receiving unit 3001, the second analyzing unit 3003, the second viewer 3005, the second operation receiving unit 3007, and the second updating unit 3009 are realized by using hardware resources (for example, FIG. 59) and the program that causes the processor to perform processes described below.

The second moving image storage unit 3021, the second parameter storage unit 3023, the second frame table storage unit 3025, the second frame image storage unit 3027, and the second period table storage unit 3029 are realized by using hardware resources (for example, FIG. 59).

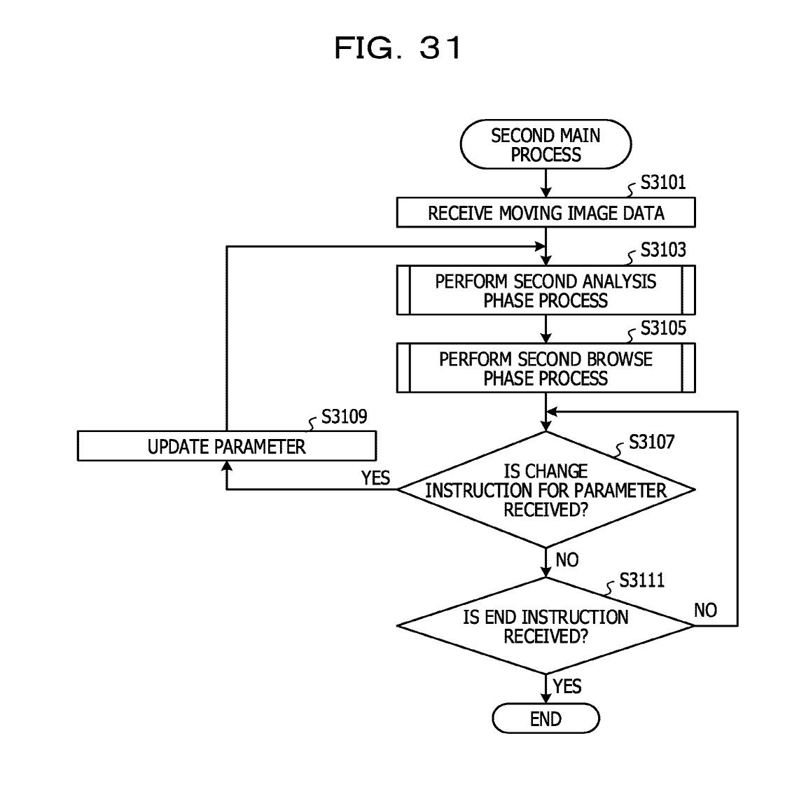

Next, a second main process in the second moving image processing apparatus 3000 will be described. FIG. 31 illustrates the flow of the second main process. The second data receiving unit 3001 receives moving image data (S3101). The received moving image data is stored in the second moving image storage unit 3021.

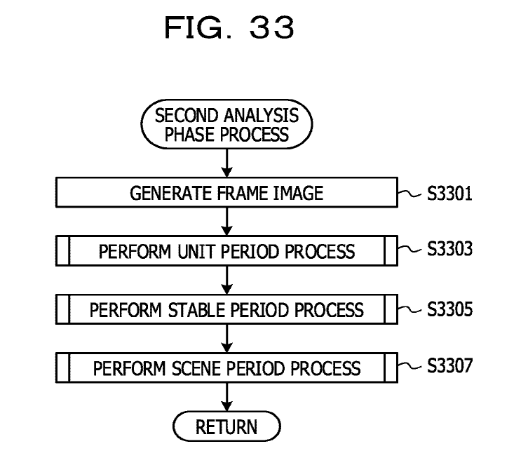

In the present embodiment, the second analyzing unit 3003 performs a second analysis phase process (S3103). In the second analysis phase process, the moving image data is analyzed. The second analysis phase process will be described later by using FIG. 33 and the like.

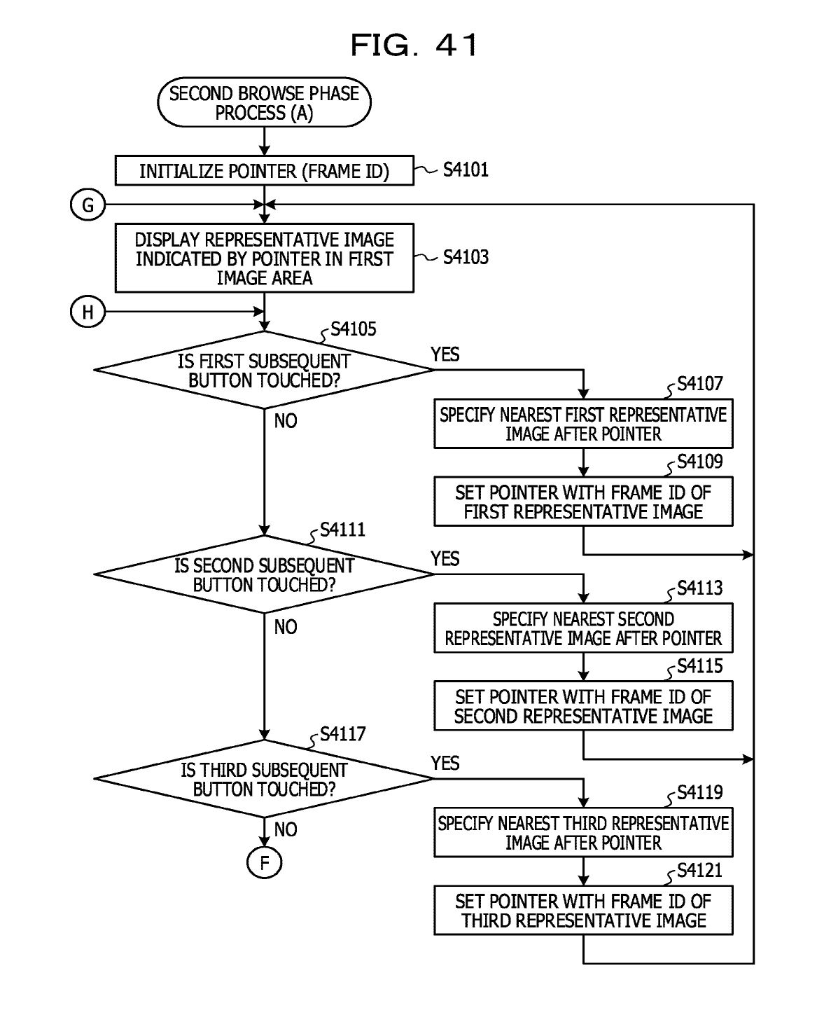

The second viewer 3005 performs a second browse phase process (S3105). In the second browse phase process, a process for browsing a frame image and a reproduced moving image is performed. The second browse phase process will be described later by using FIG. 41 and the like.

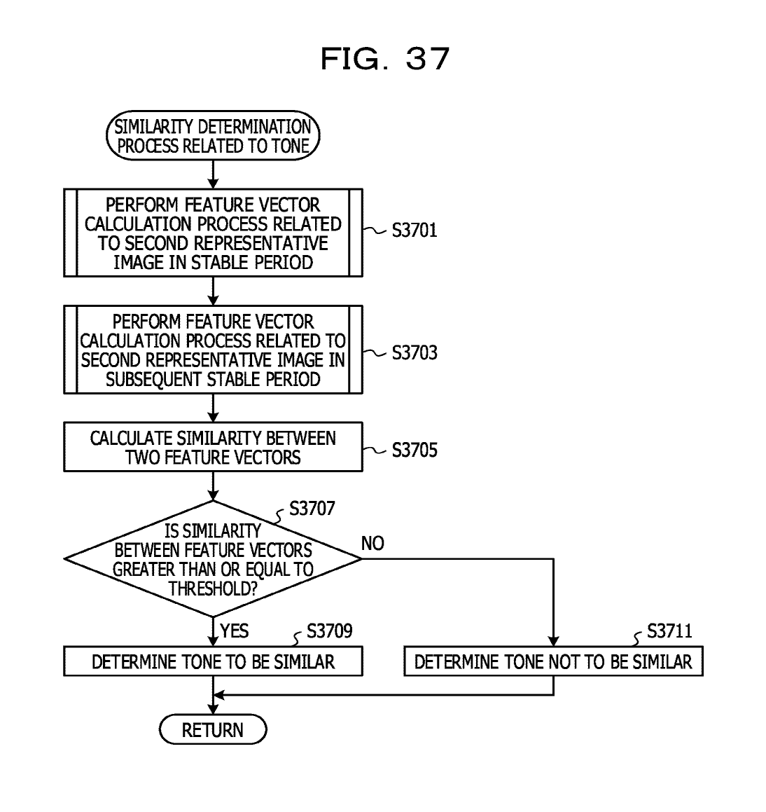

The second operation receiving unit 3007 determines whether or not a change instruction for a parameter is received (S3107). A parameter of a target of change is stored in the second parameter storage unit 3023. The parameter of a target of change is, for example, the length of the unit period 101, the threshold used in S1311 of FIG. 13, or a threshold used in S3707 of FIG. 37 described later.

In the case of determining a change instruction for a parameter to be received, the second updating unit 3009 updates the parameter in accordance with the change instruction (S3109). Then, a return is made to the process illustrated in S3103, and the above processes are repeated.

Meanwhile, in the case of determining a change instruction for a parameter not to be received, the second operation receiving unit 3007 determines whether or not an end instruction is received (S3111). In the case of determining an end instruction to be received, the second main process is ended.

Meanwhile, in the case of determining an end instruction not to be received, a return is made to the process illustrated in S3107, and the above processes are repeated.

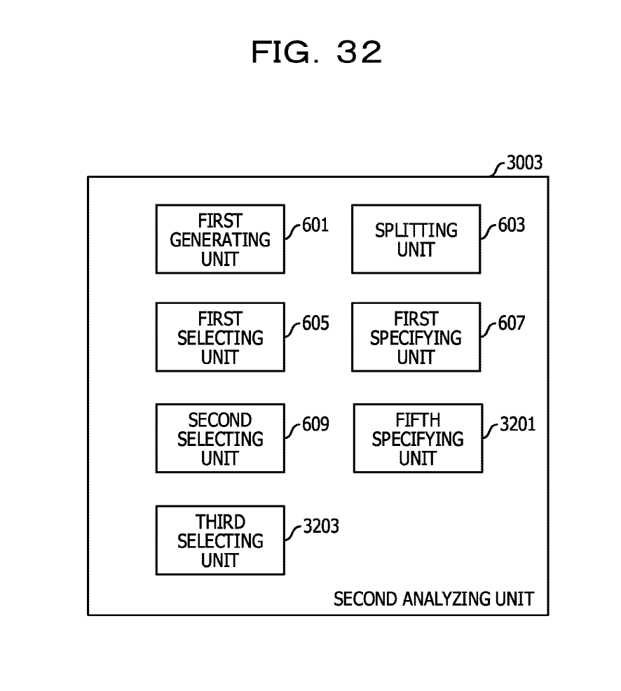

Next, the second analyzing unit 3003 that performs the second analysis phase process will be described. FIG. 32 illustrates a modular configuration of the second analyzing unit 3003. The second analyzing unit 3003 includes the first generating unit 601, the splitting unit 603, the first selecting unit 605, the first specifying unit 607, the second selecting unit 609, a fifth specifying unit 3201, and a third selecting unit 3203.

The first generating unit 601 generates a frame image based on moving image data. The splitting unit 603 splits the moving image reproduction time into the unit periods 101. The first selecting unit 605 selects the first representative image 103 that represents the unit period 101. The first specifying unit 607 specifies the stable period 201. The second selecting unit 609 selects the second representative image 203 that represents the stable period 201. The fifth specifying unit 3201 specifies the scene period 501. The third selecting unit 3203 selects the third representative image 503 that represents the scene period 501.

The first generating unit 601, the splitting unit 603, the first selecting unit 605, the first specifying unit 607, the second selecting unit 609, the fifth specifying unit 3201, and the third selecting unit 3203 are realized by using hardware resources (for example, FIG. 59) and the program that causes the processor to perform processes described below.

FIG. 33 illustrates the flow of the second analysis phase process. The first generating unit 601 generates a frame image based on moving image data (S3301). The generated frame image is stored in the second frame image storage unit 3027. At this point, a frame ID and a file name and a reproduction timing of a frame image are set in the frame table. A frame image that does not correspond to a representative image may be deleted in the stage after analysis is ended.

A process of S3303 is the same as the process of S703 in FIG. 7. A process of S3305 is the same as the process of S705 in FIG. 7.

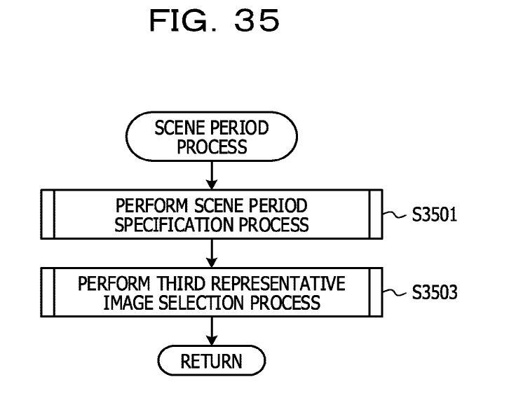

The second analyzing unit 3003 performs a scene period process (S3307). In the scene period process, the scene period 501 is specified, and a representative image in the scene period 501 (that is, the third representative image 503) is selected. The scene period process will be described later by using FIG. 35. When the second analysis phase process is ended, a return is made to a caller of the second main process.

FIG. 34A to FIG. 34D illustrate an example of the period table according to the present embodiment. The period table in this example includes a record corresponding to a frame. The record of the period table includes a field storing a frame ID, a field storing a unit period ID, a field of a first representative image flag, a field storing a stable period ID, a field of a second representative image flag, a field storing the length of the stable period 201, a field storing a scene period ID, a field of a third representative image flag, a field storing the length of the scene period 501, and a field storing additional data.

The frame ID specifies a frame. The unit period ID specifies the unit period 101 to which the frame belongs. The first representative image flag is ON in the case of the image of the frame corresponding to the first representative image 103. If the first representative image flag is OFF, the frame does not correspond to the first representative image 103. The stable period ID specifies the stable period 201 to which the frame belongs. In the case of the frame not being included in the stable period 201, the text “not applicable” is set. The second representative image flag is ON in the case of the frame corresponding to the second representative image 203. If the second representative image flag is OFF, the frame does not correspond to the second representative image 203. The length of the stable period 201 is set in the record corresponding to the second representative image 203. The scene period ID specifies the scene period 501 to which the frame belongs. The third representative image flag is ON in the case of the frame corresponding to the third representative image 503. If the third representative image flag is OFF, the frame does not correspond to the third representative image 503. The length of the scene period 501 is set in the record corresponding to the third representative image 503. FIG. 34C illustrates a part continued from FIG. 34A. FIG. 34D illustrates a part continued from FIG. 34B.

FIG. 35 illustrates the flow of the scene period process. The fifth specifying unit 3201 performs a specification process of the scene period 501 (S3501).

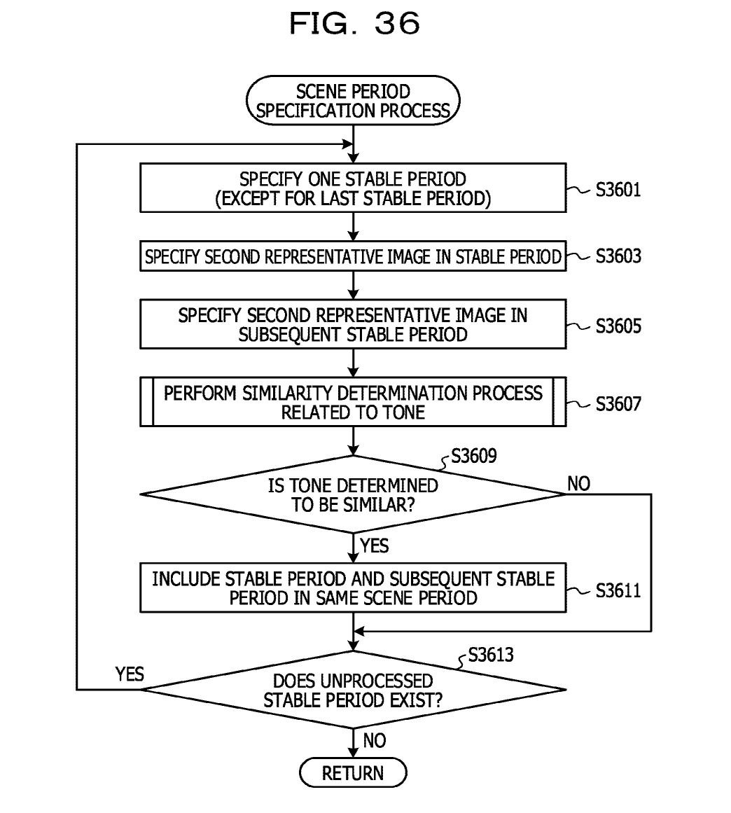

FIG. 36 illustrates the flow of the specification process of the scene period 501. The fifth specifying unit 3201 specifies one stable period 201 (S3601). For example, the fifth specifying unit 3201 specifies the stable period 201 in reproduction order. The last stable period 201 is not specified.

The fifth specifying unit 3201 specifies the second representative image 203 in the stable period 201 (S3603). The fifth specifying unit 3201 specifies the second representative image 203 in the subsequent stable period 201 (S3605). Then, the fifth specifying unit 3201 performs a similarity determination process related to tone (S3607).

FIG. 37 illustrates the flow of the similarity determination process related to tone. The fifth specifying unit 3201 performs a feature vector calculation process related to the second representative image 203 specified in S3603 (S3701). In the feature vector calculation process, a feature vector that indicates tone is calculated.

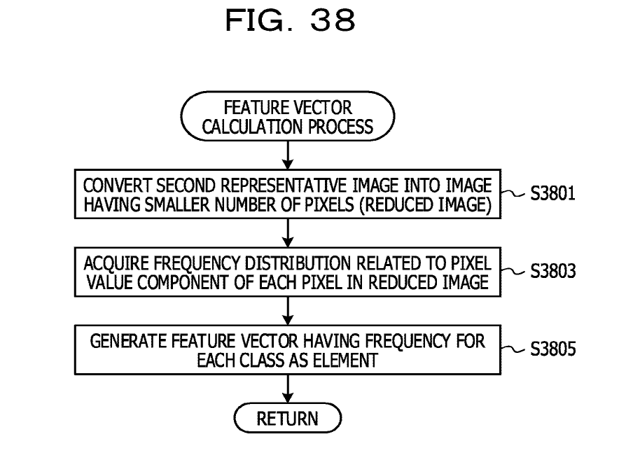

FIG. 38 illustrates the flow of the feature vector calculation process. The fifth specifying unit 3201 converts the second representative image 203 into an image having a smaller number of pixels (reduced image) (S3801). The fifth specifying unit 3201 acquires a frequency distribution related to a pixel value component (for example, luminance or an RGB value) of each pixel in the reduced image (S3803). The fifth specifying unit 3201 generates a feature vector that includes a frequency for each class as an element (S3805). Then, when the feature vector calculation process is ended, a return is made to a caller of the similarity determination process related to tone. The process of S3801 may be omitted, and the frequency distribution related to the pixel value component of each pixel in the second representative image 203 may be acquired in S3803.

FIG. 37 will be described again. The fifth specifying unit 3201 performs the feature vector calculation process related to the second representative image 203 specified in S3605 (S3703). The fifth specifying unit 3201 calculates similarity between the two feature vectors (S3705). The fifth specifying unit 3201 determines whether or not the similarity between the feature vectors is greater than or equal to the threshold (S3707). In the case of the similarity between the feature vectors being greater than or equal to the threshold, the fifth specifying unit 3201 determines tone to be similar (S3709). Meanwhile, in the case of the similarity between the feature vectors not being greater than or equal to the threshold, the fifth specifying unit 3201 determines tone not to be similar (S3711). When the similarity determination process related to tone is ended, a return is made to a caller of the specification process of the scene period 501.

FIG. 36 will be described again. The fifth specifying unit 3201 causes the process to branch according to whether or not tone is determined to be similar (S3609). In the case of determining tone to be similar, the fifth specifying unit 3201 includes the stable period 201 and the subsequent stable period 201 in the same scene period 501 (S3611). Specifically, the same value as the scene period ID in the record of each frame included in the stable period 201 is set in the scene period ID in the record of each frame included in the subsequent stable period 201. In the case of a scene period ID not being set in the record of each frame included in the stable period 201, a new scene period ID is set in the record of each frame included in both of the stable periods 201.

Meanwhile, in the case of determining tone not to be similar, a transition is made to a process of S3613.

The fifth specifying unit 3201 determines whether or not an unprocessed stable period 201 exists (S3613). In the case of determining an unprocessed stable period 201 to exist, a return is made to the process illustrated in S3601, and the above processes are repeated.

Meanwhile, in the case of determining an unprocessed stable period 201 not to exist, the specification process of the scene period 501 is ended. When the specification process of the scene period 501 is ended, a return is made to a caller of the scene period process.

FIG. 35 will be described again. The third selecting unit 3203 performs a selection process of the third representative image 503 (S3503).

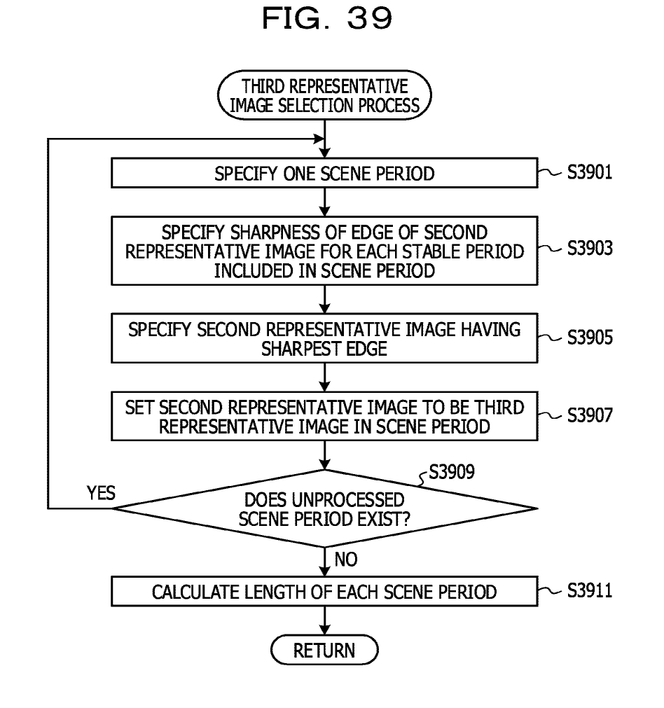

FIG. 39 illustrates the flow of the selection process of the third representative image 503. The third selecting unit 3203 specifies one scene period 501 (S3901). For example, the third selecting unit 3203 specifies a scene period ID in reproduction order in the period table.

The third selecting unit 3203 specifies the sharpness of an edge of the second representative image 203 of the stable period 201 for each stable period 201 included in the scene period 501 (S3903). Specifically, the third selecting unit 3203 reads the sharpness of an edge in the second representative image 203 from the frame table. The same applies in the case of using another index that indicates the clearness of a frame.

The third selecting unit 3203 specifies the second representative image 203 having the sharpest edge (that is, the clearest second representative image 203) of the second representative images 203 of the stable period 201 included in the scene period 501 (S3905). The third selecting unit 3203 sets the second representative image 203 to be the third representative image 503 in the scene period 501 (S3907). Specifically, the third representative image flag in the record corresponding to the second representative image 203 is set to ON. The third representative image flag in the record corresponding to a frame image other than the third representative image 503 is set to OFF.

The third selecting unit 3203 determines whether or not an unprocessed scene process 501 exists (S3909). In the case of determining an unprocessed scene period 501 to exist, a return is made to the process illustrated in S3901, and the above processes are repeated.

Meanwhile, in the case of determining an unprocessed scene period 501 not to exist, the third selecting unit 3203 calculates the length of each scene period 501 (S3911). The calculated length of the scene period 501 is set in the record of the third representative image 503 in the period table. Specifically, the reproduction timing of the frame in the initial record of records having the same scene period ID set is subtracted from the reproduction timing of the frame in the last record in the period table, and thus the length of the scene period 501 specified by the scene period ID is acquired. When the selection process of the third representative image 503 is ended, a return is made to a caller of the scene period process.

In a certain experiment, the number of first representative images 103 is approximately 4.0 percent of the number of frame images. The number of second representative images 203 is approximately 0.85 percent of the number of frame images. The number of third representative images 503 is approximately 0.20 percent of the number of frame images. In the present embodiment, accordingly, frame images of targets of browsing may be narrowed. The second analysis phase process is described heretofore.

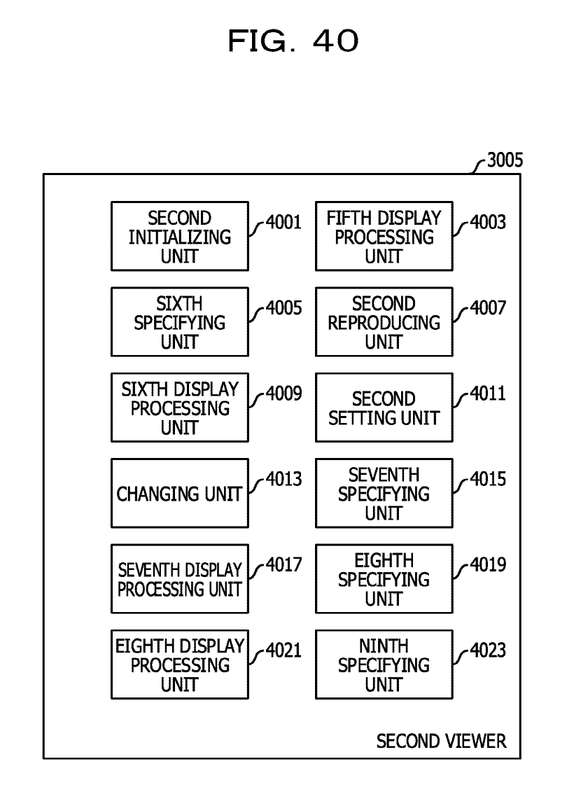

Next, the second browse phase process will be described. FIG. 40 illustrates a modular configuration of the second viewer 3005. The second viewer 3005 includes a second initializing unit 4001, a fifth display processing unit 4003, a sixth specifying unit 4005, a second reproducing unit 4007, a sixth display processing unit 4009, a second setting unit 4011, a changing unit 4013, a seventh specifying unit 4015, a seventh display processing unit 4017, an eighth specifying unit 4019, an eighth display processing unit 4021, and a ninth specifying unit 4023.

The second initializing unit 4001 initializes a mode and a pointer for specifying a display target. The fifth display processing unit 4003 displays a frame image in the first image area 2901. The sixth specifying unit 4005 specifies a display target in response to an operation of the user in the second embodiment. The second reproducing unit 4007 reproduces a moving image. The sixth display processing unit 4009 displays a moving image. The second setting unit 4011 sets the pointer with the ID of the frame that is lastly reproduced as a moving image (or the frame ID of the first representative image 103 that is lastly reproduced). The changing unit 4013 changes the mode in response to an operation of the user. The seventh specifying unit 4015 specifies a display target in response to an operation of the user in a fourth embodiment. The seventh display processing unit 4017 performs a second thumbnail display process in a fifth embodiment. The eighth specifying unit 4019 specifies a display target in response to an operation of the user in the fifth embodiment. The eighth display processing unit 4021 performs a second mark array display process in sixth and seventh embodiments. The ninth specifying unit 4023 specifies a display target in response to an operation of the user in the sixth and seventh embodiments.

The second initializing unit 4001, the fifth display processing unit 4003, the sixth specifying unit 4005, the second reproducing unit 4007, the sixth display processing unit 4009, the second setting unit 4011, the changing unit 4013, the seventh specifying unit 4015, the seventh display processing unit 4017, the eighth specifying unit 4019, the eighth display processing unit 4021, and the ninth specifying unit 4023 are realized by using hardware resources (for example, FIG. 59) and the program that causes the processor to perform processes described below.

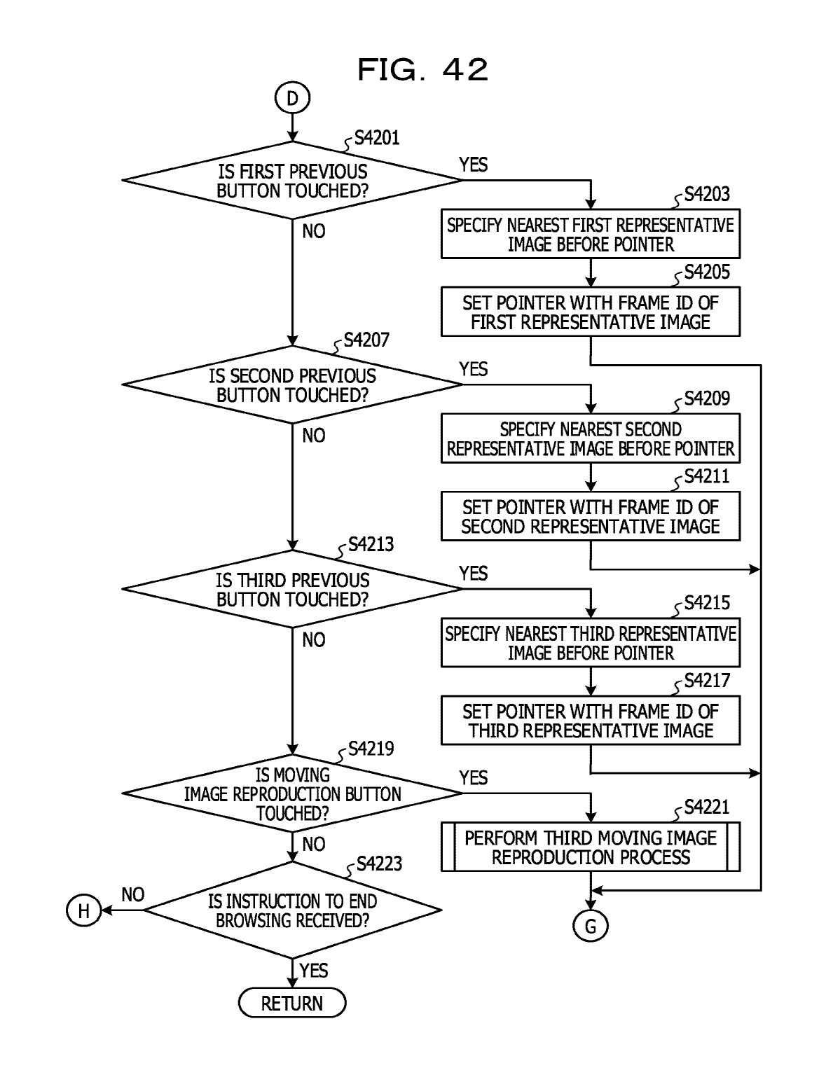

In the present embodiment, a second browse phase process (A) is performed in S3105 illustrated in FIG. 31. FIG. 41 and FIG. 42 illustrate the flow of the second browse phase process (A). The second initializing unit 4001 initializes the pointer (S4101). The pointer is an internal parameter that indicates the frame ID of a representative image displayed in the first image area 2901. The second initializing unit 4001 sets the pointer with, for example, the frame ID of the leading first representative image 103. The pointer may be set with the frame ID of the leading second representative image 203. The pointer may be set with the frame ID of the leading third representative image 503. The pointer may be initialized in any manner.

The fifth display processing unit 4003 displays a representative image indicated by the pointer in the first image area 2901 (S4103). Specifically, the file name of the frame image corresponding to the frame ID indicated by the pointer is specified, and the frame image of the file is loaded and displayed in the first image area 2901.

The second operation receiving unit 3007 determines whether or not the first subsequent button 2905 is touched (S4105). In the case of determining the first subsequent button 2905 to be touched, the sixth specifying unit 4005 specifies the nearest first representative image 103 after the pointer (S4107). Specifically, the sixth specifying unit 4005 searches in the period table for the immediately nearby record having the first representative image flag set to ON from the records after the record of the frame ID indicated by the pointer. Then, the sixth specifying unit 4005 sets the pointer with the frame ID of the first representative image 103 (S4109). Then, a return is made to the process illustrated in S4103, and the above processes are repeated.

Meanwhile, in the case of determining the first subsequent button 2905 not to be touched, the second operation receiving unit 3007 determines whether or not the second subsequent button 2907 is touched (S4111). In the case of determining the second subsequent button 2907 to be touched, the sixth specifying unit 4005 specifies the nearest second representative image 203 after the pointer (S4113). Specifically, the sixth specifying unit 4005 searches in the period table for the immediately nearby record having the second representative image flag set to ON from the records after the record of the frame ID indicated by the pointer. Then, the sixth specifying unit 4005 sets the pointer with the frame ID of the second representative image 203 (S4115). Then, a return is made to the process illustrated in S4103, and the above processes are repeated.

Meanwhile, in the case of determining the second subsequent button 2907 not to be touched, the second operation receiving unit 3007 determines whether or not the third subsequent button 2909 is touched (S4117). In the case of determining the third subsequent button 2909 to be touched, the sixth specifying unit 4005 specifies the nearest third representative image 503 after the pointer (S4119). Specifically, the sixth specifying unit 4005 searches in the period table for the immediately nearby record having the third representative image flag set to ON from the records after the record of the frame ID indicated by the pointer. Then, the sixth specifying unit 4005 sets the pointer with the frame ID of the third representative image 503 (S4121). Then, a return is made to the process illustrated in S4103, and the above processes are repeated.

Meanwhile, in the case of determining the third subsequent button 2909 not to be touched, a transition is made to a process of S4201 illustrated in FIG. 42 through a terminal F.

FIG. 42 will be described. The second operation receiving unit 3007 determines whether or not the first previous button 2911 is touched (S4201). In the case of determining the first previous button 2911 to be touched, the sixth specifying unit 4005 specifies the nearest first representative image 103 before the pointer (S4203). Specifically, the sixth specifying unit 4005 searches in the period table for the immediately nearby record having the first representative image flag set to ON from the records before the record of the frame ID indicated by the pointer. Then, the sixth specifying unit 4005 sets the pointer with the frame ID of the first representative image 103 (S4205). Then, a return is made to the process illustrated in S4103 of FIG. 41 through a terminal G, and the above processes are repeated.

Meanwhile, in the case of determining the first previous button 2911 not to be touched, the second operation receiving unit 3007 determines whether or not the second previous button 2913 is touched (S4207). In the case of determining the second previous button 2913 to be touched, the sixth specifying unit 4005 specifies the nearest second representative image 203 before the pointer (S4209). Specifically, the sixth specifying unit 4005 searches in the period table for the immediately nearby record having the second representative image flag set to ON from the records before the record of the frame ID indicated by the pointer. Then, the sixth specifying unit 4005 sets the pointer with the frame ID of the second representative image 203 (S4211). Then, a return is made to the process illustrated in S4103 of FIG. 41 through the terminal G, and the above processes are repeated.

Meanwhile, in the case of determining the second previous button 2913 not to be touched, the second operation receiving unit 3007 determines whether or not the third previous button 2915 is touched (S4213). In the case of determining the third previous button 2915 to be touched, the sixth specifying unit 4005 specifies the nearest third representative image 503 before the pointer (S4215). Specifically, the sixth specifying unit 4005 searches in the period table for the immediately nearby record having the third representative image flag set to ON from the records before the record of the frame ID indicated by the pointer. Then, the sixth specifying unit 4005 sets the pointer with the frame ID of the third representative image 503 (S4217). Then, a return is made to the process illustrated in S4103 of FIG. 41 through the terminal G, and the above processes are repeated.

Meanwhile, in the case of determining the third previous button 2915 not to be touched, the second operation receiving unit 3007 determines whether or not the moving image reproduction button 2917 is touched (S4219). In the case of determining the moving image reproduction button 2917 to be touched, the second viewer 3005 performs a third moving image reproduction process (S4221). In the third moving image reproduction process, a moving image is reproduced from the frame image indicated by the pointer.

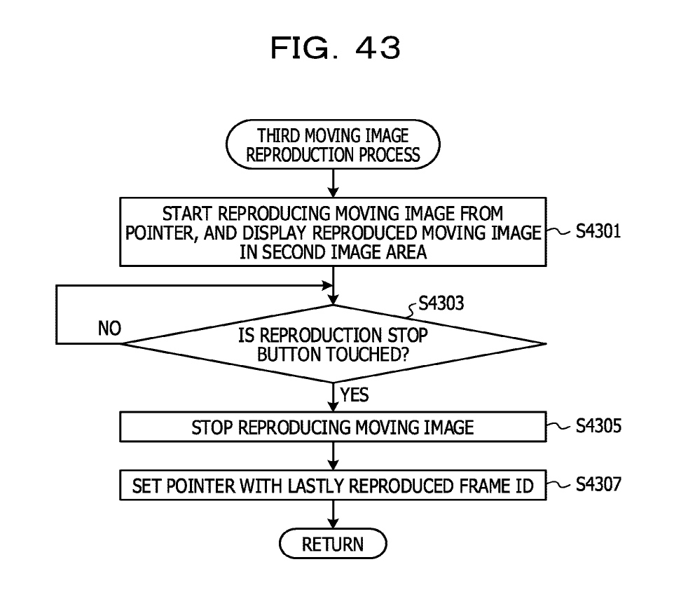

FIG. 43 illustrates the flow of the third moving image reproduction process. The second reproducing unit 4007 starts reproducing a moving image from the reproduction timing of the frame image indicated by the pointer, and the sixth display processing unit 4009 displays the reproduced moving image in the second image area 2903 (S4301).

The second operation receiving unit 3007 determines whether or not the reproduction stop button 2919 is touched (S4303). In the case of determining the reproduction stop button 2919 not to be touched, the process of S4303 is repeated.

Meanwhile, in the case of determining the reproduction stop button 2919 to be touched, the second reproducing unit 4007 stops reproducing the moving image (S4305). Then, the second setting unit 4011 sets the pointer with the lastly reproduced frame ID (or the frame ID of the lastly reproduced first representative image 103) (S4307). When the third moving image reproduction process is ended, a return is made to a caller of the second browse phase process (A).

FIG. 42 will be described again. When the third moving image reproduction process is ended, a return is made to the process of S4103 illustrated in FIG. 41 through the terminal G.

In the case of determining the moving image reproduction button 2917 not to be touched in S4219, the second operation receiving unit 3007 determines whether or not an instruction to end browsing is received (S4223). In the case of determining an instruction to end browsing to be received, the second browse phase process (A) is ended, and a return is made to a caller of the second main process.

Meanwhile, in the case of determining an instruction to end browsing not to be received, a return is made to the process illustrated in S4105 of FIG. 41 through a terminal H, and the above processes are repeated.

The second browse phase process (A) is described heretofore. An unclear image is unlikely to be included in the first representative image 103 selected in the second analysis phase. Thus, browsing is facilitated. Similarly, images having similar compositions are not included in the second representative image 203. Thus, browsing is facilitated. Similarly, images included in the same scene do not overlap with each other in the third representative image 503. Thus, browsing is facilitated.

An unclear image is excluded in the state of selecting the first representative image 103, and the second representative image 203 and the third representative image 503 are selected with the first representative image 103 as a candidate. Thus, the second representative image 203 and the third representative image 503 are clear.

In the second browse phase, if the subsequent first representative image 103 is displayed, or the previous first representative image 103 is displayed, a transition in a short period may be recognized.

In the case of recognizing a transition in the same scene, the user feels convenience if the subsequent second representative image 203 is displayed, or the previous second representative image 203 is displayed.

If the subsequent third representative image 503 is displayed, the user may recognize the immediately subsequent scene. Conversely, if the previous third representative image 503 is displayed, the user may recognize the immediately previous scene.

In this example, buttons for scroll operations for the first representative image 103 to the third representative image 503 are included in one display operating screen. Thus, scroll operations for the first representative image 103 to the third representative image 503 may be appropriately combined. Then, a work for finding a desired frame image is simplified.

Representative images are scrolled by indicating one image at a time. Thus, a similar operation to the case of slide browsing is realized. Therefore, the present embodiment is easily applied as, for example, presentation materials.

In the above example, for each of first periods (unit periods 101) into which the reproduction time of moving image data is split, the first representative image 103 that represents the first period is selected from frame images included in the first period. A second period (stable period 201) is specified by a sequence of the first representative images 103 that are in direct adjacency in a linear arrangement of the first representative images 103 and have a smaller change in the position of the subject in images than a reference. For each second period, the second representative image 203 that represents the second period is selected from the first representative images 103 included in the second period. A third period (scene period 501) is specified by a sequence of the second representative images 203 that are in direct adjacency in a linear arrangement of the second representative images 203 and have similar frequency distributions of the pixel value component. A process of selecting, for each third period, the third representative image 503 representing the third period from the second representative images 203 included in the third period is included.

Therefore, according to the present embodiment, an image representing a scene may be more accurately extracted. For example, even in the case of a frame image of different tone being temporarily captured in a part of a moving image corresponding to one scene, a useless representative image is not extracted since the period of the scene is accurately specified.

### Third Embodiment

In the present embodiment, an example of simplifying the step of selecting the first representative image 103 will be described. For example, for a moving image that does not include a video captured with camera shake or an image out of focus, simplifying the step of selecting the first representative image 103 does not substantially pose many problems.

In the present embodiment, a first selection process (B) is performed in S903 illustrated in FIG. 9. The first selection process (B) may be applied to any of the first and second embodiments.

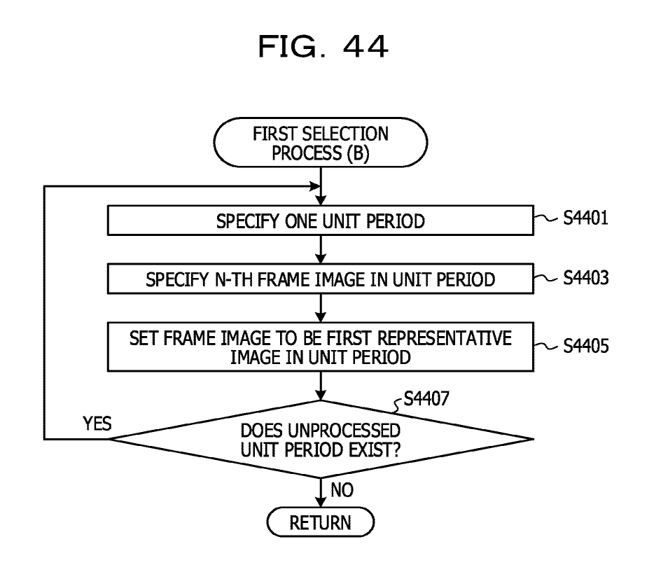

FIG. 44 illustrates the flow of the first selection process (B). The first selecting unit 605 specifies one unit period 101 in the same manner as in the case of S1001 of FIG. 10 (S4401).

The first selecting unit 605 specifies the N-th frame image in the unit period 101 (S4403). N may be any number of 1 to the number of frame images. That is, the leading frame image may be specified, or a frame image in the middle may be specified, or the last frame image may be specified.

The first selecting unit 605 sets the frame image to be the first representative image 103 in the unit period 101 in the same manner as in the case of S1013 of FIG. 10 (S4405).

The first selecting unit 605 determines whether or not an unprocessed unit period 101 exists (S4407). In the case of determining an unprocessed unit period 101 to exist, a return is made to the process illustrated in S4401, and the above processes are repeated.

Meanwhile, in the case of determining an unprocessed unit period 101 not to exist, the first selection process (B) is ended. When the first selection process (B) is ended, a return is made to a caller of the unit period process.

According to the present embodiment, process load is reduced. Substantial problems are less if a video is generally clear.

### Fourth Embodiment

In the present embodiment, an example of automatically displaying representative images in order will be described.

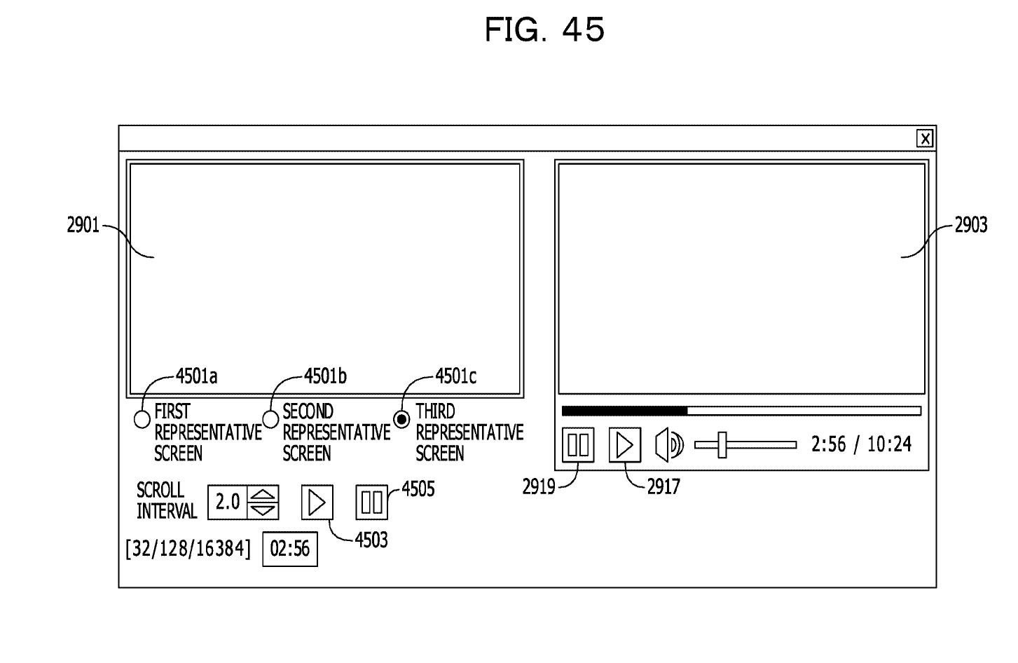

FIG. 45 illustrates a display operating screen of the second viewer 3005 according to the fourth embodiment. If a radio button 4501a is selected, the first representative image 103 becomes a target of automatic scroll. The mode at this point is referred to as a first mode. If a radio button 4501b is selected, the second representative image 203 becomes a target of automatic scroll. The mode at this point is referred to as a second mode. If a radio button 4501c is selected, the third representative image 503 becomes a target of automatic scroll. The mode at this point is referred to as a third mode.

If a scroll start button 4503 is touched, an instruction to start automatic scroll is provided. If automatic scroll is started, a representative image that is selected in accordance with the current mode is displayed in the first image area 2901 in order at a scroll interval.

If a scroll stop button 4505 is touched, automatic scroll is stopped. The scroll interval may be changed.

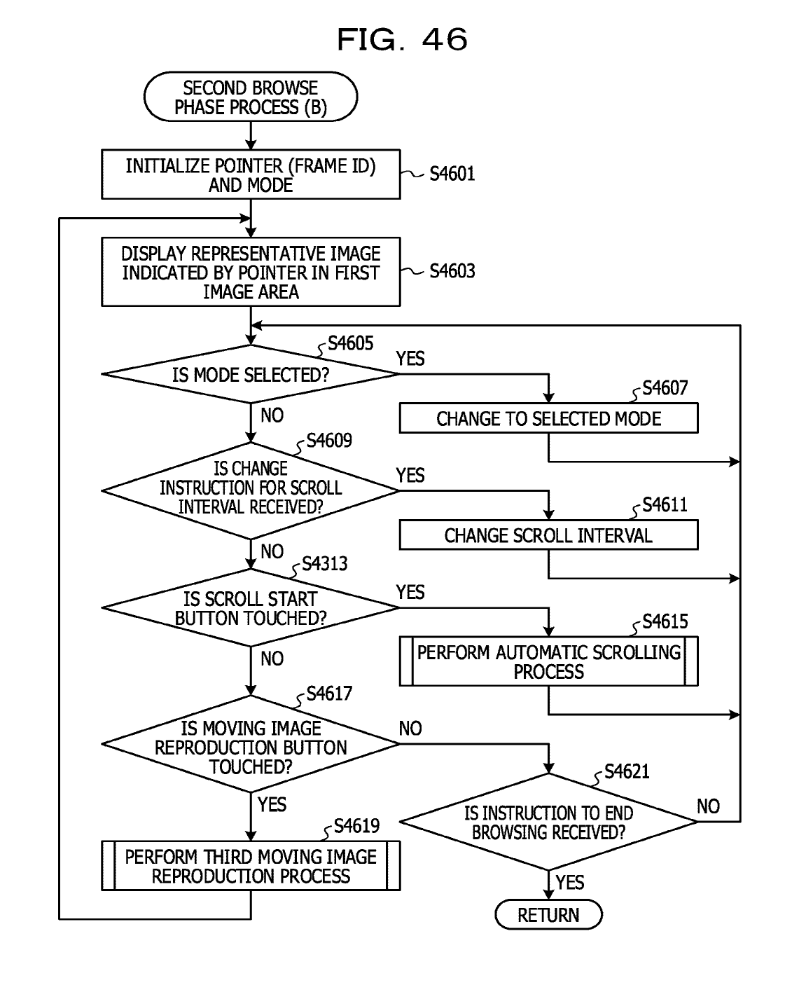

In the present embodiment, a second browse phase process (B) is performed in S3105 illustrated in FIG. 31. FIG. 46 illustrates the flow of the second browse phase process (B). The second initializing unit 4001 initializes the pointer and the mode (S4601). The mode is an internal parameter. In this example, any of the first mode in which the first representative image 103 is displayed, the second mode in which the second representative image 203 is displayed, and the third mode in which the third representative image 503 is displayed is set. Initialization may be performed in any manner, and any mode may be set. In the case of the user specifying in advance an initial mode, the mode may be set.

The fifth display processing unit 4003 displays a representative image indicated by the pointer in the first image area 2901 in the same manner as in the case of S4103 of FIG. 41 (S4603).

The second operation receiving unit 3007 determines whether or not a mode is selected with the radio buttons 4501a to 4501c (S4605). In the case of determining a mode to be selected with the radio buttons 4501a to 4501c, the changing unit 4013 changes the current mode to the selected mode (S4607). Then, a return is made to the process illustrated in S4605, and the above processes are repeated.

Meanwhile, in the case of determining a mode not to be selected with the radio buttons 4501a to 4501c, the second operation receiving unit 3007 determines whether or not a change instruction for the scroll interval is received (S4609). In the case of determining a change instruction for the scroll interval to be received, the second operation receiving unit 3007 changes the scroll interval (S4611). The scroll interval is an internal parameter. Then, a return is made to the process illustrated in S4605, and the above processes are repeated.

Meanwhile, in the case of determining a change instruction for the scroll interval not to be received, the second operation receiving unit 3007 determines whether or not the scroll start button 4503 is touched (S4613). In the case of determining the scroll start button 4503 to be touched, the second viewer 3005 performs an automatic scrolling process (S4615). In the automatic scrolling process, representative images are automatically displayed in order.

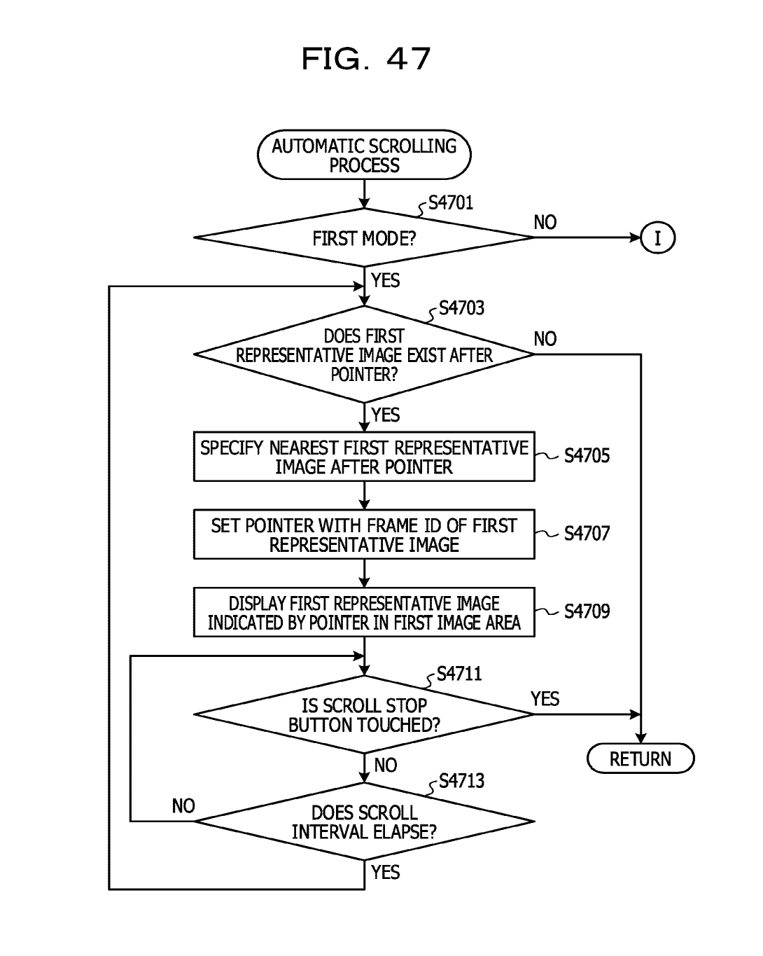

FIG. 47 to FIG. 49 illustrate the flow of the automatic scrolling process. The seventh specifying unit 4015 determines whether or not the first mode is currently set (S4701). In the case of determining the first mode to be currently set, the seventh specifying unit 4015 determines whether or not the first representative image 103 exists after the pointer (S4703). Specifically, the seventh specifying unit 4015 searches in the period table for the immediately nearby record having the first representative image flag set to ON from the records after the record of the frame ID indicated by the pointer.

In the case of determining the first representative image 103 not to exist after the pointer, the automatic scrolling process is ended, and a return is made to a caller of the second browse phase process (B).

Meanwhile, in the case of determining the first representative image 103 to exist after the pointer, the seventh specifying unit 4015 specifies the nearest first representative image 103 after the pointer (S4705) and sets the pointer with the frame ID of the first representative image 103 (S4707). Then, the fifth display processing unit 4003 displays the first representative image 103 indicated by the pointer in the first image area 2901 (S4709).

Then, the second operation receiving unit 3007 determines whether or not the scroll stop button 4505 is touched (S4711). In the case of determining the scroll stop button 4505 to be touched, the automatic scrolling process is ended, and a return is made to a caller of the second browse phase process (B).

Meanwhile, in the case of determining the scroll stop button 4505 not to be touched, the second operation receiving unit 3007 determines whether or not an amount of time corresponding to the scroll interval elapses from the point in time when the process of S4709 is performed (S4713). In the case of determining an amount of time corresponding to the scroll interval to elapse, a return is made to the process illustrated in S4703, and the above processes are repeated.

Meanwhile, in the case of determining an amount of time corresponding to the scroll interval not to elapse, a return is made to the process illustrated in S4711, and the above processes are repeated.

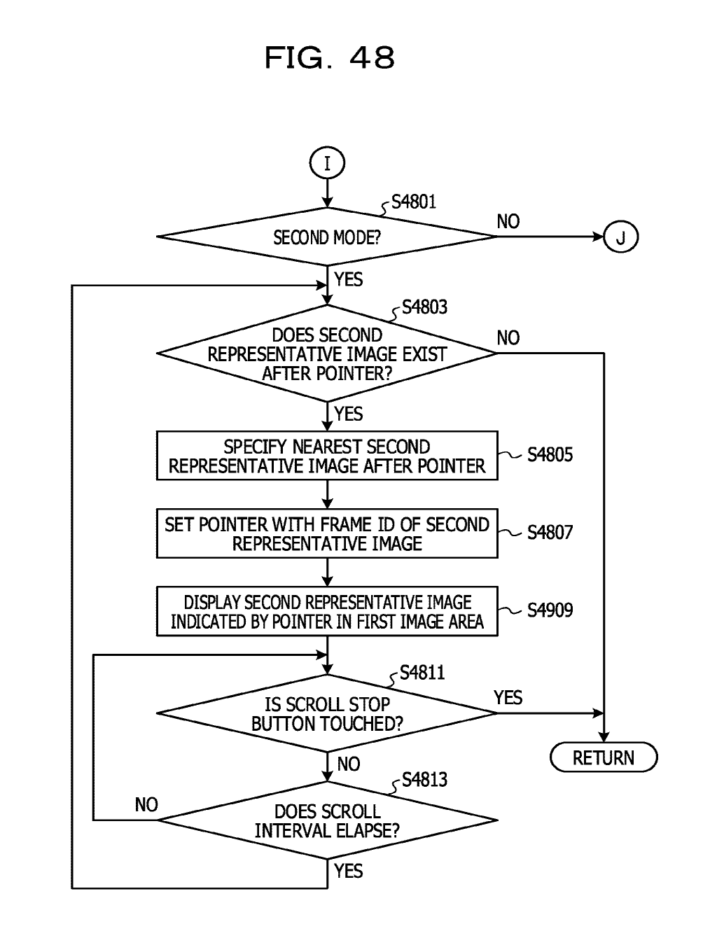

S4701 will be described again. In the case of determining the first mode not to be currently set in S4701, a transition is made to a process of S4801 illustrated in FIG. 48 through a terminal I.

FIG. 48 will be described. The seventh specifying unit 4015 determines whether or not the second mode is currently set (S4801). In the case of determining the second mode to be currently set, the seventh specifying unit 4015 determines whether or not the second representative image 203 exists after the pointer (S4803). Specifically, the seventh specifying unit 4015 searches in the period table for the immediately nearby record having the second representative image flag set to ON from the records after the record of the frame ID indicated by the pointer.

In the case of determining the second representative image 203 not to exist after the pointer, the automatic scrolling process is ended, and a return is made to a caller of the second browse phase process (B).

Meanwhile, in the case of determining the second representative image 203 to exist after the pointer, the seventh specifying unit 4015 specifies the nearest second representative image 203 after the pointer (S4805) and sets the pointer with the frame ID of the second representative image 203 (S4807). Then, the fifth display processing unit 4003 displays the second representative image 203 indicated by the pointer in the first image area 2901 (S4809).

Then, the second operation receiving unit 3007 determines whether or not the scroll stop button 4505 is touched (S4811). In the case of determining the scroll stop button 4505 to be touched, the automatic scrolling process is ended, and a return is made to a caller of the second browse phase process (B).

Meanwhile, in the case of determining the scroll stop button 4505 not to be touched, the second operation receiving unit 3007 determines whether or not an amount of time corresponding to the scroll interval elapses from the point in time when the process of S4809 is performed (S4813). In the case of determining an amount of time corresponding to the scroll interval to elapse, a return is made to the process illustrated in S4803, and the above processes are repeated.

Meanwhile, in the case of determining an amount of time corresponding to the scroll interval not to elapse, a return is made to the process illustrated in S4811, and the above processes are repeated.

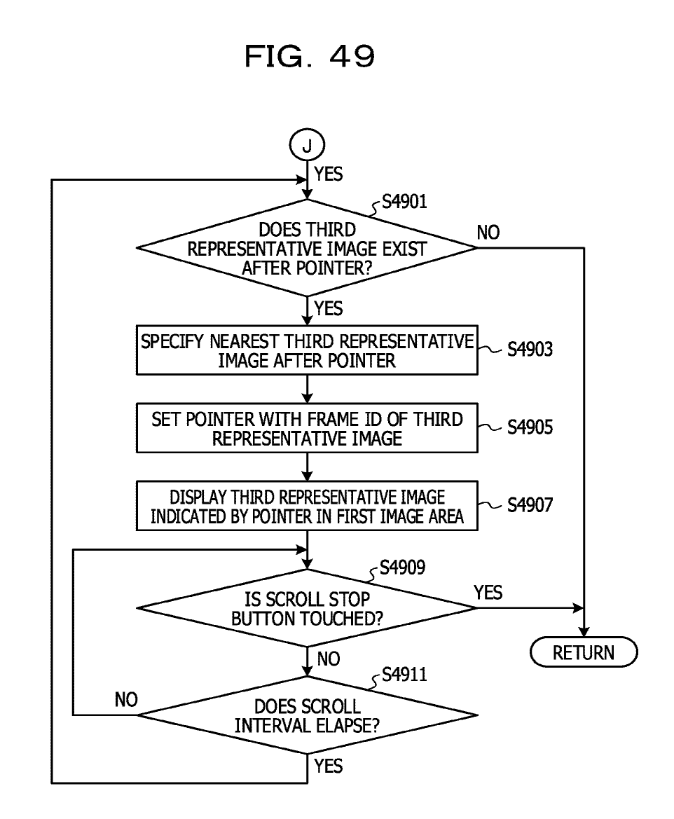

S4801 will be described again. In the case of determining the second mode not to be currently set in S4801, that is, in the case of the third mode being currently set, a transition is made to a process of S4901 illustrated in FIG. 49 through a terminal J.

FIG. 49 will be described. The seventh specifying unit 4015 determines whether or not the third representative image 503 exists after the pointer (S4901). Specifically, the seventh specifying unit 4015 searches in the period table for the immediately nearby record having the third representative image flag set to ON from the records after the record of the frame ID indicated by the pointer.

In the case of determining the third representative image 503 not to exist after the pointer, the automatic scrolling process is ended, and a return is made to a caller of the second browse phase process (B).

Meanwhile, in the case of determining the third representative image 503 to exist after the pointer, the seventh specifying unit 4015 specifies the nearest third representative image 503 after the pointer (S4903) and sets the pointer with the frame ID of the third representative image 503 (S4905). Then, the fifth display processing unit 4003 displays the third representative image 503 indicated by the pointer in the first image area 2901 (S4907).

Then, the second operation receiving unit 3007 determines whether or not the scroll stop button 4505 is touched (S4909). In the case of determining the scroll stop button 4505 to be touched, the automatic scrolling process is ended, and a return is made to a caller of the second browse phase process (B).

Meanwhile, in the case of determining the scroll stop button 4505 not to be touched, the second operation receiving unit 3007 determines whether or not an amount of time corresponding to the scroll interval elapses from the point in time when the process of S4907 is performed (S4911). In the case of determining an amount of time corresponding to the scroll interval to elapse, a return is made to the process illustrated in S4901, and the above processes are repeated.

Meanwhile, in the case of determining an amount of time corresponding to the scroll interval not to elapse, a return is made to the process illustrated in S4909, and the above processes are repeated. The automatic scrolling process is described heretofore.

FIG. 46 will be described again. When the automatic scrolling process is ended, a return is made to the process illustrated in S4605, and the above processes are repeated.

In the case of determining the scroll start button 4503 not to be touched in S4613, the second operation receiving unit 3007 determines whether or not the moving image reproduction button 2917 is touched (S4617). In the case of determining the moving image reproduction button 2917 to be touched, the second viewer 3005 performs the third moving image reproduction process (S4619). When the third moving image reproduction process is ended, a return is made to the process illustrated in S4603, and the above processes are repeated.

Meanwhile, in the case of determining the moving image reproduction button 2917 not to be touched, the second operation receiving unit 3007 determines whether or not an instruction to end browsing is received (S4621). In the case of determining an instruction to end browsing to be received, the second browse phase process (B) is ended, and a return is made to a caller of the second main process.

Meanwhile, in the case of determining an instruction to end browsing not to be received, a return is made to the process illustrated in S4605, and the above processes are repeated.

According to the present embodiment, the third representative image 503 is automatically displayed in order. Thus, a transition between scenes is easily recognized.

The second representative image 203 is automatically displayed in order. Thus, a transition between frame images in the period of a scene is easily recognized.

The first representative image 103 is automatically displayed in order. Thus, a change in frame image in a short period is easily recognized.

### Fifth Embodiment

In the present embodiment, an example of displaying thumbnails of continuous representative images will be described.

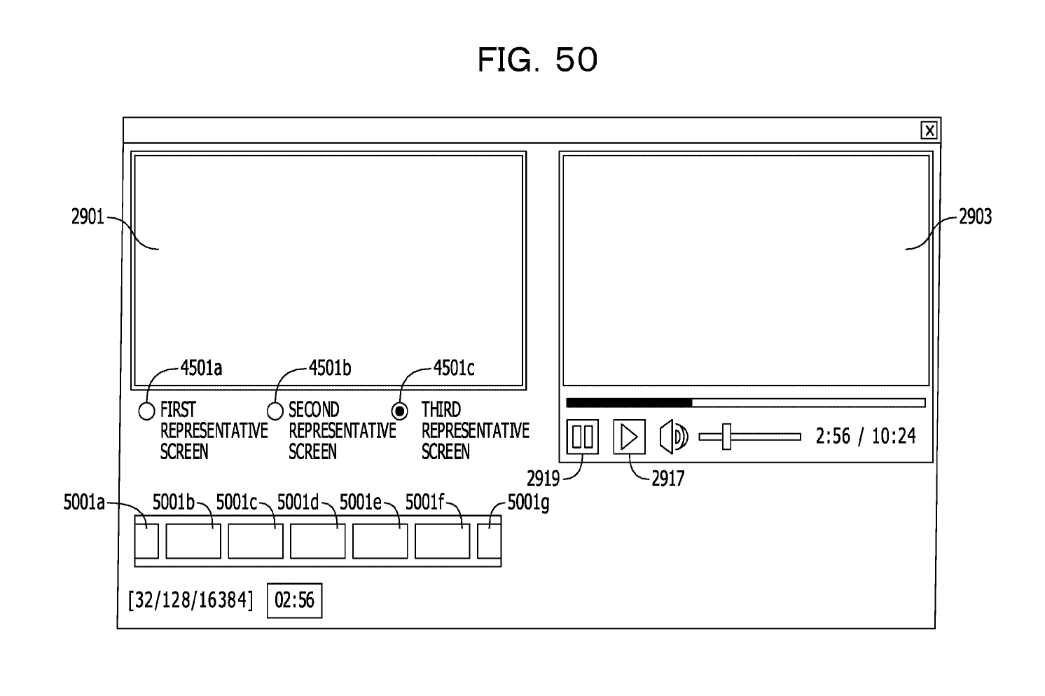

FIG. 50 illustrates a display operating screen of the second viewer 3005 according to the fifth embodiment. If the radio button 4501a is selected, the first representative image 103 becomes a target of thumbnail display. The mode at this point is referred to as a first mode. If the radio button 4501b is selected, the second representative image 203 becomes a target of thumbnail display. The mode at this point is referred to as a second mode. If the radio button 4501c is selected, the third representative image 503 becomes a target of thumbnail display. The mode at this point is referred to as a third mode.

A thumbnail 5001d at the center in the first mode is a reduced image of the first representative image 103 that is nearest to the frame image displayed in the first image area 2901. A thumbnail 5001c to a thumbnail 5001a that are in order backward in time are reduced images of the previous first representative images 103. A thumbnail 5001e to a thumbnail 5001g that are in order are reduced images of the subsequent first representative images 103.

When any of the thumbnails 5001a to 5001g is touched in the first mode, the first representative image 103 corresponding to a thumbnail 5001 is displayed in the first image area 2901. Then, the thumbnails 5001a to 5001g are rearranged in such a manner that the touched thumbnail 5001 is at the center. If an operation of sliding the display area of the thumbnail 5001 is performed, the thumbnails 5001a to 5001g are moved in accordance with the amount of sliding and are replaced.

The thumbnail 5001d at the center in the second mode is a reduced image of the second representative image 203 that is nearest to the frame image displayed in the first image area 2901. The thumbnail 5001c to the thumbnail 5001a that are in order backward in time are reduced images of the previous second representative images 203. The thumbnail 5001e to the thumbnail 5001g that are in order are reduced images of the subsequent second representative images 203.

When any of the thumbnails 5001a to 5001g is touched in the second mode, the second representative image 203 corresponding to the thumbnail 5001 is displayed in the first image area 2901. Then, the thumbnails 5001a to 5001g are rearranged in such a manner that the touched thumbnail 5001 is at the center. If an operation of sliding the display area of the thumbnail 5001 is performed, the thumbnails 5001a to 5001g are moved in accordance with the amount of sliding and are replaced.

The thumbnail 5001d at the center in the third mode is a reduced image of the third representative image 503 that is nearest to the frame image displayed in the first image area 2901. The thumbnail 5001c to the thumbnail 5001a that are in order backward in time are reduced images of the previous third representative images 503. The thumbnail 5001e to the thumbnail 5001g that are in order are reduced images of the subsequent third representative images 503.

When any of the thumbnails 5001a to 5001g is touched in the third mode, the third representative image 503 corresponding to the thumbnail 5001 is displayed in the first image area 2901. Then, the thumbnails 5001a to 5001g are rearranged in such a manner that the touched thumbnail 5001 is at the center. If an operation of sliding the display area of the thumbnail 5001 is performed, the thumbnails 5001a to 5001g are moved in accordance with the amount of sliding and are replaced.

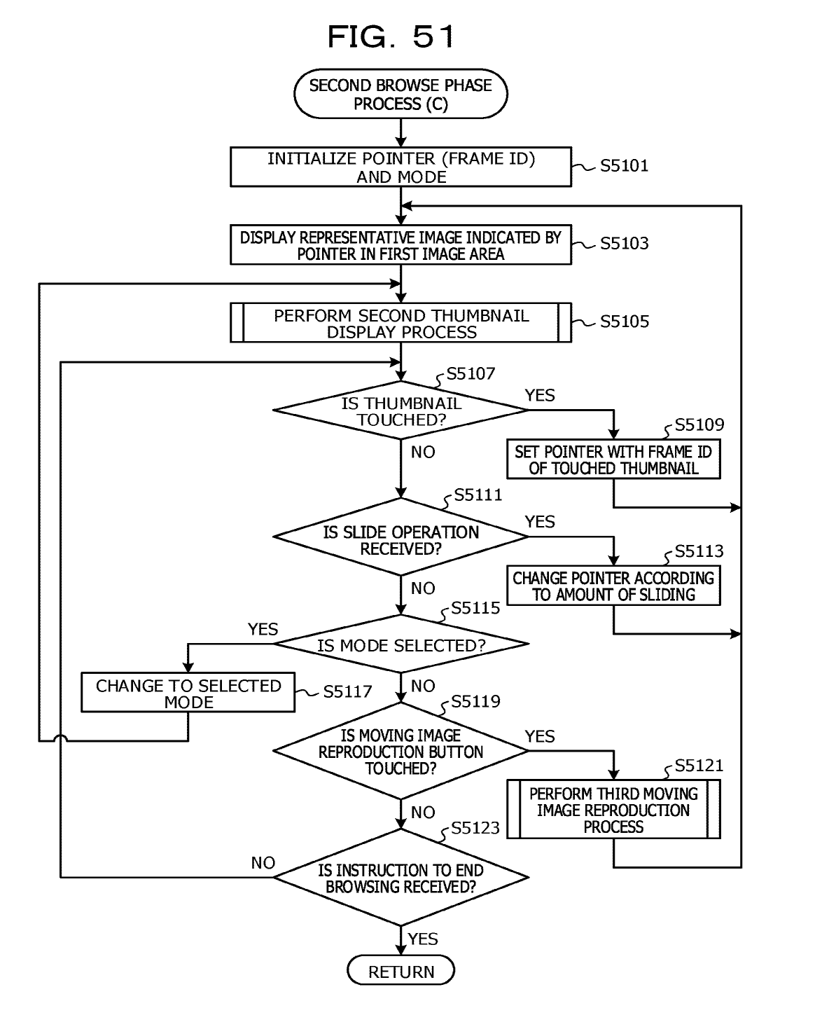

In the present embodiment, a second browse phase process (C) is performed in S3105 illustrated in FIG. 31. FIG. 51 illustrates the flow of the second browse phase process (C). The second initializing unit 4001 initializes the pointer and the mode in the same manner as in the case of S4601 of FIG. 46 (S5101). The fifth display processing unit 4003 displays a representative image indicated by the pointer in the first image area 2901 in the same manner as in the case of S4103 of FIG. 41 (S5103).

The seventh display processing unit 4017 performs the second thumbnail display process (S5105). In the second thumbnail display process, the thumbnails 5001a to 5001g of representative images are displayed according to the current mode.

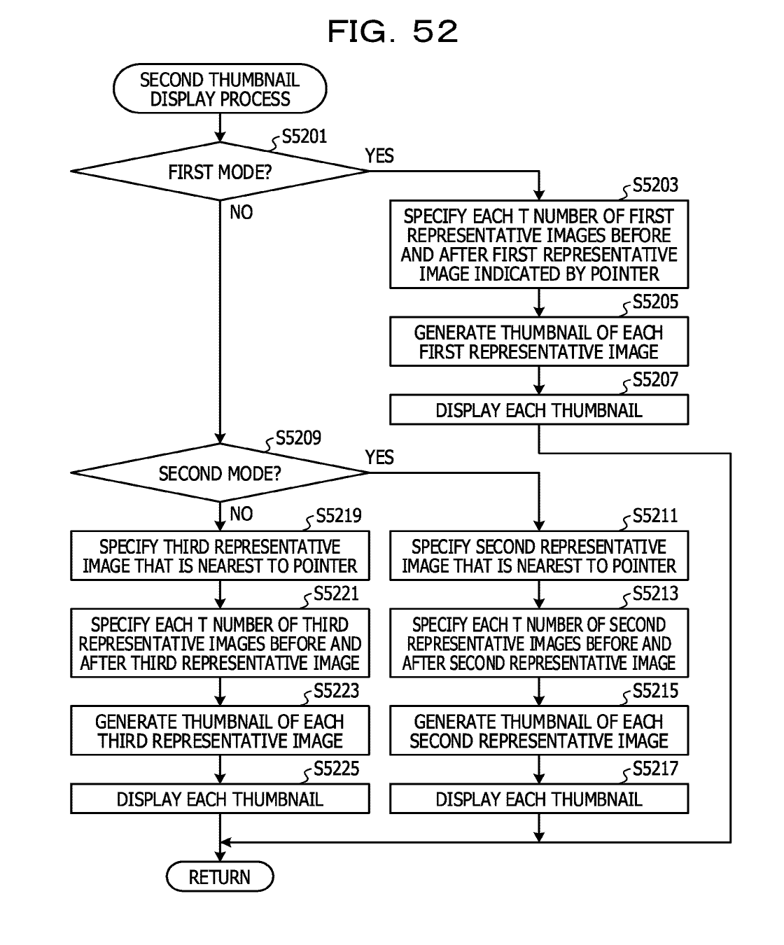

FIG. 52 illustrates the flow of the second thumbnail display process. The seventh display processing unit 4017 determines whether or not the first mode is currently set (S5201). In the case of determining the first mode to be currently set, the seventh display processing unit 4017 specifies each T number (in this example, three) of first representative images 103 before and after the first representative image 103 indicated by the pointer (or the first representative image 103 that is nearest to the pointer) (S5203). Specifically, the seventh display processing unit 4017 searches in the period table for immediately nearby T number of records having the first representative image flag set to ON from the records before the record of the frame ID indicated by the pointer. The seventh display processing unit 4017 searches for immediately nearby T number of records having the first representative image flag set to ON from the records after the record of the frame ID indicated by the pointer.

The seventh display processing unit 4017 generates the thumbnail 5001 of each specified first representative image 103 (S5205). Specifically, the seventh display processing unit 4017 specifies the file name of the frame image corresponding to each frame ID and converts the frame image of the file into the image of the thumbnail 5001.

The seventh display processing unit 4017 displays each of the generated thumbnails 5001a to 5001g (S5207). Specifically, the seventh display processing unit 4017 arranges the thumbnails 5001a to 5001g in reproduction order. Then, the second thumbnail display process is ended, and a return is made to a caller of the second browse phase process (C).

In the case of determining the first mode not to be currently set in S5201, the seventh display processing unit 4017 determines whether or not the second mode is currently set (S5209). In the case of determining the second mode to be currently set, the seventh display processing unit 4017 specifies the second representative image 203 that is nearest to the pointer (S5211). Specifically, the seventh display processing unit 4017 specifies the record, of records having the second representative image flag set to ON in the period table, that is nearest to the record of the frame ID indicated by the pointer.

The seventh display processing unit 4017 specifies each T number (in this example, three) of second representative images 203 before and after the second representative image 203 indicated by the pointer (S5213). Specifically, the seventh display processing unit 4017 searches in the period table for immediately nearby T number of records having the second representative image flag set to ON from the records before the record of the frame ID indicated by the pointer. The seventh display processing unit 4017 searches for immediately nearby T number of records having the second representative image flag set to ON from the records after the record of the frame ID indicated by the pointer.

The seventh display processing unit 4017 generates the thumbnail 5001 of each specified second representative image 203 (S5215). Specifically, the file name of the frame image corresponding to each frame ID is specified, and the frame image of the file is converted into the image of the thumbnail 5001.

The seventh display processing unit 4017 displays each of the generated thumbnails 5001a to 5001g (S5217). Specifically, the seventh display processing unit 4017 arranges the thumbnails 5001a to 5001g in reproduction order. Then, the second thumbnail display process is ended, and a return is made to a caller of the second browse phase process (C).

In the case of determining the second mode not to be currently set in S5209, that is, in the case of the third mode being currently set, the seventh display processing unit 4017 specifies the third representative image 503 that is nearest to the pointer (S5219). Specifically, the seventh display processing unit 4017 specifies the record, of records having the third representative image flag set to ON in the period table, that is nearest to the record of the frame ID indicated by the pointer.

The seventh display processing unit 4017 specifies each T number (in this example, three) of third representative images 503 before and after the third representative image 503 indicated by the pointer (S5221). Specifically, the seventh display processing unit 4017 searches in the period table for immediately nearby T number of records having the third representative image flag set to ON from the records before the record of the frame ID indicated by the pointer. The seventh display processing unit 4017 searches for immediately nearby T number of records having the third representative image flag set to ON from the records after the record of the frame ID indicated by the pointer.

The seventh display processing unit 4017 generates the thumbnail 5001 of each specified third representative image 503 (S5223). Specifically, the file name of the frame image corresponding to each frame ID is specified, and the frame image of the file is converted into the image of the thumbnail 5001.

The seventh display processing unit 4017 displays each of the generated thumbnails 5001a to 5001g (S5225). Specifically, the seventh display processing unit 4017 arranges the thumbnails 5001a to 5001g in reproduction order. Then, the second thumbnail display process is ended, and a return is made to a caller of the second browse phase process (C).

FIG. 51 will be described again. When the second thumbnail display process is ended, the second operation receiving unit 3007 determines whether or not the thumbnail 5001 is touched (S5107). In the case of determining the thumbnail 5001 to be touched, the eighth specifying unit 4019 sets the pointer with the frame ID corresponding to the touched thumbnail 5001 (S5109). Then, a return is made to the process illustrated in S5103, and the above processes are repeated.

Meanwhile, in the case of determining the thumbnail 5001 not to be touched, the second operation receiving unit 3007 determines whether or not a slide operation in the display area of the thumbnail 5001 is received (S5111). In the case of determining a slide operation in the display area of the thumbnail 5001 to be received, the eighth specifying unit 4019 changes the pointer according to the amount of sliding (S5113). At this point, the eighth specifying unit 4019 acquires the number of representative images corresponding to the movement by multiplying the amount of sliding by a predetermined percentage. When the pointer is changed, a return is made to the process illustrated in S5103, and the above processes are repeated.

Meanwhile, in the case of determining a slide operation in the display area of the thumbnail 5001 not to be received, the second operation receiving unit 3007 determines whether or not a mode is selected with the radio buttons 4501a to 4501c (S5115). In the case of determining a mode to be selected with the radio buttons 4501a to 4501c, the changing unit 4013 changes the current mode to the selected mode (S5117). Then, a return is made to the process illustrated in S5105, and the above processes are repeated.

Meanwhile, in the case of determining a mode not to be selected with the radio buttons 4501a to 4501c, the second operation receiving unit 3007 determines whether or not the moving image reproduction button 2917 is touched (S5119). In the case of determining the moving image reproduction button 2917 to be touched, the second viewer 3005 performs the third moving image reproduction process (S5121). Then, a return is made to the process illustrated in S5103, and the above processes are repeated.

Meanwhile, in the case of determining the moving image reproduction button 2917 not to be touched, the second operation receiving unit 3007 determines whether or not an instruction to end browsing is received (S5123). In the case of determining an instruction to end browsing to be received, the second browse phase process (C) is ended, and a return is made to a caller of the second main process.

Meanwhile, in the case of determining an instruction to end browsing not to be received, a return is made to the process illustrated in S5107, and the above processes are repeated.

According to the present embodiment, the thumbnail 5001 of the continuous third representative image 503 is displayed, and screen display of the third representative image 503 is switched in the case of selecting the thumbnail 5001. Thus, a scene for image display is easily selected.

The thumbnail 5001 of the continuous second representative image 203 is displayed, and screen display of the second representative image 203 is switched in the case of selecting the thumbnail 5001. Thus, a frame image that has a different composition in the period of a scene is easily selected.

The thumbnail 5001 of the continuous first representative image 103 is displayed, and screen display of the first representative image 103 is switched in the case of selecting the thumbnail 5001. Thus, a frame image included in a short period is easily selected.

### Sixth Embodiment

In the present embodiment, an example of displaying a linear arrangement of a mark corresponding to the first representative image 103 not corresponding to the second representative image 203 and a mark corresponding to the second representative image 203 in reproduction order will be described.

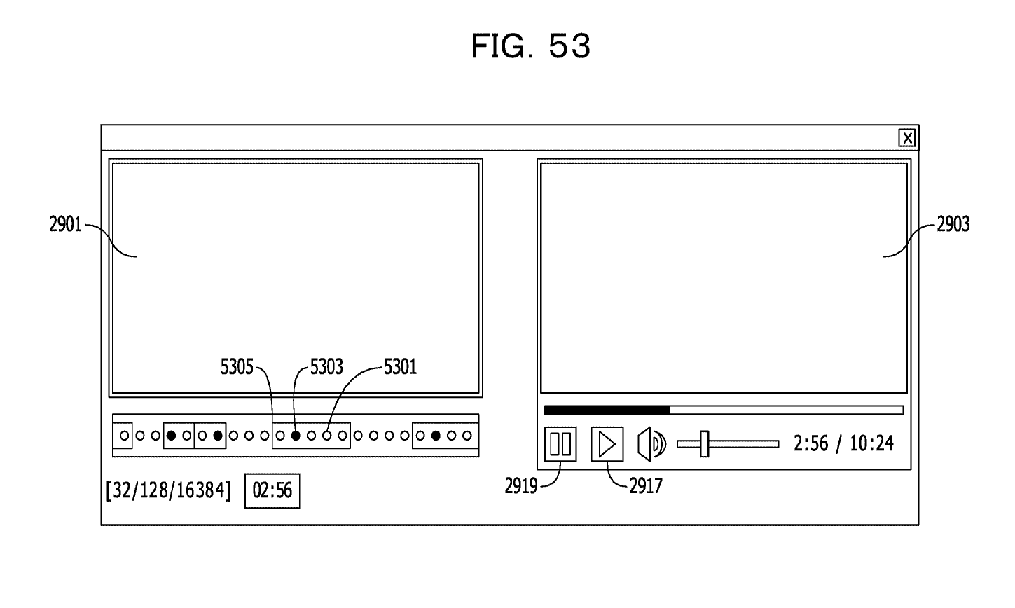

FIG. 53 illustrates a display operating screen of the second viewer 3005 according to the sixth embodiment. A fourth mark 5301 that is illustrated by a circle with only an edge corresponds to the first representative image 103 that does not correspond to the second representative image 203. A fifth mark 5303 that is illustrated by a filled circle corresponds to the second representative image 203. A mark at the center corresponds to the frame image displayed in the first image area 2901. A mark on the left side of the mark at the center corresponds to the representative image that is earlier in order than the frame image displayed in the first image area 2901. A mark on the right side of the mark at the center corresponds to the representative image that is later in order than the frame image displayed in the first image area 2901. A box 5305 illustrates the range of the stable period 201.

When any mark is touched, a representative image corresponding to the mark is displayed in the first image area 2901. Then, the marks are rearranged in such a manner that the touched mark is at the center. If an operation of sliding the display area of the marks is performed, the marks are moved in accordance with the amount of sliding and are replaced.

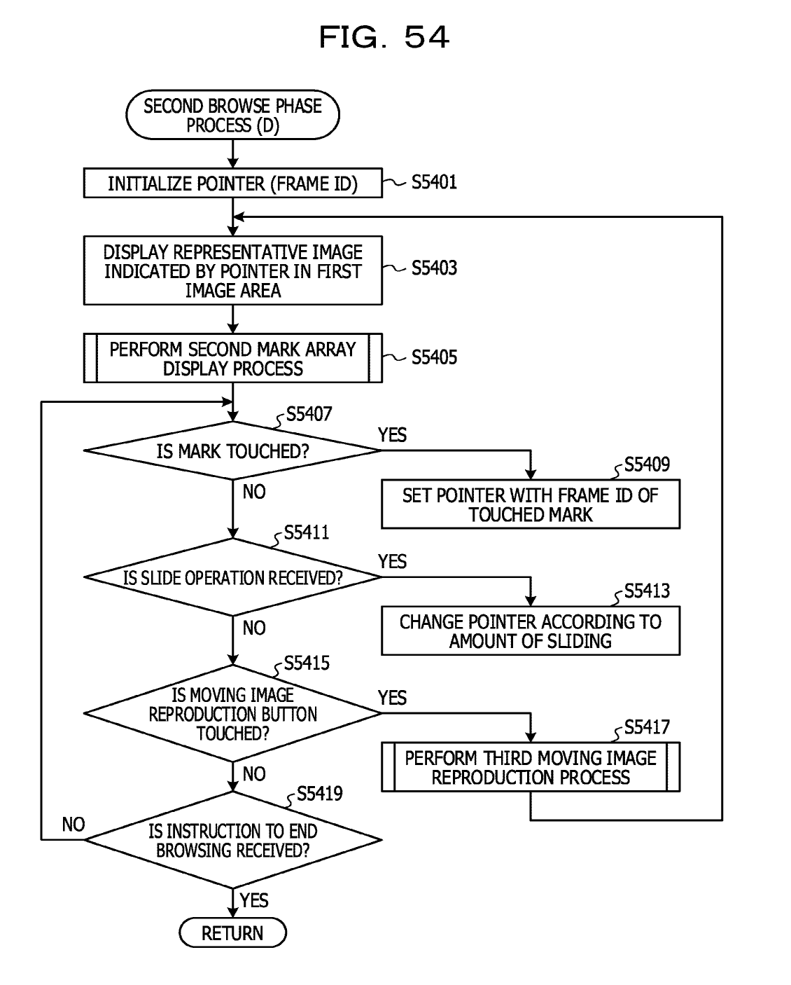

In the present embodiment, a second browse phase process (D) is performed in S3105 illustrated in FIG. 31. FIG. 54 illustrates the flow of the second browse phase process (D). The second initializing unit 4001 initializes the pointer in the same manner as in the case of S4101 of FIG. 41 (S5401). The fifth display processing unit 4003 displays a representative image indicated by the pointer in the first image area 2901 in the same manner as in the case of S4103 of FIG. 41 (S5403).

The eighth display processing unit 4021 performs the second mark array display process (S5405). In the second mark array display process, marks represent a linear arrangement of various representative images. A second mark array display process (A) is performed in the present embodiment.

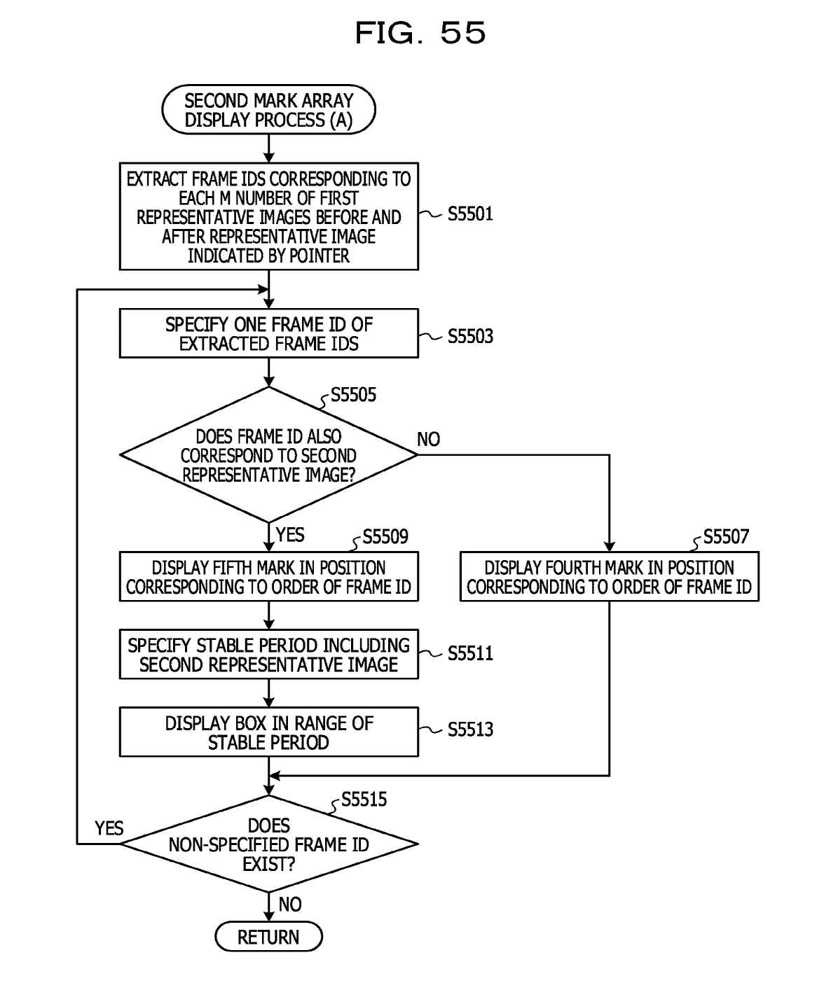

FIG. 55 illustrates the flow of the second mark array display process (A). The eighth display processing unit 4021 extracts the frame IDs corresponding to each M number (in this example, 11) of first representative images 103 before and after the representative image indicated by the pointer (or representative images that are nearest to the pointer) (S5501). Specifically, the seventh display processing unit 4017 searches in the period table for immediately nearby M number of records having the first representative image flag set to ON from the records before the record of the frame ID indicated by the pointer. The seventh display processing unit 4017 searches for immediately nearby M number of records having the first representative image flag set to ON from the records after the record of the frame ID indicated by the pointer.

The eighth display processing unit 4021 specifies one frame ID of the extracted frame IDs (S5503). For example, the eighth display processing unit 4021 specifies a frame ID in reproduction order.

The eighth display processing unit 4021 determines whether or not the frame ID also corresponds to the second representative image 203 (S5505). In the case of determining the frame ID not to correspond to the second representative image 203, the eighth display processing unit 4021 displays the fourth mark 5301 in a position corresponding to the order of the frame ID (S5507). The order is set in reproduction order from left to right of the display operating screen. A transition is made to a process of S5515.

Meanwhile, in the case of determining the frame ID to correspond to the second representative image 203, the eighth display processing unit 4021 displays the fifth mark 5303 in a position corresponding to the order of the frame ID (S5509).

The eighth display processing unit 4021 specifies the stable period 201 that includes the second representative image 203 (S5511), and displays the box 5305 that surrounds the range of the stable period 201 (S5513). At this point, a background color may be set inside of the box 5305.

The eighth display processing unit 4021 determines whether or not a non-specified frame ID exists (S5515). In the case of determining a non-specified frame ID to exist, a return is made to the process illustrated in S5503, and the above processes are repeated.

Meanwhile, in the case of determining a non-specified frame ID not to exist, the second mark array display process (A) is ended, and a return is made to a caller of the second browse phase process (D).

FIG. 54 will be described again. The second operation receiving unit 3007 determines whether or not any mark is touched (S5407). In the case of determining any mark to be touched, the ninth specifying unit 4023 sets the pointer with the frame ID corresponding to the touched mark (S5409). Then, a return is made to the process illustrated in S5403, and the above processes are repeated.

Meanwhile, in the case of determining any mark not to be touched, the second operation receiving unit 3007 determines whether or not a slide operation in the display area of the marks is received (S5411). In the case of determining a slide operation in the display area of the marks to be received, the ninth specifying unit 4023 changes the pointer according to the amount of sliding (S5413). At this point, the ninth specifying unit 4023 acquires the number of representative images corresponding to the movement by multiplying the amount of sliding by a predetermined percentage. When the pointer is changed, a return is made to the process illustrated in S5403, and the above processes are repeated.

Meanwhile, in the case of determining a slide operation in the display area of the marks not to be received, the second operation receiving unit 3007 determines whether or not the moving image reproduction button 2917 is touched (S5415). In the case of determining the moving image reproduction button 2917 to be touched, the second viewer 3005 performs the third moving image reproduction process (S5417). When the third moving image reproduction process is ended, a return is made to the process illustrated in S5403, and the above processes are repeated.

Meanwhile, in the case of determining the moving image reproduction button 2917 not to be touched, the second operation receiving unit 3007 determines whether or not an instruction to end browsing is received (S5419). In the case of determining an instruction to end browsing to be received, the second browse phase process (D) is ended, and a return is made to a caller of the second main process.

Meanwhile, in the case of determining an instruction to end browsing not to be received, a return is made to the process illustrated in S5407, and the above processes are repeated.

According to the present embodiment, a configuration of a representative image related to a combination of a period having a stable composition and another period is easily recognized.

### Seventh Embodiment

In the present embodiment, an example of displaying a linear arrangement of a mark corresponding to the third representative image 503 and a mark corresponding to the first representative image 103 not corresponding to the third representative image 503 in reproduction order will be described.

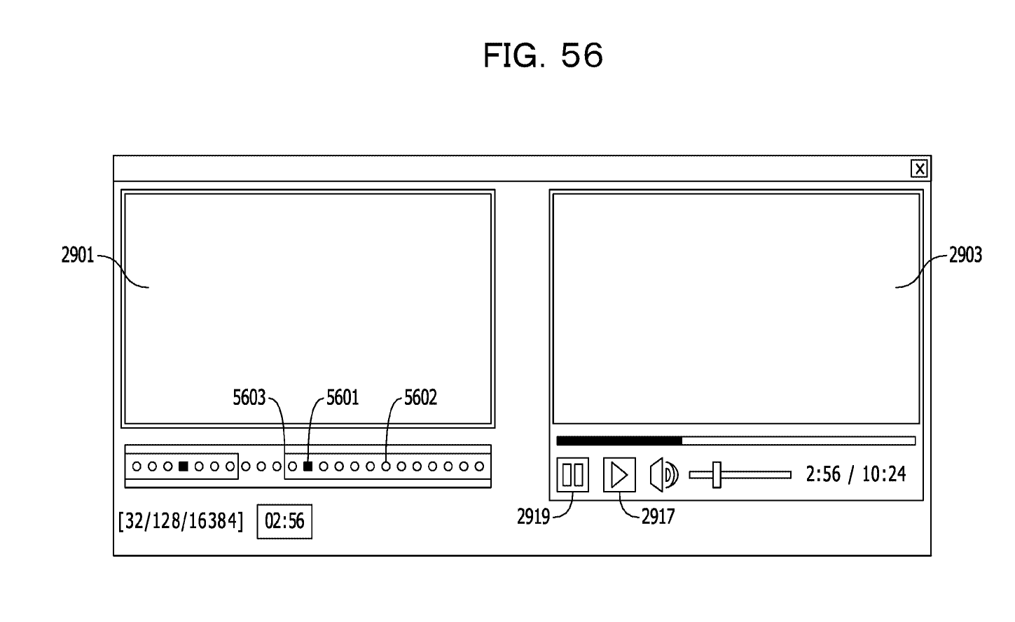

FIG. 56 illustrates a display operating screen of the second viewer 3005 according to the seventh embodiment. A sixth mark 5601 that is illustrated by a filled rectangle corresponds to the third representative image 503. A seventh mark 5602 that is illustrated by a circle with only an edge corresponds to the first representative image 103 that does not correspond to the third representative image 503. A mark at the center corresponds to the representative image displayed in the first image area 2901 (or a representative image that is nearest to the frame image displayed in the first image area 2901). A mark on the left side of the mark at the center corresponds to the representative image that is earlier in order than the frame image displayed in the first image area 2901. A mark on the right side of the mark at the center corresponds to the representative image that is later in order than the frame image displayed in the first image area 2901. A box 5603 illustrates the range of the scene period 501.

When any mark is touched, a representative image corresponding to the mark is displayed in the first image area 2901. Then, the marks are rearranged in such a manner that the touched mark is at the center. If an operation of sliding the display area of the marks is performed, the marks are moved in accordance with the amount of sliding and are replaced.

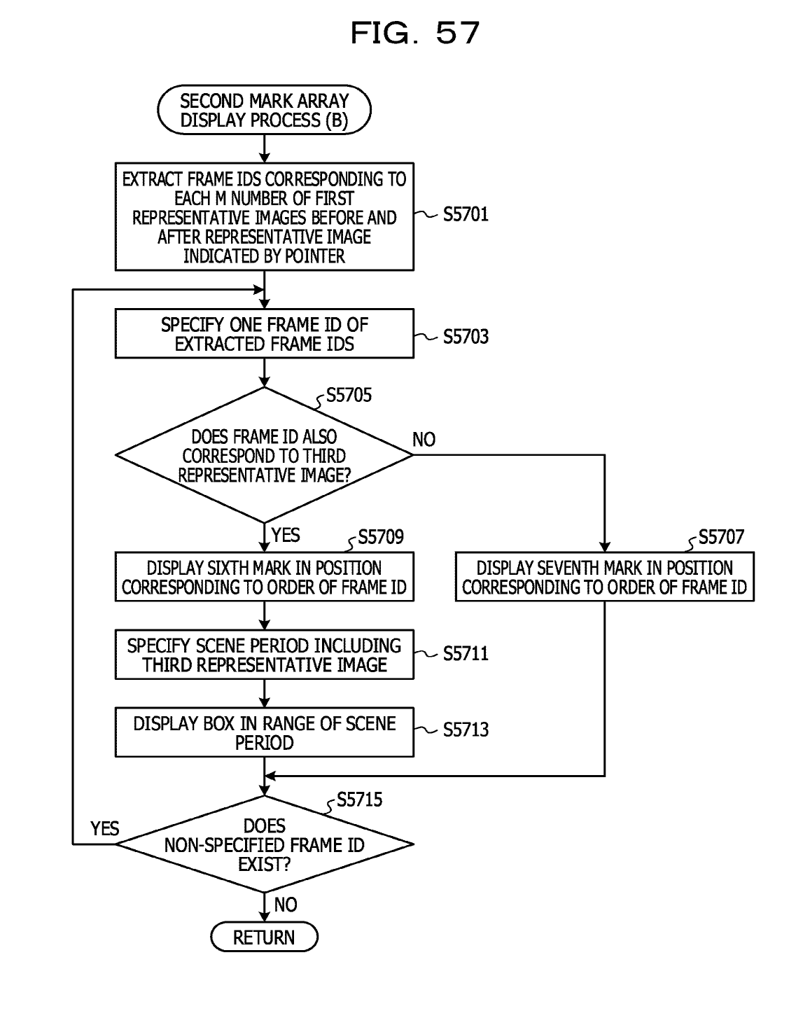

In the present embodiment, a second mark array display process (B) is performed in S5405 illustrated in FIG. 54. FIG. 57 illustrates the flow of the second mark array display process (B). Processes of S5701 and S5703 are the same as in the case of S5501 and S5503 of FIG. 55.

The eighth display processing unit 4021 determines whether or not the frame ID also corresponds to the third representative image 503 (S5705). In the case of determining the frame ID not to correspond to the third representative image 503, the eighth display processing unit 4021 displays the seventh mark 5602 in a position corresponding to the order of the frame ID (S5707). The order is set in reproduction order from left to right of the display operating screen. Then, a transition is made to a process of S5715.

Meanwhile, in the case of determining the frame ID to correspond to the third representative image 503, the eighth display processing unit 4021 displays the sixth mark 5601 in a position corresponding to the order of the frame ID (S5709).

The eighth display processing unit 4021 specifies the scene period 501 that includes the third representative image 503 (S5711), and displays the box 5603 that surrounds the range of the scene period 501 (S5713). At this point, a background color may be set inside of the box 5603.

The process of S5715 is the same as in the case of S5515 of FIG. 55. When the second mark array display process (B) is ended, a return is made to a caller of the second browse phase process (D).

According to the present embodiment, a configuration of a representative image related to a combination of the period of a scene and another period is easily recognized.

### Eighth Embodiment

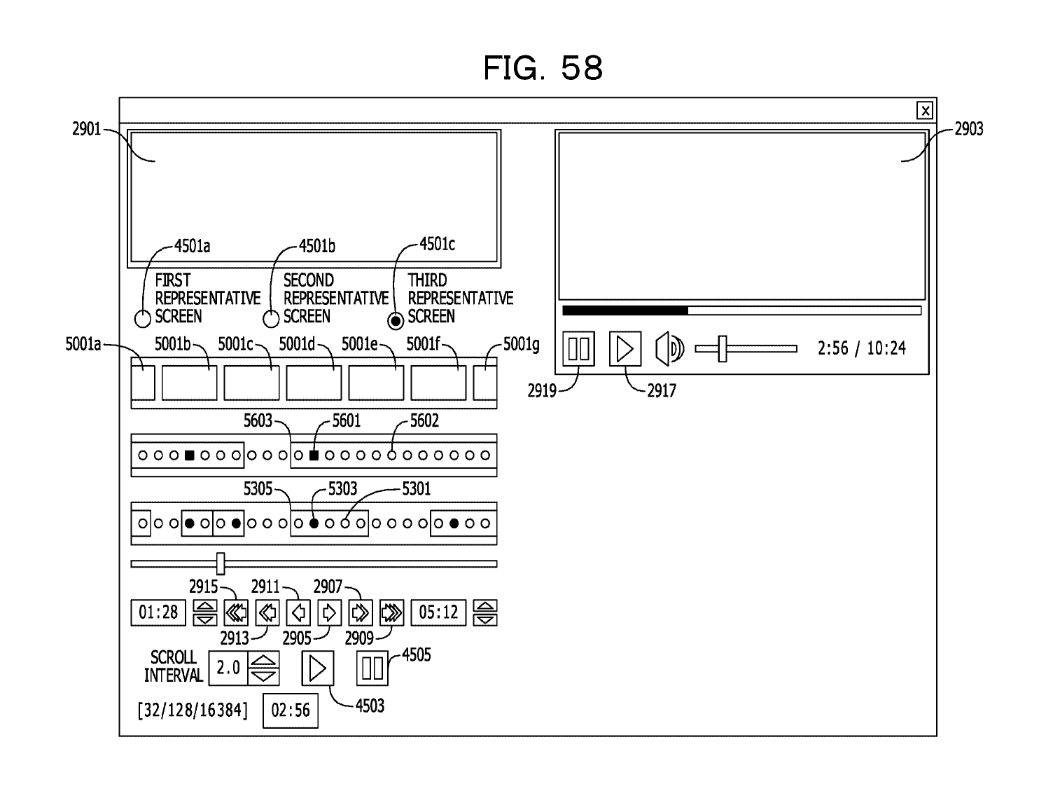

The above second browse phase processes may be combined. FIG. 58 illustrates a display operating screen in the case of combining the above second browse phase processes. The range of representative images that are made into marks in the sixth embodiment and the seventh embodiment may be specified as timings in reproduction time.

While the embodiments are described heretofore, the embodiments are not limited thereto. For example, the above functional block configuration may not match a program modular configuration.

The configuration of each storage area described above is one example and is not limited to such a configuration. For the flow of the processes, if the process results are not changed, the order of the processes may be replaced, or a plurality of processes may be performed in parallel.

The first moving image processing apparatus 400 and the second moving image processing apparatus 3000 described above are computer apparatuses in which a memory 2501, a central processing unit (CPU) 2503, a hard disk drive (HDD) 2505, a display control unit 2507 connected to a display device 2509, a drive device 2513 for a removable disc 2511, an input device 2515, and a communication control unit 2517 for connection to a network are connected by a bus 2519 as illustrated in FIG. 59. An operating system (OS) and the application program for performing the processes in the present embodiments are stored in the HDD 2505 and are read from the HDD 2505 into the memory 2501 when being executed by the CPU 2503. The CPU 2503 performs a predetermined operation by controlling the display control unit 2507, the communication control unit 2517, and the drive device 2513 in accordance with the contents of processes of the application program. Intermediate data during the processes is mainly stored in the memory 2501 and may be stored in the HDD 2505. In the embodiments, the application program for performing the processes described above is distributed as being stored in the computer-readable removable disc 2511 and is installed in the HDD 2505 from the drive device 2513. The application program may be installed in the HDD 2505 via a network such as the Internet and the communication control unit 2517. Such a computer apparatus realizes various functions as described above by organic cooperation between hardware such as the CPU 2503 and the memory 2501 described above and a program such as the OS and the application program.

The conclusion of the embodiments described heretofore is as follows.

A frame extracting method according to the present embodiments includes processes of (A) specifying, for each group acquired by grouping a plurality of frames included in a moving image with a predetermined time interval, a frame for which an index related to clearness of a frame indicates a highest clearness, (B) grouping a plurality of frames having an amount of change between temporally adjacent frames among the specified frames in each group less than or equal to a predetermined reference, and (C) extracting a representative frame from the specified frames in each group based on the frame for which the index related to the clearness of a frame indicates the highest clearness of the plurality of grouped frames.

Accordingly, a more accurate representative frame may be extracted. A clear representative frame is acquired.

The index related to the clearness may be the amount of edges detected in a frame image.

Accordingly, a frame image in focus may be selected.

The amount of change may be the amount of movement of a subject included in a frame.

Accordingly, a representative frame is acquired for each period in which an image is stable. The amount of change may be a value based on a combination of the amount of movement and the amount of change in tone of the subject included in a frame.

The width of time corresponding to a frame group, of the plurality of grouped frames, that is grouped into any group may be specified in association with the representative frame.

Accordingly, the length of a period represented by a representative frame may be recognized.

A first representative frame group that includes a plurality of the extracted representative frames may be grouped based on the tone of a frame, and a second representative frame group may be extracted from the grouped first representative frame group based on frames for which the index related to the clearness of a frame indicates the highest clearness for each group.

Accordingly, an image representing a scene may be more accurately extracted.

The width of time corresponding to a frame group, of the grouped first representative frame group, that is grouped into any group may be specified in association with a frame that is included in the any group and for which the index related to the clearness of a frame indicates the highest clearness.

Accordingly, the length of the period of a scene including a representative frame may be recognized.

A frame specified in each group, or a frame included in the first representative frame group, or a frame included in the second representative frame group may be displayed in order in accordance with a reproduction instruction.

Accordingly, a desired frame image is easily found.

A moving image reproduction control method according to the present embodiments includes processes of (D) displaying a mark corresponding to the reproduction timing of a representative frame selected from a plurality of frames included in a moving image on a time bar indicating the reproduction timing of the moving image, and displaying a part of a time section that is indicated by the time bar and is a reproduction time section to which a represented frame group represented by the representative frame and including both of a frame having an earlier reproduction timing and a frame having a later reproduction timing than the representative frame belongs, and (E) reproducing the moving image in response to an operation performed on the time bar.

Accordingly, a moving image may be reproduced after a reproduction time section represented by a representative frame is recognized.

Display of an image corresponding to the representative frame or reproduction of the moving image from a reproduction timing corresponding to the mark may be started in response to specification of the mark.

Accordingly, display of an image or reproduction of a moving image may be started at a reproduction timing indicated by each mark.

Reproduction of the moving image from a timing corresponding to the leading frame of the represented frame group may be performed in response to specification of the reproduction time section.

Accordingly, an instruction at the time of browsing a moving image from the start of the reproduction time section is simplified.

Input of information that is registered in association with the representative frame may be received in response to specification of the mark.

Accordingly, an operation of registering information corresponding to each representative frame is simplified.

A representative image group in which an image corresponding to a representative frame and input information are set may be generated in response to an instructing operation.

Accordingly, a representative frame and registered information are handled at the same time.

A representative image group in which an image corresponding to only a representative frame, of the representative frames, selected by an input operation and input information are set may be generated.

Accordingly, a representative frame for which information is not registered may be deleted.

For the representative frame, a frame for which the index related to the clearness of a frame indicates a highest clearness may be specified in each group acquired by grouping the plurality of frames included in the moving image with a predetermined time interval, and a plurality of frames having an amount of change between temporally adjacent frames among the specified frames in each group less than or equal to a predetermined reference may be grouped, and the representative frame may be selected from the specified frames in each group based on the frame for which the index related to the clearness of a frame indicates the highest clearness of the plurality of grouped frames.

Accordingly, a clear representative frame may be set as a display target.

A program that causes a computer to perform the processes of the above methods may be written, and the program may be stored in a computer-readable storage medium such as a flexible disk, a CD-ROM, a magneto-optical disc, a semiconductor memory, or a hard disk or a storage device. Generally, intermediate process results are temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A frame extracting method executed by a computer, the frame extracting method comprising:
specifying, for each of a plurality of first groups acquired by dividing a plurality of frames included in a moving image with a predetermined time interval, one frame for which an index related to clearness of a frame indicates highest clearness among frames included in each of the plurality of first groups;
grouping the plurality of specified frames into a plurality of second groups, an amount of change between temporally adjacent frames in each of the plurality of second groups being less than or equal to a predetermined reference, each of the plurality of second groups including temporally adjacent frames when each of the plurality of second groups includes more than two frames; and
extracting, for each of the plurality of second groups, a representative frame from the plurality of specified frames included in each of the plurality of second groups, the index related to the clearness of the representative frame indicating the highest clearness among the plurality of specified frames included in each of the plurality of second groups.

2. The frame extracting method according to claim 1,
wherein the index related to the clearness is detected amounts of edges in a frame image.

3. The frame extracting method according to claim 1,
wherein the amount of change is an amount of movement of a subject included in a frame.

4. The frame extracting method according to claim 1,
wherein the frame extracting method comprises:
specifying, associating with the representative frame corresponding to one of the plurality of second groups, a width of time corresponding to the plurality of first groups including one of the specified frame in the one second group.

5. The frame extracting method according to claim 1, wherein the frame extracting method comprises:
grouping a plurality of first representative frames, included in the plurality of extracted representative frames, into a plurality of third groups based on a tone of each of the plurality of representative frames;
extracting a second representative frame from each of the third groups, the index related to the clearness of the second representative frame indicating the highest clearness among the plurality of first representative frames included in each of the third groups.

6. The frame extracting method according to claim 5, wherein the frame extracting method comprises:
specifying a width of time corresponding to the plurality of second groups whose representative frames are included in one specified third group; and
outputting information that indicates the width of time associating with the representative frame of the one specified third group.

7. The frame extracting method according to claim 5, wherein the frame extracting method comprises:
displaying the plurality of frames included in the at least one of the plurality of first groups or the plurality of frames first representative frames included in the at least one of the plurality of third groups or the plurality of extracted second representative frames, in chronological order.

8. The frame extracting method according to claim 5, wherein the frame extracting method comprises:
displaying a time bar used for reproduction of the moving image, the time bar including a part of a time section corresponding to the one of the plurality of second groups;
displaying a mark corresponding to a reproduction timing of a representative frame of one of the plurality of second groups; and
reproducing the moving image in response to an operation performed on the time bar.

9. The frame extracting method according to claim 8, wherein the frame extracting method comprises:
in response to specification of the mark, displaying an image corresponding to the representative frame of the one of the plurality of second groups or reproducing the moving image from a timing corresponding to the mark.

10. The frame extracting method according to claim 8, wherein the frame extracting method comprises:
reproducing the moving image from a timing corresponding to a leading frame of one of the plurality of second groups in response to specification of the part of the time section.

11. The frame extracting method according to claim 8, wherein the frame extracting method comprises:
accepting input of information that is registered in association with the representative frame of the one of the plurality of second groups in response to specification of the mark.

12. The frame extracting method according to claim 11, wherein the frame extracting method comprises:
generating information in which an image corresponding to the representative frame of the one of the plurality of second groups and input information are set in response to an instructing operation.

13. The frame extracting method according to claim 11, wherein the frame extracting method comprises:
displaying the time bar including a plurality of parts of time sections, each of the plurality of parts of time sections corresponding to each of the plurality of second groups;
displaying a mark corresponding to a reproduction timing of the plurality of representative frames corresponding to each of the plurality of second groups; and
generating information including a plurality of data sets, each of the plurality of data sets including an image and input information corresponding one of the plurality of representative frames of each of the plurality of second groups, the image including in the data sets being a representative frame selected by an input operation and input information.

14. A non-transitory computer-readable storage medium storing a program that causes a computer to execute a process, the process comprising:
specifying, for each of a plurality of first groups acquired by dividing a plurality of frames included in a moving image with a predetermined time interval, one frame for which an index related to clearness of a frame indicates highest clearness among frames included in each of the plurality of first groups;
grouping the plurality of specified frames into a plurality of second groups, an amount of change between temporally adjacent frames in each of the plurality of second groups being less than or equal to a predetermined reference, each of the plurality of second groups including temporally adjacent frames when each of the plurality of second groups includes more than two frames; and
extracting, for each of the plurality of second groups, a representative frame from the plurality of specified frames included in each of the plurality of second groups, the index related to the clearness of the representative frame indicating the highest clearness among the plurality of specified frames included in each of the plurality of second groups.

15. A frame extracting apparatus comprising:
a memory; and
a processor coupled to the memory and the processor configured to:
specify, for each of a plurality of first groups acquired by dividing a plurality of frames included in a moving image with a predetermined time interval, one frame for which an index related to clearness of a frame indicates highest clearness among frames included in each of the plurality of first groups;
group the plurality of specified frames into a plurality of second groups, an amount of change between temporally adjacent frames in each of the plurality of second groups being less than or equal to a predetermined reference, each of the plurality of second groups including temporally adjacent frames when each of the plurality of second groups includes more than two frames; and
extract, for each of the plurality of second groups, a representative frame from the plurality of specified frames included in each of the plurality of second groups, the index related to the clearness of the representative frame indicating the highest clearness among the plurality of specified frames included in each of the plurality of second groups.
